(19) United States
(12) Patent Application Publication
(10) Pub. No.: US 2014/0373894 A1
(43) Pub. Date: Dec. 25, 2014

(54) Photovoltaic Panels Having Electrical Arc Detection Capability, And Associated Systems And Methods

(71) Applicant: Volterra Semiconductor Corporation, Fremont, CA (US)

(72) Inventors: Anthony J. Stratakos, Kentfield, CA (US); Kaiwei Yao, San Jose, CA (US)

(21) Appl. No.: 13/927,013

(22) Filed: Jun. 25, 2013

(51) Int. Cl. G01R 31/40

(52) U.S. Cl. CPC H02S 50/00
USPC 136/244

(57) ABSTRACT

A photovoltaic panel includes a panel arc detection subsystem and a plurality of photovoltaic assemblies electrically coupled in series between positive and negative panel power rails. The panel arc detection subsystem is adapted to detect a series electrical arc within the photovoltaic panel from a discrepancy between a panel voltage across the positive and negative panel power rails and a sum of all voltages across the plurality of photovoltaic assemblies. A photovoltaic string includes a string arc detection subsystem and a plurality of photovoltaic panels electrically coupled in series between positive and negative string power rails. The string arc detection subsystem is adapted to detect a series electrical arc within the photovoltaic string from a discrepancy between a string voltage across the positive and negative string power rails and a sum of all voltages across the plurality of photovoltaic panels.

### BACKGROUND

Photovoltaic systems are increasingly used to supply electric power. For example, many buildings include rooftop photovoltaic systems for supplying some or all of the building's electric power. As another example, electric utilities have built large photovoltaic systems, sometimes referred to as solar “farms,” for supplying electric power to large numbers of customers.

A single photovoltaic cell typically generates electric power at less than one volt. Many electric power applications, however, require voltages that are much higher than one volt. For example, inverters powered by photovoltaic systems often require input voltages of several hundred volts. Therefore, many photovoltaic systems include a large number photovoltaic cells electrically coupled in series to obtain a sufficiently high voltage for their application. Additionally, many photovoltaic systems include two or more strings of photovoltaic devices electrically coupled in parallel to achieve a desired system power generation capacity.

FIG. 1 illustrates a prior art photovoltaic system 100 including a first string 102 electrically coupled in parallel with a second string 104. String 102 includes M photovoltaic devices 106 electrically coupled in series, and string 104 includes N photovoltaic devices 108 electrically coupled in series, where M and N are each positive integers greater than one. In this document, specific instances of an item may be referred to by use of a numeral in parentheses (e.g., photovoltaic device 106(1)) while numerals without parentheses refer to any such item (e.g., photovoltaic devices 106). Photovoltaic devices 106, 108 are either individual photovoltaic cells or groups electrically coupled photovoltaic cells. First and second strings 102, 104 are electrically coupled in parallel with a load 110.

High voltages may exist in many photovoltaic systems. For example, each string 102, 104 of photovoltaic system 100 will often include many series-coupled photovoltaic cells, such that voltage across power rails 112, 114 will often exceed one hundred volts, especially in systems coupled through inverters to alternating current (AC) power grids. Indeed, photovoltaic systems are often rated at 600 volts or 1,000 volts. Additionally, many photovoltaic systems are capable of supplying significant current. Accordingly, photovoltaic systems may experience an electrical arc, where gas (typically air) between two nearby nodes ionizes due to a large voltage between the nodes, resulting in current flow between the nodes. Such potential for an electrical arc is compounded by the fact that typical photovoltaic systems include many electrical connectors and long electrical cables, thereby presenting many possible points of failure. Additionally, photovoltaic systems are often subjected to hostile environmental conditions, such as extreme temperatures and intense ultraviolet radiation, which may cause connector or insulation failure, particularly over the long lifetimes expected of typical photovoltaic systems. Furthermore, some photovoltaic systems are vulnerable to physical damage, such as from maintenance personnel working in the system's vicinity, or from an animal chewing on the system's components.

A photovoltaic system electrical arc can be classified as either a series electrical arc or a parallel electrical arc. A series electrical arc occurs across an opening in a series electrical circuit, such as across an opening caused by a connector failure. For example, FIG. 2 illustrates a series electrical arc 202 across an opening 204 in first string 102 of photovoltaic system 100. A parallel electrical arc occurs between two nodes of a photovoltaic system, or between a node and ground, such as due to an insulation failure. FIG. 3 illustrates a parallel electrical arc 302 between a node 116 of second string 104 and negative power rail 114 of photovoltaic system 100.

Photovoltaic system electrical arcs as usually highly undesirable because their heat can injure a person or animal in the system's vicinity, start a fire, damage the photovoltaic system, and/or generate electrical noise which can disrupt proper operation of nearby electrical circuitry. Additionally, an energized photovoltaic system may present an electrical shock hazard to firefighters attending to an arc-induced fire. Accordingly, electrical arc detection devices have been proposed for photovoltaic systems. These devices detect an electrical arc by identifying high frequency components, or “noise,” of photovoltaic system current that is generated by the electrical arc. The noise's amplitude is very small and must be increased by amplification, or by use of a current transformer, for detection. Additionally, the noise must be distinguished from other high frequency components commonly present in photovoltaic system current, such as switching power converter ripple current and harmonics thereof. Thus, conventional arc detection devices decompose photovoltaic system current into its constituent AC components using Fast Fourier Transform (FFT) techniques, or similar techniques, to distinguish electrical arc noise from other system noise. Significant computational resources are required to satisfactorily perform this signal decomposition. For example, analog to digital converters with greater than 16 bit resolution and with a sample rate in excess of 200,000 samples per second are typically required to perform FFT processing in electrical arc detection applications.

### SUMMARY

In an embodiment, a method for detecting an electrical arc in a photovoltaic panel including a plurality of photovoltaic assemblies electrically coupled in series between positive and negative panel power rails includes the following steps: (a) sensing a panel voltage across the positive and negative panel power rails, (b) sensing a respective assembly voltage across each of the plurality of photovoltaic assemblies, (c) determining a difference between a sum of all of the assembly voltages and the panel voltage, (d) determining whether the difference exceeds a threshold value, and (e) detecting the electrical arc if the difference exceeds the threshold value.

In an embodiment, a method for detecting an electrical arc in a photovoltaic string including a plurality of photovoltaic panels electrically coupled in series between positive and negative string power rails includes the following steps: (a) sensing a string voltage across the positive and negative string power rails, (b) sensing a respective panel output voltage across each of the plurality of photovoltaic panels, (c) determining a difference between a sum of all of the panel output voltages and the string voltage, (d) determining whether the difference exceeds a threshold value, and (e) detecting the electrical arc if the difference exceeds the threshold value.

In an embodiment, a method for detecting an electrical arc in a photovoltaic panel including a plurality of photovoltaic assemblies electrically coupled in series includes the following steps: (a) sensing a first assembly current flowing through one of the plurality of photovoltaic assemblies, (b) sensing a panel current flowing between the plurality of photovoltaic assemblies and other circuitry, (c) determining a difference between the panel current and the first assembly current, (d) determining whether a magnitude of the difference exceeds a threshold value, and (e) detecting the electrical arc if the magnitude of the difference exceeds the threshold value.

In an embodiment, a method for detecting an electrical arc in a photovoltaic panel including a plurality of photovoltaic assemblies electrically coupled in series includes the following steps: (a) sensing a first assembly current flowing through one of the plurality of photovoltaic assemblies, (b) sensing a second assembly current flowing through another one of the plurality of photovoltaic assemblies, (c) determining a difference between the first and second assembly currents, (d) determining whether a magnitude of the difference exceeds a threshold value, and (e) detecting the electrical arc if the magnitude of the difference exceeds the threshold value.

In an embodiment, a method for detecting an electrical arc in a string including a plurality of photovoltaic panels electrically coupled in series includes the following steps: (a) sensing a first panel output current flowing through an output port one of the plurality of photovoltaic panels, (b) sensing a string current flowing between the plurality of photovoltaic panels and other circuitry, (c) determining a difference between the first panel output current and the string current, (d) determining whether a magnitude of the difference exceeds a threshold value, and (e) detecting the electrical arc if the magnitude of the difference exceeds the threshold value.

In an embodiment, a method for detecting an electrical arc in a string including a plurality of photovoltaic panels electrically coupled in series includes the following steps: (a) sensing a first panel output current flowing through an output port one of the plurality of photovoltaic panels, (b) sensing a second panel output current flowing through an output port of another one of the plurality of photovoltaic panels, (c) determining a difference between the first and second panel output currents, (d) determining whether a magnitude of the difference exceeds a threshold value, and (e) detecting the electrical arc if the magnitude of the difference exceeds the threshold value.

In an embodiment, a method for detecting an electrical arc in a photovoltaic system including a plurality of strings electrically coupled in parallel, each of the plurality of strings including a plurality of photovoltaic panels electrically coupled in series, includes the following steps: (a) sensing a respective string output current flowing through an output port of each of the plurality of strings, (b) sensing a combined current flowing between the plurality of strings and other circuitry, (c) determining a difference between the combined current and a sum of all of the string output currents, (d) determining whether a magnitude of the difference exceeds a threshold value, and (e) detecting the electrical arc if the magnitude of the difference exceeds the threshold value.

In an embodiment, a photovoltaic panel having electrical arc detection capability includes a panel arc detection subsystem and a plurality of photovoltaic assemblies electrically coupled in series between a positive panel power rail and a negative panel power rail. The panel arc detection subsystem is adapted to detect a series electrical arc within the photovoltaic panel from a discrepancy between a panel voltage across the positive and negative panel power rails and a sum of all voltages across the plurality of photovoltaic assemblies.

In an embodiment, a photovoltaic panel having electrical arc detection capability includes a panel arc detection subsystem and a plurality of photovoltaic assemblies electrically coupled in series. The panel arc detection subsystem is adapted to detect a parallel electrical arc within the photovoltaic panel from a discrepancy between current flowing through a selected one of the plurality of photovoltaic assemblies and current flowing between the plurality of photovoltaic assemblies and other circuitry.

In an embodiment, a photovoltaic panel having electrical arc detection capability includes a panel arc detection subsystem and a plurality of photovoltaic assemblies electrically coupled in series. The panel arc detection subsystem is adapted to detect a parallel electrical arc within the photovoltaic panel from a discrepancy between current flowing through two different ones of the plurality of photovoltaic assemblies.

In an embodiment, a photovoltaic string having electrical arc detection capability includes a string arc detection subsystem and a plurality of photovoltaic panels electrically coupled in series between a positive string power rail and a negative string power rail. The string arc detection subsystem is adapted to detect a series electrical arc within the photovoltaic string from a discrepancy between a string voltage across the positive and negative string power rails and a sum of all voltages across the plurality of photovoltaic panels.

In an embodiment, a photovoltaic string having electrical arc detection capability includes a string arc detection subsystem and a plurality of photovoltaic panels electrically coupled in series. The string arc detection subsystem is adapted to detect a parallel electrical arc within the photovoltaic string from a discrepancy between a current flowing through a selected one of the plurality of photovoltaic panels and current flowing between the plurality of photovoltaic panels and other circuitry.

In an embodiment, a photovoltaic string having electrical arc detection capability includes a string arc detection subsystem and a plurality of photovoltaic panels electrically coupled in series. The string arc detection subsystem is adapted to detect a parallel electrical arc within the photovoltaic string from a discrepancy between current flowing through two different ones of the plurality of photovoltaic panels.

In an embodiment, a photovoltaic system having electrical arc detection capability includes a system-level arc detection subsystem and a plurality of photovoltaic strings electrically coupled in parallel. The system-level arc detection subsystem is adapted to detect a parallel electrical arc within the photovoltaic system from a discrepancy between (a) a sum of current flowing through all of the plurality of strings and (b) current flowing between the plurality of strings and other circuitry.

In an embodiment, a method for detecting an electrical arc in an energy storage system including a plurality of energy storage assemblies electrically coupled in series between positive and negative power rails includes the following steps: (a) sensing a system voltage across the positive and negative power rails, (b) sensing a respective assembly voltage across each of the plurality of energy storage assemblies, (c) determining a difference between a sum of all of the assembly voltages and the system voltage, (d) determining whether the difference exceeds a threshold value, and (e) detecting the electrical arc if the difference exceeds the threshold value.

In an embodiment, a method for detecting an electrical arc in an energy storage system including a plurality of energy storage assemblies electrically coupled in series includes the following steps: (a) sensing a first assembly current flowing through one of the plurality of energy storage assemblies, (b) sensing a system current flowing between the plurality of energy storage assemblies and other circuitry, (c) determining a difference between the system current and the first assembly current, (d) determining whether a magnitude of the difference exceeds a threshold value, and (e) detecting the electrical arc if the magnitude of the difference exceeds the threshold value.

In an embodiment, a method for detecting an electrical arc in an energy storage system including a plurality of energy storage assemblies electrically coupled in series includes the following steps: (a) sensing a first assembly current flowing through one of the plurality of energy storage assemblies, (b) sensing a second assembly current flowing through another one of the plurality of energy storage assemblies, (c) determining a difference between the first and second assembly currents, (d) determining whether a magnitude of the difference exceeds a threshold value, and (e) detecting the electrical arc if the magnitude of the difference exceeds the threshold value.

In an embodiment, a method for detecting an electrical arc in an energy storage system including a plurality of energy storage strings electrically coupled in parallel, each of the plurality of energy storage strings including a plurality of energy storage assemblies electrically coupled in series, includes the following steps: (a) sensing a respective string output current flowing through an output port of each of the plurality of energy storage strings, (b) sensing a combined current flowing between the plurality of energy storage strings and other circuitry, (c) determining a difference between the combined current and a sum of all of the string output currents, (d) determining whether a magnitude of the difference exceeds a threshold value, and (e) detecting the electrical arc if the magnitude of the difference exceeds the threshold value.

In an embodiment, an energy storage system having electrical arc detection capability includes an arc detection subsystem and a plurality of energy storage assemblies electrically coupled in series between a positive power rail and a negative power rail. The arc detection subsystem is adapted to detect a series electrical arc within the energy storage system from a discrepancy between a system voltage across the positive and negative power rails and a sum of all voltages across the plurality of energy storage assemblies.

In an embodiment, an energy storage system having electrical arc detection capability includes an arc detection subsystem and a plurality of energy storage assemblies electrically coupled in series. The arc detection subsystem is adapted to detect a parallel electrical arc within the energy storage system from a discrepancy between current flowing through a selected one of the plurality of energy storage assemblies and current flowing between the plurality of energy storage assemblies and other circuitry.

In an embodiment, an energy storage system having electrical arc detection capability includes an arc detection subsystem and a plurality of energy storage assemblies electrically coupled in series. The arc detection subsystem is adapted to detect a parallel electrical arc within the energy storage system from a discrepancy between current flowing through two different ones of the plurality of energy storage assemblies.

In an embodiment, an energy storage system having electrical arc detection capability includes an arc detection subsystem and a plurality of energy storage strings electrically coupled in parallel. The arc detection subsystem is adapted to detect a parallel electrical arc within the energy storage system from a discrepancy between (a) a sum of current flowing through all of the plurality of energy storage strings and (b) current flowing between the plurality of energy storage strings and other circuitry.

### BRIEF DESCRIPTION OF THE DRAWINGS

FIG. 1 illustrates a prior art photovoltaic system.

FIG. 2 illustrates an example of a series electrical arc in the FIG. 1 photovoltaic system.

FIG. 3 illustrates an example of a parallel electrical arc in the FIG. 1 photovoltaic system.

FIG. 4 illustrates a photovoltaic panel having electrical arc detection capability, according to an embodiment.

FIG. 5 illustrates an example of a series electrical arc in the FIG. 4 photovoltaic panel.

FIG. 6 illustrates an example of a parallel electrical arc in the FIG. 4 photovoltaic panel.

FIG. 7 illustrates one possible implementation of a panel arc detection subsystem of the FIG. 4 photovoltaic panel, according to an embodiment.

FIG. 8 illustrates another possible implementation of the panel arc detection subsystem of the FIG. 4 photovoltaic panel, according to an embodiment.

FIG. 9 illustrates one possible implementation of an assembly voltage sensing subsystem of the FIG. 4 photovoltaic panel, according to an embodiment.

FIG. 10 illustrates one possible implementation of an assembly current sensing subsystem of the FIG. 4 photovoltaic panel, according to embodiment.

FIG. 11 illustrates a photovoltaic panel similar to that of FIG. 4, but further including a panel-level MPPT converter, according to an embodiment.

FIG. 12 illustrates a photovoltaic panel similar to that of FIG. 4, but further including a microinverter, according to an embodiment.

FIG. 13 illustrates a photovoltaic panel similar to that of FIG. 4, but with photovoltaic assemblies including maximum power point tracking converters, according to an embodiment.

FIG. 14 illustrates one possible implementation of photovoltaic assemblies of the FIG. 13 photovoltaic panel, according to an embodiment.

FIG. 15 illustrates another possible implementation of photovoltaic assemblies of the FIG. 13 photovoltaic panel, according to an embodiment.

FIG. 16 illustrates a photovoltaic string having electrical arc detection capability, according to an embodiment.

FIG. 17 illustrates one possible implementation of a string arc detection subsystem of the FIG. 16 photovoltaic string, according to an embodiment.

FIG. 18 illustrates another possible implementation of the string arc detection subsystem of the FIG. 16 photovoltaic string, according to an embodiment.

FIG. 19 illustrates a photovoltaic system having parallel arc detection capability, according to an embodiment.

FIG. 20 illustrates one possible implementation of a system-level arc detection subsystem of the FIG. 19 photovoltaic system, according to an embodiment.

FIG. 21 illustrates an energy storage system having electrical arc detection capability, according to an embodiment.

FIG. 22 illustrates another energy storage system having electrical arc detection capability, according to an embodiment.

FIG. 23 illustrates a method for detecting a series electrical arc in a photovoltaic panel including a plurality of photovoltaic assemblies electrically coupled in series, according to an embodiment.

FIG. 24 illustrates a method for detecting a series electrical arc in a photovoltaic string including a plurality of photovoltaic panels electrically coupled in series, according to an embodiment.

FIG. 25 illustrates a method for detecting a parallel electrical arc in a photovoltaic panel including a plurality of photovoltaic assemblies electrically coupled in series, according to an embodiment.

FIG. 26 illustrates another method for detecting a parallel electrical arc in a photovoltaic panel including a plurality of photovoltaic assemblies electrically coupled in series, according to an embodiment.

FIG. 27 illustrates a method for detecting a parallel electrical arc in a photovoltaic string including a plurality of photovoltaic panels electrically coupled in series, according to an embodiment.

FIG. 28 illustrates another method for detecting a parallel electrical arc in a photovoltaic string including a plurality of photovoltaic panels electrically coupled in series, according to an embodiment.

FIG. 29 illustrates a method for detecting an electrical arc in a photovoltaic system including a plurality of strings electrically coupled in parallel, according to an embodiment.

FIG. 30 illustrates a method for detecting a series electrical arc in an energy storage system including a plurality of energy storage assemblies electrically coupled in series, according to an embodiment.

FIG. 31 illustrates a method for detecting a parallel electrical arc in an energy storage system including a plurality of energy storage system assemblies electrically coupled in series, according to an embodiment.

FIG. 32 illustrates another method for detecting a parallel electrical arc in an energy storage system including a plurality of energy storage assemblies electrically coupled in series, according to an embodiment.

FIG. 33 illustrates a method for detecting an electrical arc in an energy storage system including a plurality of energy storage strings electrically coupled in parallel, according to an embodiment.

FIG. 34 illustrates an energy storage system similar to that of FIG. 21, but with energy storage assemblies including voltage regulators, according to an embodiment.

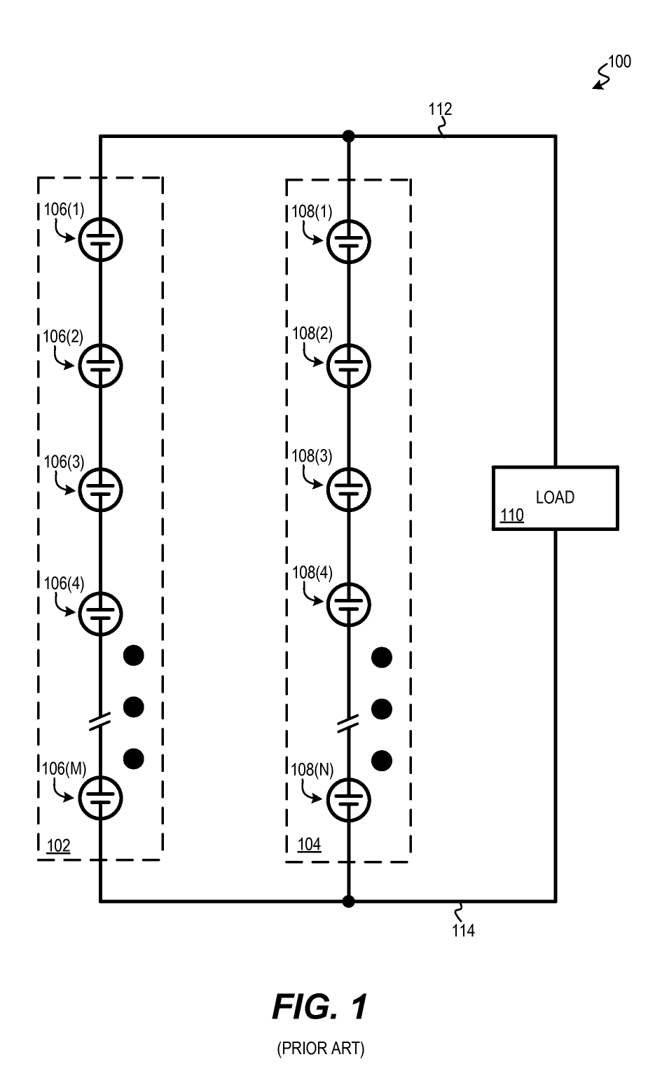

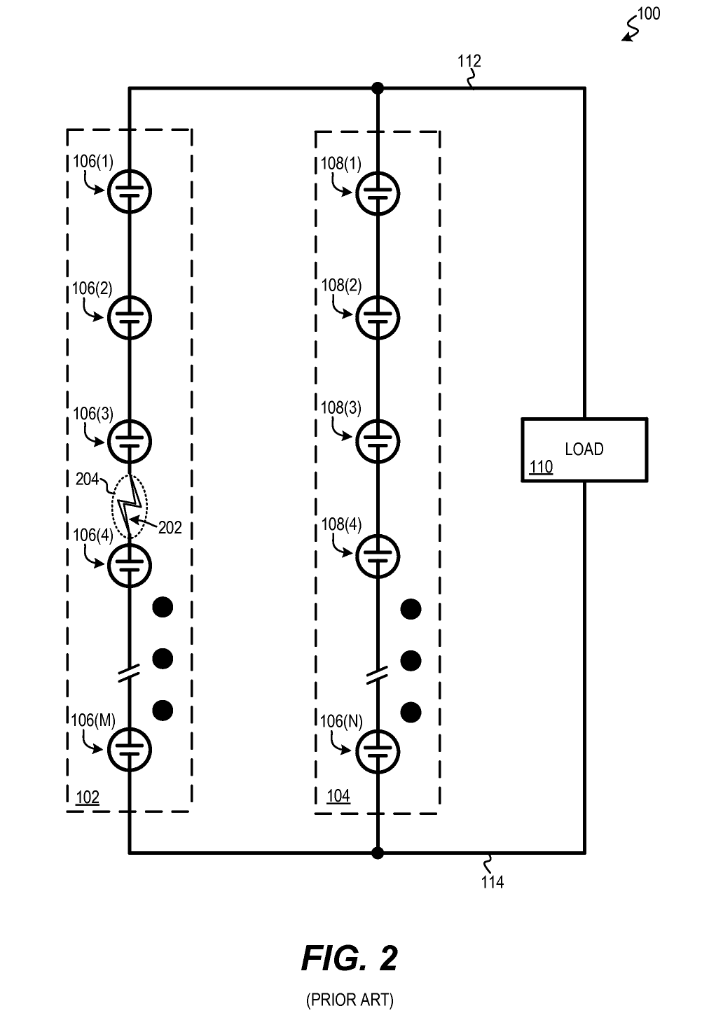

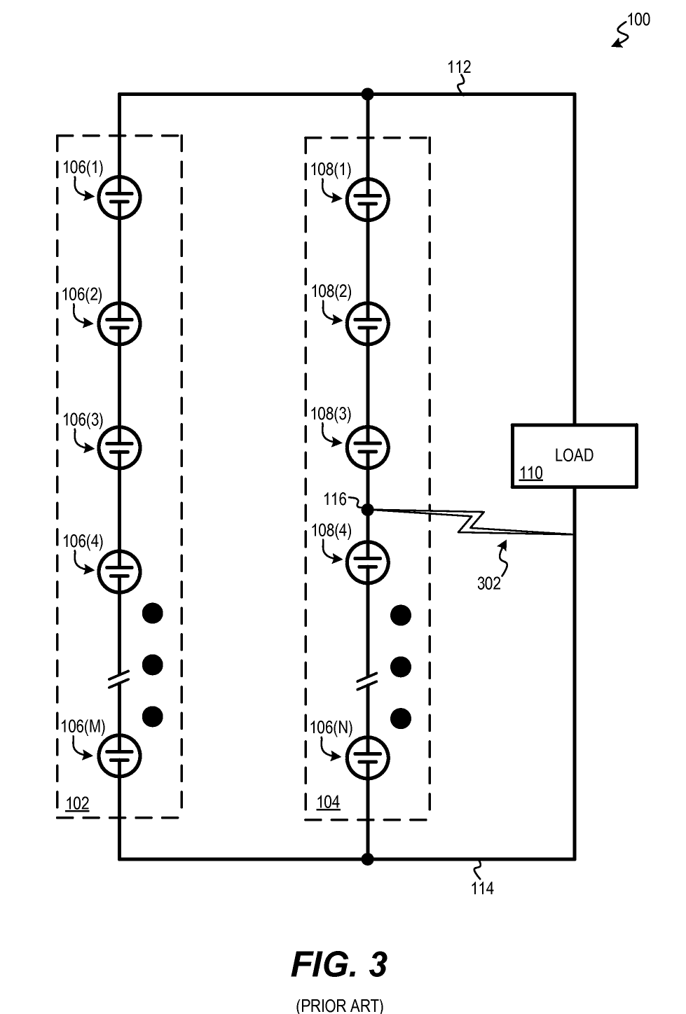

### DETAILED DESCRIPTION OF THE EMBODIMENTS

Applicants have developed photovoltaic panels and associated systems and methods which detect an electrical arc from a voltage discrepancy and/or from a current discrepancy. Such voltage and current discrepancies can potentially be detected using fewer computation resources than are typically required for FFT processing or similar signal decomposition techniques. Accordingly, the electrical arc detection techniques disclosed herein can potentially be implemented with fewer computational resources than conventional electrical arc detection techniques, thereby promoting simplicity, low cost, and reliability.

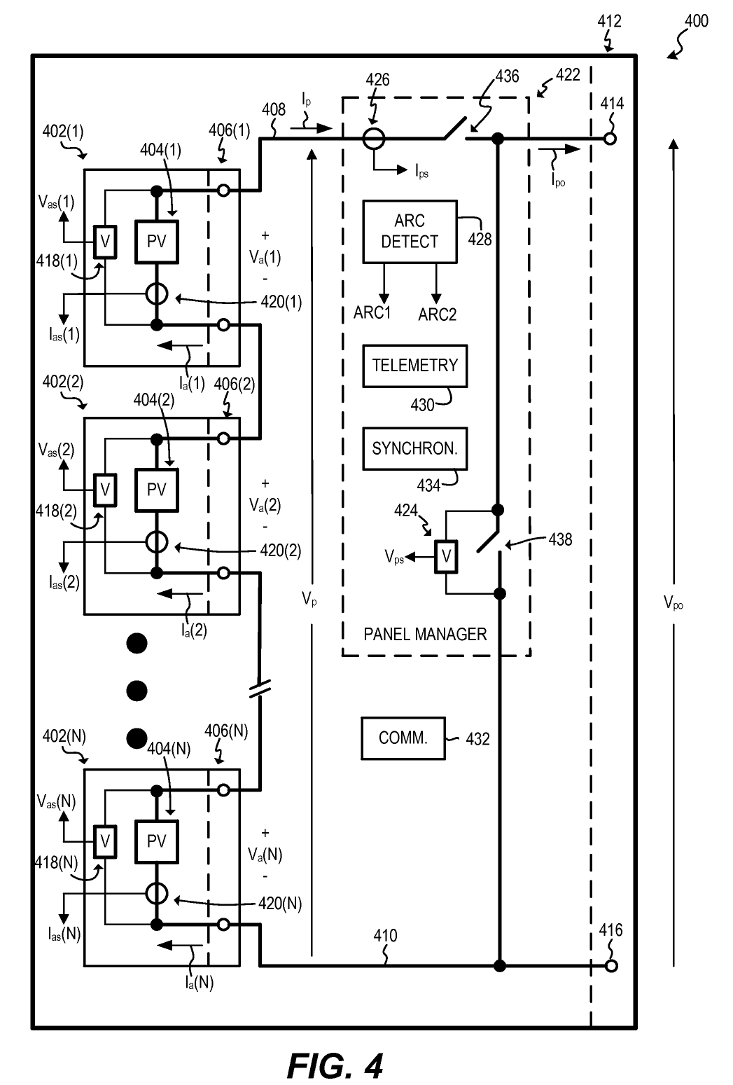

FIG. 4 illustrates a photovoltaic panel 400 having electrical arc detection capability. Photovoltaic panel 400 includes N photovoltaic assemblies 402, where N is an integer greater than one. Each photovoltaic assembly 402 includes a photovoltaic device 404 electrically coupled to an output port 406. Each photovoltaic device 404 includes one or more photovoltaic cells (not shown) electrically coupled in series and/or parallel. Photovoltaic assemblies 402 are electrically coupled in series between a positive power rail 408 and a negative power rail 410 of photovoltaic panel 400. Photovoltaic panel 400 further includes a panel output port 412 having a positive output terminal 414 and a negative output terminal 416 electrically coupled to positive power rail 408 and negative power rail 410, respectively.

Each photovoltaic assembly 402 further includes an assembly voltage sensing subsystem 418 and an assembly current sensing subsystem 420. Each assembly voltage sensing subsystem 418 generates a signal Vₐₛ representing a voltage Vₐ across the output port 406 of its respective photovoltaic assembly 402, and each assembly current sensing subsystem 420 generates a signal Iₐₛ representing current Iₐ flowing through its respective photovoltaic assembly 402, or in other words, representing current flowing between the photovoltaic assembly and external circuitry electrically coupled to output port 406. For example, assembly voltage sensing subsystem 418(1) generates signal Vₐₛ(1) representing voltage Vₐ(1) across photovoltaic assembly 402(1), and assembly voltage sensing subsystem 418(2) generates signal Vₐₛ(2) representing voltage Vₐ(2) across photovoltaic assembly 402(2). Similarly, assembly current sensing subsystem 420(1) generates signal Iₐₛ(1) representing current Iₐ(1) flowing through photovoltaic assembly 402(1), and assembly current sensing subsystem 420(2) generates signal Iₐₛ(2) representing current Iₐ(2) flowing through photovoltaic assembly 402(2).

Photovoltaic panel 400 further includes a panel manager 422 including a panel voltage sensing subsystem 424, a panel current sensing subsystem 426, and a panel arc detection subsystem 428. Panel voltage sensing subsystem 424 generates a signal Vₚₛ representing panel voltage Vₚ across power rails 408, 410. In this embodiment, panel voltage Vₚ is the same as panel output voltage Vₚₒ across panel output port 412, and signal Vₚₛ therefore represents panel output voltage Vₚₒ as well as panel voltage Vₚ. Panel current sensing subsystem 426 generates a signal Iₚₛ representing panel current Iₚ flowing between photovoltaic assemblies 402 and other circuitry. In this embodiment, panel current Iₚ is the same as panel output current Iₚₒ flowing through panel output port 412, and signal Iₚₛ therefore represents panel output current Iₚₒ as well as panel current Iₚ. Panel manager 422 optionally further includes a telemetry subsystem 430 adapted to communicate information, such as signals Vₚₛ and/or Iₚₛ, to an external device, such as a string manager in applications where multiple photovoltaic panel 400 instances are electrically coupled in series to form a string of photovoltaic panels.

It is anticipated that signals Vₐₛ, Iₐₛ, Vₚₛ, and Iₚₛ will typically be digital signals to facilitate signal transmission and processing. However, one or more of signals Vₐₛ, Iₐₛ, Vₚₛ, and Iₚₛ could alternately be an analog signal without departing from the scope hereof. Signals Vₐₛ and Iₐₛ are communicatively coupled to panel manager 422 via a communication network 432 which is, for example, a serial communication network, a parallel bus communication network, a wireless communication network, or a power line communication network.

Panel arc detection subsystem 428 processes signals Vₐₛ, Iₐₛ, Vₚₛ, and Iₚₛ to detect a series or parallel electrical arc in photovoltaic panel 400 from a voltage or current discrepancy within the panel. Under normal conditions, the sum of voltages Vₐ across all photovoltaic assemblies 402 will be substantially equal to panel voltage Vₚ at a given time. However, a series electrical arc within photovoltaic panel 400 will cause panel voltage Vₚ to be less than the sum of all photovoltaic assembly voltages Vₐ, due to voltage drop across the series electrical arc.

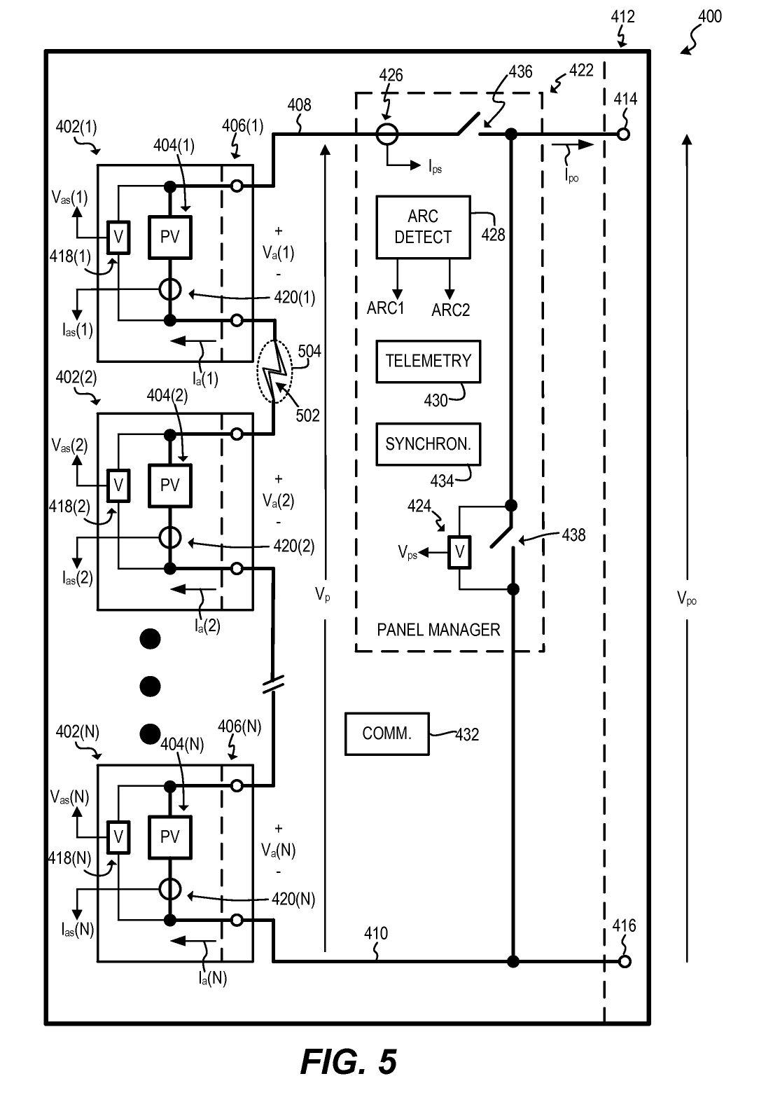

Consider, for example, FIG. 5, which illustrates an example of photovoltaic panel 400 experiencing a series electrical arc 502 across an opening 504 that has developed between photovoltaic assemblies 402(1) and 402(2). Assume each photovoltaic assembly 402 is generating a voltage Vₐ of 30 volts, and that 40 volts is dropped across series electrical arc 502. In this case, the sum of all voltages Vₐ across photovoltaic assemblies 402, Vₛᵤₘ, is as follows:

Vₛᵤₘ=30N (EQN. 1)

However, the voltage across series electrical arc 502 will subtract from panel voltage Vₚ, such that panel voltage is as follows:

V_{P}=30N−40 (EQN. 2)

Thus, the Vₚ is less than Vₛᵤₘ by 40 volts due to series electrical arc 502.

Accordingly, panel arc detection subsystem 428 detects a series electrical arc within photovoltaic panel 400 from a discrepancy between panel voltage Vₚ and the sum of all assembly voltages Vₐ at a given time. Specifically, panel arc detection subsystem 428 detects a series electrical arc within photovoltaic panel 400 when EQN. 3 holds true:

[Σₙ₌₁^{N}Vₐₛ(n)−Vₚₛ]>Vₜₕ (EQN. 3)

Vₜₕ is a positive threshold value chosen to achieve a desired tradeoff between electrical arc detection sensitivity and immunity to false electrical arc detection. If Vₜₕ was omitted from EQN. 3, parasitic voltage drop across conductors electrically coupling photovoltaic assemblies 402 in series, or minor voltage measure errors, would cause false detection of an electrical arc.

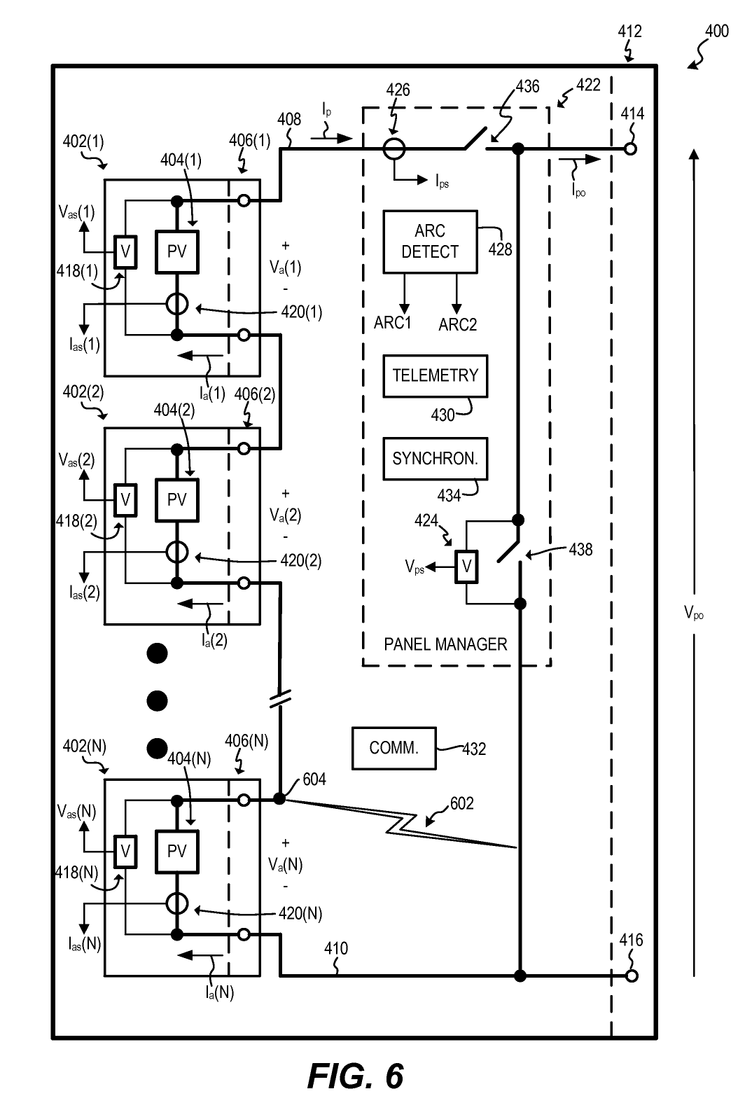

Under normal conditions, magnitude of current flowing through serially-connected portions of photovoltaic panel 400 will be the same at a given time. However, a parallel electrical arc within photovoltaic panel 400 will cause a discrepancy in current flowing between different serially-connected portions of the photovoltaic panel. Consider, for example, FIG. 6, which illustrates an example of photovoltaic panel 400 experiencing a parallel electrical arc 602 between node 604 and negative power rail 410. The magnitude of current Iₐ(N) flowing through photovoltaic assembly 402(N) will differ from the magnitude of panel current Iₚ due to parallel electrical arc 602.

Panel arc detection subsystem 428 detects a parallel electrical arc within photovoltaic panel 400 from a discrepancy between current flowing in different serially-connected portions of the photovoltaic panel at a given time, such as a discrepancy between assembly current Iₐ of two different photovoltaic assemblies 402, or a discrepancy between panel current Iₚ and assembly current Iₐ of a selected photovoltaic assembly 402. For example, in some embodiments, panel arc detection subsystem 428 detects a parallel electrical arc within panel 400 when EQN. 4 holds true, where x is an integer ranging from 1 to N:

|Iₚₛ−Iₐₛ(x)|>Iₜₕ (EQN. 4)

In other embodiments, panel arc detection subsystem 428 detects a parallel electrical arc within panel 400 when EQN. 5 holds true, where x and y are each integers ranging from 1 to N, and x does not equal y:

|Iₐₛ(x)−Iₐₛ(y)|>Iₜₕ (EQN. 5)

In both EQNS. 4 and 5, Iₜₕ is a positive threshold value chosen to achieve a desired tradeoff between electrical arc detection sensitivity and immunity to false electrical arc detection. If Iₜₕ were omitted from the equations, minor current measurement errors would cause false detection of a parallel electrical arc. Panel current sensing subsystem 426 is optionally omitted in embodiments evaluating EQN. 5 since panel current signal Iₚₛ is not a parameter of EQN. 5.

In some embodiments, panel arc detection subsystem 428 is capable of evaluating only one instance of either EQN. 4 or 5 at a given time. In these embodiments, panel arc detection subsystem 428 varies the value of x, or both x and y (if applicable), so that different portions of photovoltaic panel 400 are selected for parallel electrical arc detection. For example, in some embodiments implementing EQN. 4, x is repeatedly stepped through all integers ranging from 1 to N, such that EQN. 4 is evaluated with x equal to one, then with x equal to two, and so on. As another example, in some embodiments implementing EQN. 5, x and y are each repeatedly stepped through all integers ranging from 1 to N, but such that x does not equal y. For example, in a particular embodiment implementing EQN. 5, the equation is evaluated with x equal to 1 and y equal to 2, then with x equal to 2 and y equal to 3, and so on.

In some other embodiments, panel arc detection subsystem 428 is capable of evaluating several instances of either EQN. 4 or EQN. 5 at a given time, thereby potentially speeding detection of a parallel electrical arc. In embodiments evaluating multiple EQN. 4 instances at a given time, each instance has a different value of x. In embodiments evaluating multiple EQN. 5 instances at a given time, each instance has a different combination of x and y values.

The parameters of each of EQNS. 3-5 must be sensed at a common time for accurate electrical arc detection. For example, signals Vₐₛ and Vₚₛ of EQN. 3 must represent voltages sensed at a common time, to accurately detect a series electrical arc. Accordingly, panel manager 422 optionally further includes a synchronization subsystem 434 capable of synchronizing generation of signals Vₐₛ, Iₐₛ, Vₚₛ, and Iₚₛ. In some embodiments, synchronization subsystem 434 operates independently, while in other embodiments, synchronization subsystem 434 is at least partially controlled by an external signal, such as an external clock signal generated by a system incorporating photovoltaic panel 400.

In some alternate embodiments, part or all of panel voltage sensing subsystem 424, panel current sensing subsystem 426, panel arc detection subsystem 428, telemetry subsystem 430, and/or synchronization subsystem 434 are separate from panel manager 422. Furthermore, in some other alternate embodiments, panel manager 422 is omitted and panel voltage sensing subsystem 424, panel current sensing subsystem 426, panel arc detection subsystem 428, telemetry subsystem 430, and synchronization subsystem 434 are stand-alone subsystems or part of other subsystems of photovoltaic panel 400.

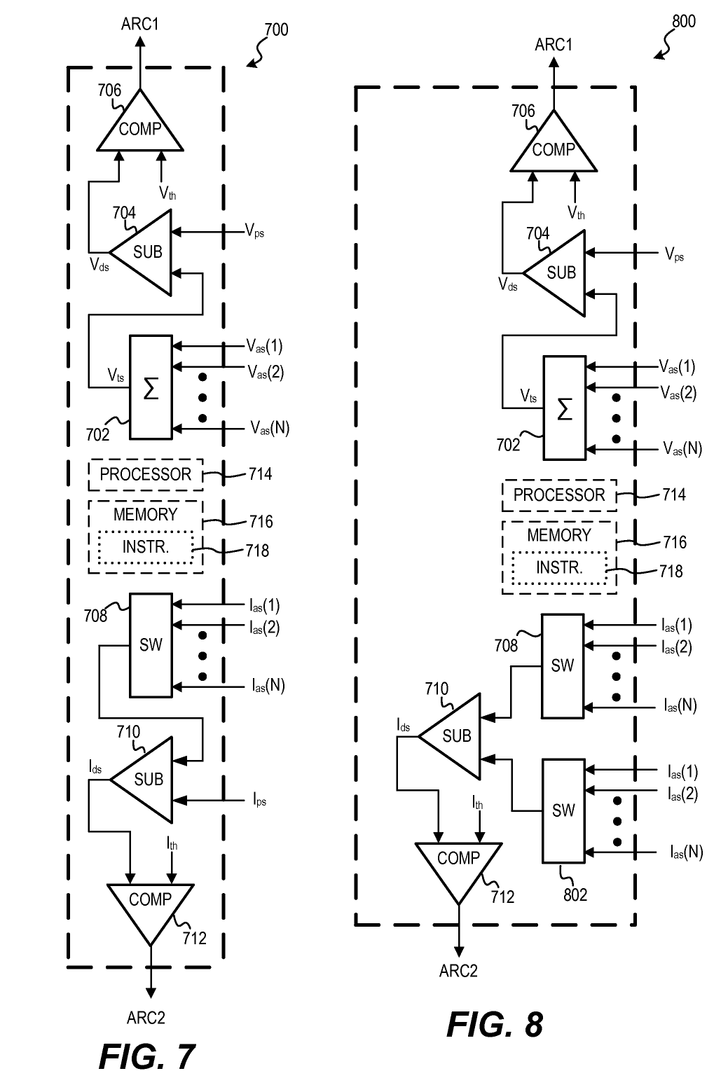

FIG. 7 illustrates a panel arc detection subsystem 700, which is one possible implementation of panel arc detection subsystem 428 (FIG. 4). Panel arc detection subsystem 700 includes a summation module 702, a subtraction module 704, and a comparison module 706, which collectively detect a series electrical arc within photovoltaic panel 400 by evaluating EQN. 3. In particular, summation module 702 generates a total voltage signal Vₜₛ representing a sum of all assembly voltage signals Vₐₛ. Thus, total voltage signal Vₜₛ represents the sum of all voltages Vₐ across photovoltaic assemblies 402. Subtraction module 704 generates a voltage difference signal V_{ds} representing a difference between total voltage signal Vₜₛ and panel voltage signal Vₚₛ. Thus, voltage difference signal V_{ds} represents a discrepancy between panel voltage Vₚ and the sum of all voltages Vₐ across photovoltaic assemblies 402. As discussed above, panel voltage Vₚ should be substantially equal to the sum of all assembly voltages Vₐ at a given time. Thus, voltage difference signal V_{ds} should ordinarily be very small. In the event of a series electrical arc, however, panel voltage Vₚ will be smaller than the sum of all assembly voltages, and voltage difference signal V_{ds} will have a significant magnitude.

Comparison module 706 determines whether voltage difference signal V_{ds} exceeds threshold value Vₜₕ, and if so, comparison module 706 asserts a signal ARC1 representing a series electrical arc. Otherwise, panel arc detection subsystem 700 continues to monitor photovoltaic panel 400 for a series electrical arc.

Panel arc detection subsystem 700 further includes a switching module 708, a subtraction module 710, and a comparison module 712 which collectively detect a parallel electrical arc by evaluating EQN. 4. Switching module 708 selects one of the N assembly current signals Iₐₛ for communicative coupling to subtraction module 710, thereby selecting one photovoltaic assembly 402 for monitoring. Thus, switching module 708 effectively selects the value of x in EQN. 4. From time to time, switching module 708 varies which assembly current signal Iₐₛ is coupled to subtraction module 710, thereby effectively changing the value of x in EQN. 4. For example, in some embodiments, switching module 708 sequentially couples assembly current signal Iₐₛ(1), Iₐₛ(2), Iₐₛ(3), etc. to subtraction module 710 and then repeats the sequence, such that x is effectively stepped from 1, to 2, to 3, and so on.

Subtraction module 710 generates a current difference signal I_{ds} representing a difference between an assembly current signal Iₐₛ selected by switching module 708 and panel current signal Iₚₛ. As discussed above, current through all series-connected portions of photovoltaic panel 400 will be the same under normal conditions, and the magnitude of current difference signal I_{ds} will therefore be essentially zero under normal conditions. A parallel electrical arc affecting current flowing through a selected photovoltaic assembly 402, however, will cause the selected assembly current signal Iₐₛ to differ from panel current signal Iₚₛ, thereby causing current difference signal I_{ds} to have a significant magnitude.

Comparison module 712 determines whether current difference signal I_{ds} exceeds threshold value Iₜₕ, and if so, comparison module 712 asserts a signal ARC2 indicating a parallel electrical arc. Otherwise, panel arc detection subsystem 700 continues to monitor photovoltaic panel 400 for a parallel electrical arc.

Some alternate embodiments of panel arc detection subsystem 700 include additional instances of switching module 708, subtraction module 710, and comparison module 712, such that arc detection subsystem 700 is capable of evaluating additional instances of EQN. 4 at a given time, thereby potentially speeding detection of a parallel electrical arc. Furthermore, a certain alternate embodiment includes N subtraction modules 710 and N comparison modules 712, thereby allowing simultaneous evaluation of N instances of EQN. 4 and eliminating the need for switching module 708.

Modules 702-712 of panel arc detection subsystem 700 may be implemented by electronic circuitry, such as digital electronic circuitry in the case where signals Vₐₛ, Iₐₛ, Vₚₛ, and Iₚₛ are digital signals, or analog electronic circuitry, such as in the case where signals Vₐₛ, Iₐₛ, Vₚₛ, and Iₚₛ are analog signals. Additionally, in some embodiments, panel arc detection subsystem 700 further includes a processor 714 and a memory 716, where processor 714 implements at least some of modules 702-712 by executing instructions 718, in the form of software or firmware, stored in memory 716. In some embodiments, signals ARC1 and ARC2 are combined into a single signal representing either a series or a parallel electrical arc.

FIG. 8 illustrates a panel arc detection subsystem 800, which is another possible implementation of panel arc detection subsystem 428 (FIG. 4). Panel arc detection subsystem 800 is similar to panel arc detection subsystem 700 of FIG. 7, but panel arc detection subsystem 800 is adapted to evaluate EQN. 5, instead of EQN. 4, to detect a parallel electrical arc. Panel arc detection subsystem 800 includes an additional switching module 802 which communicatively couples an assembly current signal Iₐₛ to subtraction module 710. Switching modules 708, 802 collectively select two different assembly current signals Iₐₛ for comparison by subtraction module 710, thereby selecting two different photovoltaic assemblies 402 for monitoring at a given time. Thus, switching modules 708, 802 effectively select the value of x and the value of y, respectively, for EQN. 5. From time to time, switching modules 708, 802 vary which assembly current signals Iₐₛ are coupled to subtraction module 710, thereby effectively changing the values of x and y in EQN. 5. For example, in some embodiments, switching module 708 communicatively couples assembly current signal Iₐₛ(m) to subtraction module 710, and switching module 802 communicatively couples assembly current signal Iₐₛ(m+1) to subtraction module 710, where m is repeatedly stepped through all integers ranging from 1 to N−1.

In some alternate embodiments, panel arc detection subsystem 428 is capable of detecting only a series electrical arc or a parallel electrical arc, instead of both series and parallel electrical arcs. For example, modules 708-712 are omitted in some alternate embodiments of panel arc detection subsystem 700 (FIG. 7) not having parallel electrical arc detection capability. As another example, modules 702-706 are omitted in some alternate embodiments of panel arc detection subsystem 700 not having series electrical arc detection capability.

In some embodiments, photovoltaic panel 400 additionally includes a panel isolation switch 436 and/or a panel shorting switch 438. Although switches 436, 438 are shown as being part of panel manager 422, one or more of these switches could be separate from panel manager 422 without departing from the scope hereof. Panel isolation switch 436 is electrically coupled in series with photovoltaic assemblies 402 and is closed during normal operating conditions. In response to panel arc detection subsystem 428 detecting an electrical arc in photovoltaic panel 400, panel isolation switch 436 opens to extinguish the arc. Opening of panel isolation switch 436, however, will only extinguish a series electrical arc in photovoltaic panel 400. Accordingly, in some embodiments where panel arc detection subsystem 428 is implemented as shown in FIG. 7 or FIG. 8, panel isolation switch 436 opens in response to assertion of signal ARC1 indicating a series electrical arc. Panel isolation switch 436 must be able to withstand the maximum possible voltage across power rails 408, 410. Additionally, panel isolation switch 436 should have a low on-resistance to prevent excessive power dissipation in the isolation switch during normal operating conditions.

Panel shorting switch 438 is electrically coupled across power rails 408, 410, and the switch is open during normal operating conditions. In response to panel arc detection subsystem 428 detecting an electrical arc in photovoltaic panel 400, panel shorting switch 438 closes to extinguish the arc. Panel shorting switch 438 is advantageously capable of extinguishing both parallel and series electrical arcs. Accordingly, in some embodiments where panel arc detection subsystem 428 is implemented as shown in FIG. 7 or FIG. 8, panel shorting switch 438 closes in response to assertion of either signal ARC1 indicating a series electrical arc or signal ARC2 indicating a parallel arc. Additionally, use of panel shorting switch 438 to extinguish an electrical arc does not interrupt current flowing through other devices electrically coupled in series with photovoltaic panel 400. Thus, incorporation of panel shorting switch 438 may be particularly advantageous in applications where photovoltaic panel 400 is part of a series string of photovoltaic devices, such that string current can continue to flow through photovoltaic panel 400 while an electrical arc within the panel is extinguished. Panel shorting switch 438 must be able to withstand the maximum voltage across power rails 408, 410, and panel shorting switch 438 must also be able to withstand the highest short circuit current of photovoltaic assemblies 402. In embodiments where photovoltaic panel 400 is intended to be electrically coupled in series with other power sources, such as other photovoltaic panels, panel shorting switch 438 must be capable of withstanding the maximum bypass current expected to pass through photovoltaic panel 400.

In some embodiments where panel manager 422 includes telemetry subsystem 430, the telemetry subsystem is adapted to signal an external system in response to detection of an electrical arc. For example, in some embodiments where panel arc detection subsystem 428 is implemented as shown in FIG. 7 or FIG. 8, telemetry subsystem 430 signals an external subsystem that a series or parallel electrical arc has occurred in response to assertion of signal ARC1 or ARC2, respectively.

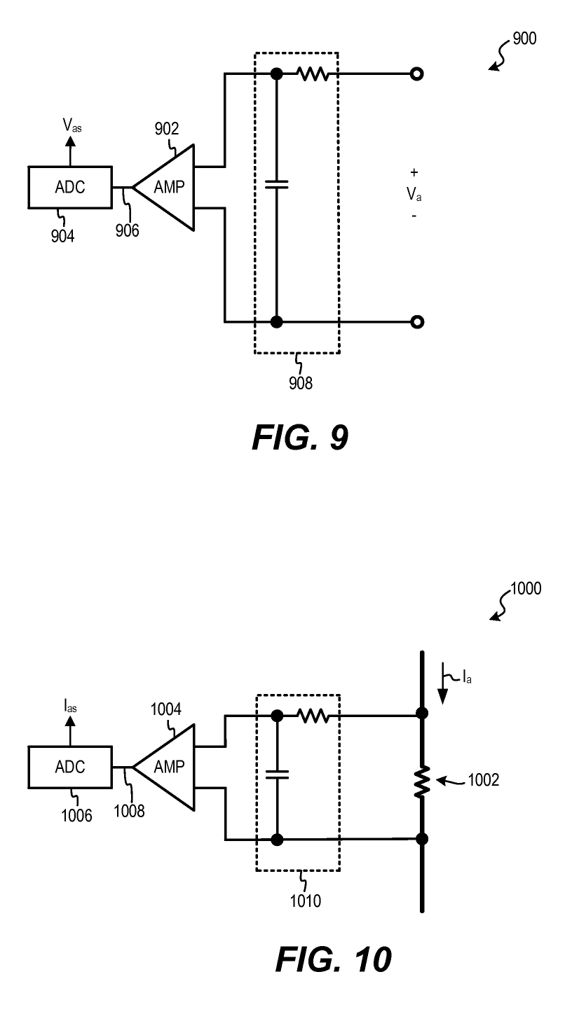

FIG. 9 illustrates an assembly voltage sensing subsystem 900, which is one possible implementation of assembly voltage sensing subsystem 418 of FIG. 4. Assembly voltage sensing subsystem 900 includes an amplifier 902 and an analog to digital converter (ADC) 904. Amplifier 902 amplifies voltage Vₐ across output port 406, and an analog output 906 of amplifier 902 is digitized by ADC 904 to generate an assembly voltage signal Vₐₛ in digital format. A low-pass filter 908 is optionally electrically coupled to the input of amplifier 902, to help eliminate AC components from the assembly voltage signal. Although low-pass filter 908 is shown as being a single-pole resistive-capacitive (RC) filter, low-pass filter 908 could take other forms without departing from the scope hereof.

FIG. 10 illustrates an assembly current sensing subsystem 1000, which is one possible implementation of assembly current sensing subsystem 420 of FIG. 4. Assembly current sensing subsystem 1000 includes a current sense resistor 1002, an amplifier 1004, and an ADC 1006. Current sense resistor 1002 is electrically coupled in series with photovoltaic device 404, such that assembly current Iₐ flows through current sense resistor 1002. Current sense resistor 1002 has a small resistance value, such as several milliohms, to minimize power dissipation in the resistor. Amplifier 1004 amplifies a voltage across current sense resistor 1002, and ADC 1006 digitizes an analog output 1008 of amplifier 1004 to generate an assembly current signal Iₐₛ in digital format. A low-pass filter 1010 is optionally electrically coupled to the input of amplifier 1004, to help eliminate AC components from the assembly current signal. Although low-pass filter 1010 is shown as being a single-pole RC filter, low-pass filter 1010 could take other forms without departing from the scope hereof.

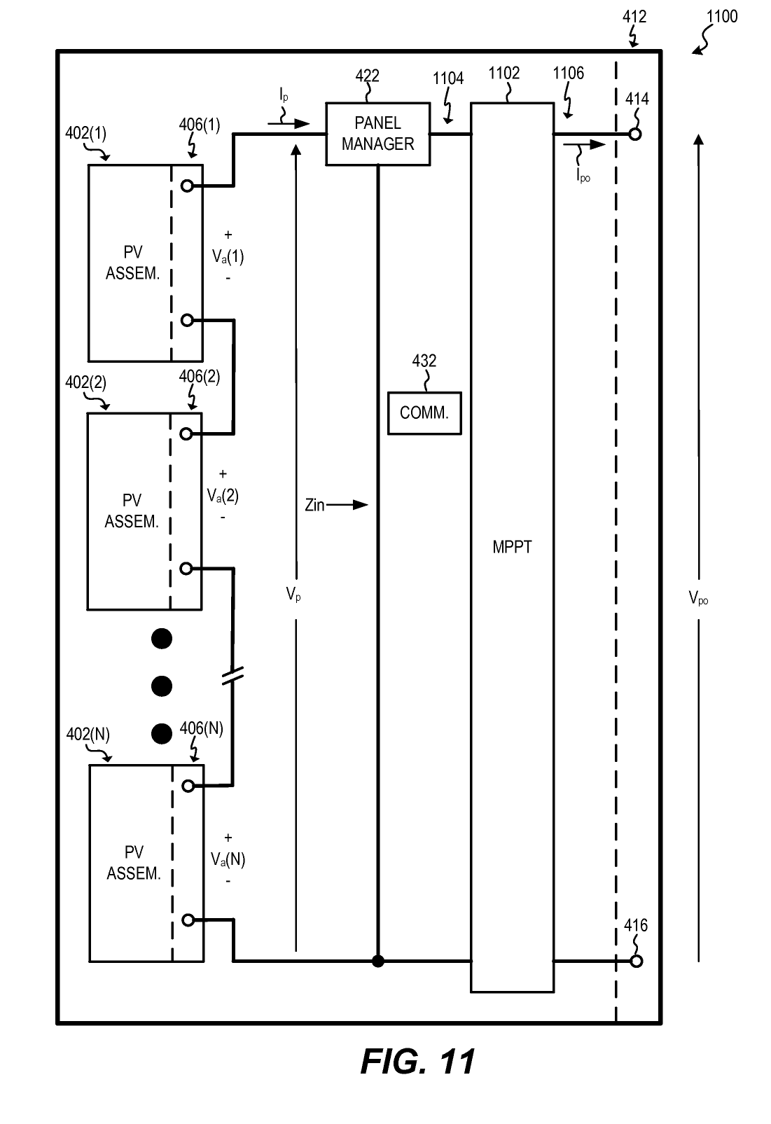

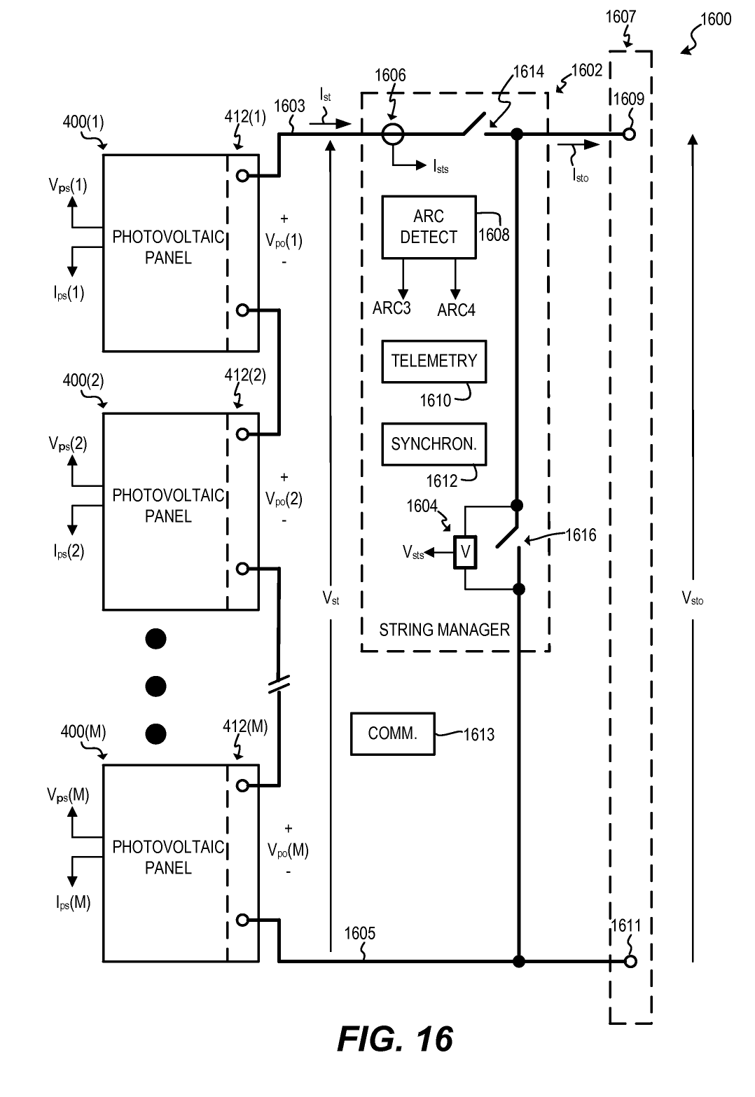

Photovoltaic panel 400 could be modified to have panel-level maximum power point tracking (MPPT) capability, photovoltaic assembly-level MPPT capability, and/or inversion capability. For example, FIG. 11 illustrates a photovoltaic panel 1100, which is similar to photovoltaic panel 400 of FIG. 4, but further includes a panel-level MPPT converter 1102 electrically coupled between photovoltaic assemblies 402 and panel output port 412. Details of photovoltaic assemblies 402 and panel manager 422 are omitted in FIG. 11 to promote illustrative clarity. MPPT converter 1102 adjusts its input impedance Zin, as seen by photovoltaic assemblies 402, such that photovoltaic assemblies 402 operate substantially at their collective maximum power point. Although panel manager 422 is shown as being electrically coupled to an input 1104 of MPPT converter 1102, panel manager 422 could alternately be electrically coupled to an output 1106 of MPPT converter 1102. In some embodiments, some or all of panel manager 422 is implemented within MPPT converter 1102. Panel voltage Vₚ is not the same as panel output voltage Vₚₒ, and panel current Iₚ is not the same as panel output current Iₚₒ, due to inclusion of MPPT converter 1102. According, some embodiments additionally include a subsystem (not shown) for generating a signal representing panel output voltage Vₚₒ, and/or a subsystem (not shown) for generating a signal representing panel output current Iₚₒ. Panel output voltage signals and panel output current signals are used, for example, for string-level electrical arc detection in applications where multiple photovoltaic panel 1100 instances are series coupled to form a photovoltaic string, such as discussed below with respect to FIG. 16.

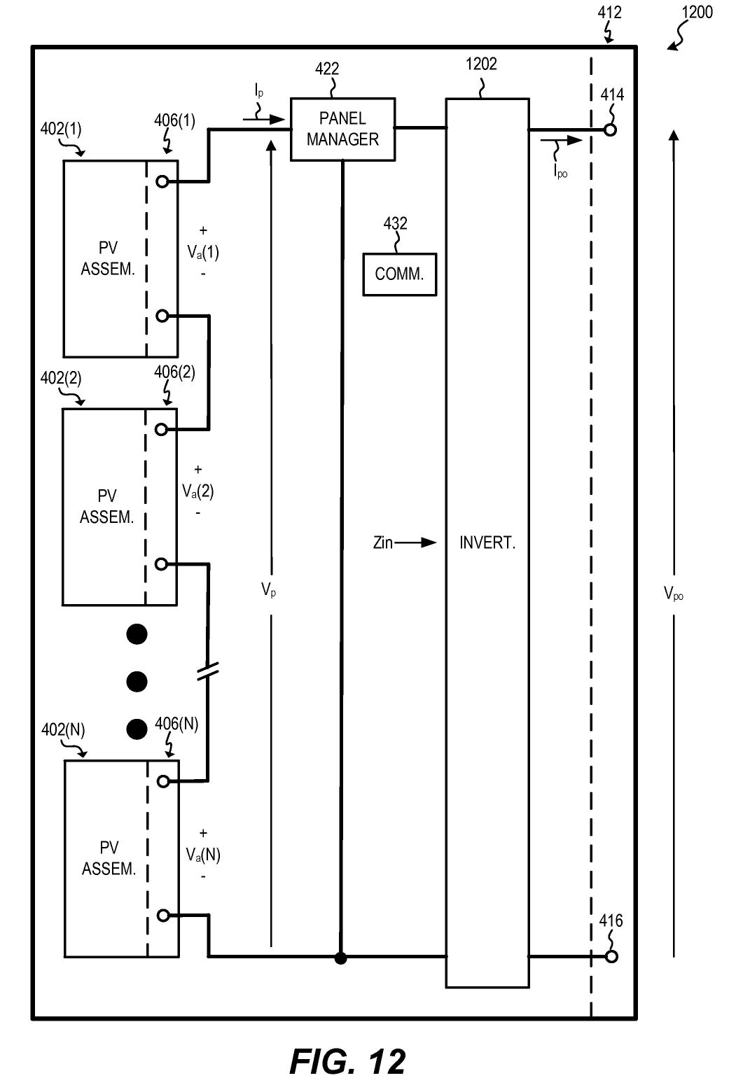

As another example, FIG. 12 illustrates a photovoltaic panel 1200, which is similar to photovoltaic panel 400, but further including a microinverter 1202 electrically coupled between photovoltaic assemblies 402 and panel output port 412. Details of photovoltaic assemblies 402 and panel manager 422 are omitted in FIG. 12 to promote illustrative clarity. Microinverter 1202 converts direct current (DC) power generated by photovoltaic assemblies 402 into AC power, such as for powering building electrical loads and/or an AC power grid. Microinverter 1202 optionally also has MPPT capability, where microinverter 1202 adjusts its input impedance Zin, as seen by photovoltaic assemblies 402, such that photovoltaic assemblies 402 operate substantially at their collective maximum power point. In some embodiments, some or all of panel manager 422 is implemented within microinverter 1202. Panel voltage Vₚ is not the same as panel output voltage Vₚₒ, and panel current Iₚ is not the same as panel output current Iₚₒ, due to inclusion of inverter 1202.

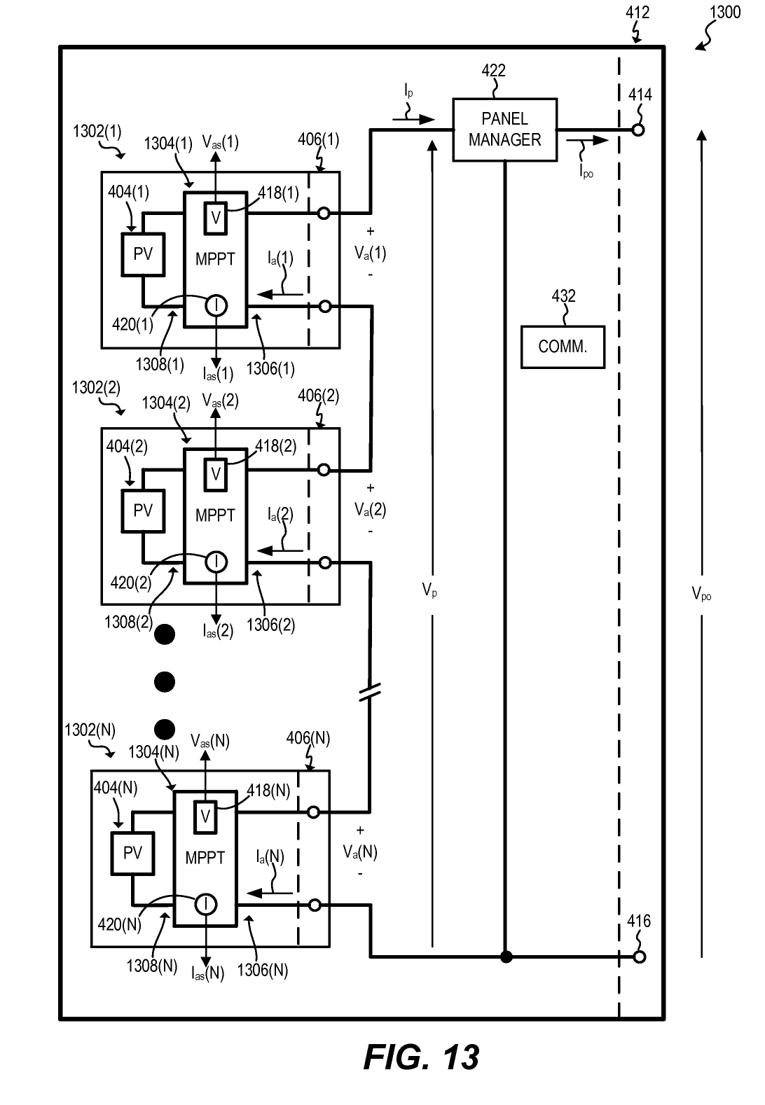

FIG. 13 shows a photovoltaic panel 1300 including photovoltaic assembly-level MPPT. Photovoltaic panel 1300 is similar to photovoltaic panel 400 of FIG. 4, but photovoltaic panel 1300 includes photovoltaic assemblies 1302 in place of photovoltaic assemblies 402. Details of panel manager 422 are omitted in FIG. 13 to promote illustrative clarity. Photovoltaic assemblies 1302 are like photovoltaic assemblies 402, but further include a MPPT converter 1304 electrically coupled between photovoltaic device 404 and output port 406. Each MPPT converter 1304 adjusts its input impedance such that its respective photovoltaic device 404 operates substantially at its maximum power point. Assembly voltage sensing subsystems 418 and/or assembly current sensing subsystems 420 are optionally implemented within MPPT converters 1304, as shown. Photovoltaic panel 1300 optionally further includes a panel-level MPPT converter or a microinverter (not shown), such as similar to MPPT converter 1102 of FIG. 11 or microinverter 1202 of FIG. 12.

Panel arc detection subsystem 428 is capable of detecting an electrical arc on the output side 1306 of MPPT converters 1304. However, MPPT converters 1304 prevent panel arc detection subsystem 428 from detecting an electrical arc on the input side 1308 of MPPT converters 1304. Accordingly, in some embodiments, photovoltaic devices 404 have a maximum open circuit voltage rating that is sufficiently low, such as less than 80 volts, so that electrical arc detection is not required under applicable safety standards. Furthermore, in some embodiments, photovoltaic devices 404 have a maximum open circuit voltage rating that is lower than a minimum voltage required to sustain an electrical arc on the input side 1308 of MPPT converters 1304. For example, in certain embodiments, photovoltaic devices 404 include at least one, but no more than 24, photovoltaic cells electrically coupled in series, so that maximum open circuit voltage of photovoltaic devices 404 is 18 volts or less. Limiting open circuit voltage to a maximum value of about 18 volts essentially eliminates the possibility of an electrical arc on the input side 1308 of MPPT converters 1304 in typical photovoltaic panel applications, as testing has shown that around 43 volts is required to sustain an electrical arc across a 0.0625 inch electrode gap.

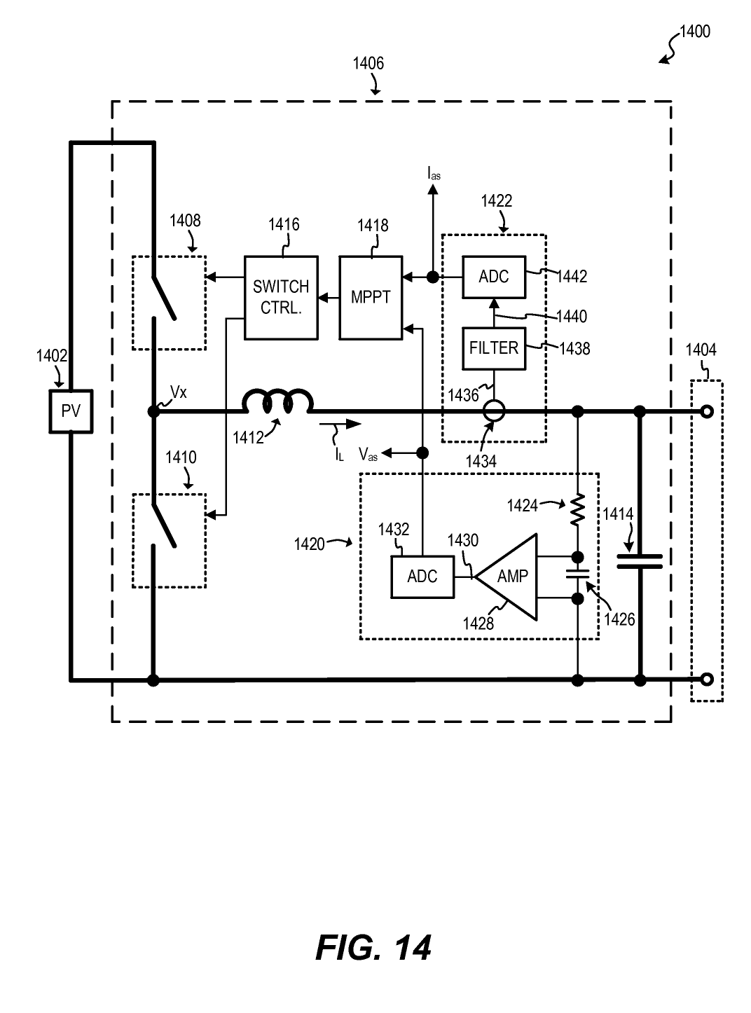

FIG. 14 illustrates a photovoltaic assembly 1400, which is one possible implementation of photovoltaic of photovoltaic assembly 1302 of FIG. 13. Photovoltaic assembly 1400 includes a photovoltaic device 1402, an output port 1404, and an MPPT converter 1406 electrically coupled between photovoltaic device 1402 and output port 1404. Each photovoltaic device 1402 includes one or more photovoltaic cells electrically coupled in series and/or parallel.

MPPT converter 1406 includes a control switching device 1408 and a freewheeling switching device 1410 electrically coupled in series across photovoltaic device 1402. Switching devices 1408, 1410 are electrically coupled together at a switching node Vx. Each switching device 1408, 1410 includes, for example, one or more transistors. In some embodiments, freewheeling switching device 1410 is supplemented by, or replaced with, a diode. An inductor 1412 is electrically coupled between switching node Vx and output port 1404, and a capacitor 1414 is electrically coupled across output port 1404. Switching devices 1408, 1410, inductor 1412, and capacitor 1414 collectively form a buck converter operating under the control of a switching control subsystem 1416 and a MPPT subsystem 1418.

MPPT converter 1406 further includes a voltage sensing subsystem 1420 and a current sensing subsystem 1422. Voltage sensing subsystem 1420 includes a resistor 1424 and a capacitor 1426 electrically coupled across output port 1404 to form a low-pass R-C filter. A voltage across capacitor 1426 is amplified by an amplifier 1428, and an analog output 1430 of amplifier 1428 is digitized by an ADC 1432. ADC 1432 generates an assembly voltage signal Vₐₛ in digital format from analog output 1430. The assembly voltage signal is communicatively coupled to panel arc detection subsystem 428 and to MPPT subsystem 1418. MPPT subsystem 1418 uses the assembly voltage signal for determining output power, as discussed below. Thus, voltage sensing subsystem 1420 supports both photovoltaic assembly MPPT and photovoltaic panel electrical arc detection. In some alternate embodiments, the low-pass R-C filter formed of resistor 1424 and capacitor 1426 is replaced with an alternative low-pass filter.

Current sensing subsystem 1422 includes reconstructor circuitry 1434, which generates a signal 1436 representing current I_{L} flowing through MPPT converter 1406. In some embodiments, reconstructor circuitry 1434 employs systems and methods disclosed in one or more of U.S. Pat. Nos. 6,160,441 and 6,445,244 to Stratakos et al., each of which is incorporated herein by reference, to generate current signal 1436 based on current flowing through switching devices 1408, 1410. A low-pass filter 1438 generates a filtered signal 1440, which is digitized by an ADC 1442 to generate an assembly current signal Iₐₛ. The assembly current signal represents the DC value of current I_{L}. The assembly current signal is communicatively coupled to panel arc detection subsystem 428 and to MPPT subsystem 1418. MPPT subsystem 1418 uses the assembly current signal for determining output power, as discussed below. Thus, current sensing subsystem 1422 supports both MPPT and photovoltaic panel electrical arc detection.

Switching control subsystem 1416 controls switching of switching devices 1408, 1410 under the control of MPPT subsystem 1418 to substantially maximize power generated by photovoltaic device 1402. Specifically, MPPT subsystem 1418 determines photovoltaic assembly output power from the product of the assembly voltage and assembly current signals, and MPPT subsystem 1418 causes switching control subsystem 1416 to adjust duty cycle of control switching device 1408 to control MPPT converter 1406 input impedance to maximize power out of output port 1404.

In some alternate embodiments, voltage sensing subsystem 1420 is modified to sense voltage at switching node Vx, instead of across output port 1404. Although the voltage at switching node Vx has a large AC component, the low pass filter formed by resistor 1424 and capacitor 1426 substantially removes the AC component, such that essentially only the DC component remains. The DC component of the voltage at switching node Vx is essentially the same as the voltage across output port 1404, and the assembly voltage signal therefore represents the voltage across output port 1404.

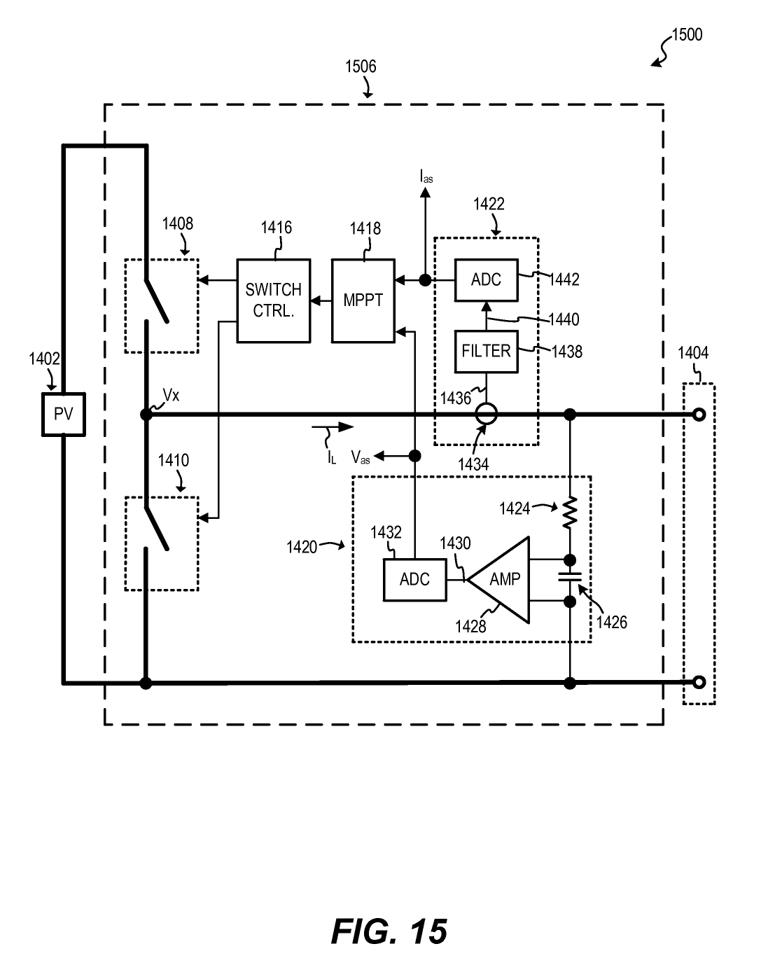

FIG. 15 illustrates a photovoltaic assembly 1500, which is another possible implementation of photovoltaic assembly 1302 of FIG. 13. Photovoltaic assembly 1500 is similar to photovoltaic assembly 1400 of FIG. 14, but inductor 1412 and capacitor 1414 omitted. MPPT converter 1506 relies on inductance and capacitance external to photovoltaic assembly 1500 in place of inductor 1412 and capacitor 1414. For example, in some applications, multiple instances of photovoltaic assembly 1500 share common output inductance and output capacitance. The common output inductance includes, for example, interconnection inductance of a circuit including output ports 1404. Although voltage across output port 1404 will have a large AC component in photovoltaic assembly 1500, resistor 1424 and capacitor 1426 substantially remove the AC component before amplification by amplifier 1428, such the assembly voltage signal represents the DC component of the output port 1404 voltage.

The arc detection techniques disclosed above may also be applied to a string of photovoltaic devices. For example, FIG. 16 illustrates a photovoltaic string 1600 having electrical arc detection capability. Photovoltaic string 1600 includes M photovoltaic panels 400 (FIG. 4) electrically coupled in series between a positive string power rail 1603 and a negative string power rail 1605, where M is an integer greater than one. Photovoltaic string 1600 further includes a panel output port 1607 having a positive output terminal 1609 and a negative output terminal 1611 electrically coupled to positive string power rail 1603 and negative string power rail 1605, respectively. Details of photovoltaic panels 400 are not shown in FIG. 16 to promote illustrative clarity. Photovoltaic string 1600 further includes a string manager 1602, which is analogous to panel manager 422. Specifically, string manager 1602 includes a string voltage sensing subsystem 1604, a string current sensing subsystem 1606, a string arc detection subsystem 1608, an optional telemetry subsystem 1610, and an optional synchronization subsystem 1612. String voltage sensing subsystem 1604 generates a string voltage signal Vₛₜₛ representing string voltage Vₛₜ across string power rails 1603, 1605. String current sensing subsystem 1606 generates a string current signal Iₛₜₛ representing current Iₛₜ flowing between photovoltaic panels 400 and other circuitry. In this embodiment, string voltage Vₛₜ is the same as string output voltage Vₛₜₒ across string output port 1607, and signal Vₛₜₛ therefore represents string output voltage Vₛₜₒ as well as string voltage Vₛₜ. String current Iₛₜ is the same as string output current Iₛₜₒ flowing through output port 1607, and signal Iₛₜₛ therefore represents string output current Iₛₜₒ as well as string current Iₛₜ. Optional synchronization subsystem 1612 synchronizes generation of signals Vₛₜₛ and Iₛₜₛ, and in some embodiments, synchronization subsystem 1612 cooperates with synchronization subsystems 434 of photovoltaic panels 400 (FIG. 4), to synchronize generation of signals Vₛₜₛ and Iₛₜₛ with generation of signal Vₚₛ and Iₚₛ.

Communication network 1613 communicatively couple signals Vₚₛ and Iₚₛ from photovoltaic panels 400 to string manager 1602. In some embodiments, communication network 1613 includes a dedicated electrical or optical conductor communicatively coupling each signal Vₚₛ and Iₚₛ from photovoltaic panels 400 to string manager 1602. In some other embodiments, such as when string manager 1602 is remote from photovoltaic panels 400, communication network 1613 includes systems which facilitate transmitting multiple signals over significant distances, such as wireless networks or wired networks based on the RS485 standard. Some examples of possible wireless networks include, but are not limited to, wireless networks based on the IEEE802.15.4 standard and cellular telephone networks.

String arc detection subsystem 1608 detects an electrical arc within string 1600 in a manner similar to how panel arc detection subsystem 428 detects an arc within photovoltaic panel 400. Specifically, string arc detection subsystem 1608 detects a series electrical arc within photovoltaic string 1600 from a discrepancy between string voltage Vₛₜ and a sum of all panel output voltages Vₚₒ. For example, in some embodiments, string arc detection subsystem 1608 detects a series electrical arc within string 1600 when EQN. 6 holds true, where Vₜₕₛₜ is a positive threshold value chosen to achieve a desired tradeoff between electrical arc detection sensitivity and immunity to false electrical arc detection:

[Σₙ₌₁^{N}Vₚₛ(n)−Vₛₜₛ]>Vₜₕₛₜ (EQN. 6)

String arc detection subsystem 1608 detects a parallel electrical arc within photovoltaic string 1600 from a discrepancy in current flowing between different portions of the string at a given time, such as from a discrepancy between current flowing through two different photovoltaic panels 400, or from a discrepancy between current flowing through a selected photovoltaic panel 400 and current flowing between the photovoltaic panel and other circuitry. For example, in some embodiments, string arc detection subsystem 1608 detects a parallel electrical arc within photovoltaic string 1600 when EQN. 7 holds true, where x is an integer ranging from 1 to M:

|Iₛₜₛ−Iₚₛ(x)|>Iₜₕₛₜ (EQN. 7)

In other embodiments, string arc detection subsystem 1608 detects a parallel electrical arc within string 1600 when EQN. 8 holds true, where x and y are each integers ranging from 1 to M, and x does not equal y:

|Iₚₛ(x)−Iₚₛ(y)|>Iₜₕₛₜ (EQN. 8)

In both EQNS. 7 and 8, Iₜₕₛₜ is a positive threshold value chosen to achieve a desired tradeoff between electrical arc detection sensitivity and immunity to false electrical arc detection. String current sensing subsystem 1606 is optionally omitted in embodiments evaluating EQN. 8 since panel current signal Iₛₜₛ is not a parameter of EQN. 8.

In some embodiments, string arc detection subsystem 1608 is capable of evaluating only one instance of either EQN. 7 or 8 at a given time. In these embodiments, string arc detection subsystem 1608 varies the value of x, or both x and y (if applicable), so that different portions of string 1600 are selected for parallel electrical arc detection. In some other embodiments, string arc detection subsystem 1608 is capable of evaluating several instances of either EQN. 7 or EQN. 8 at a given time, thereby potentially speeding detection of a parallel electrical arc. In embodiments evaluating multiple EQN. 7 instances at a given time, each instance has a different value of x. In embodiments evaluating multiple EQN. 8 instances at a given time, each instance has a different combination of x and y values.

In some alternate embodiments, part or all of string voltage sensing subsystem 1604, string current sensing subsystem 1606, string arc detection subsystem 1608, telemetry subsystem 1610 and/or synchronization subsystem 1612 are separate from string manager 1602. Furthermore, in some other alternate embodiments, string manager 1602 is omitted and string voltage sensing subsystem 1604, string current sensing subsystem 1606, string arc detection subsystem 1608, telemetry subsystem 1610, and synchronization subsystem 1612 are stand-alone subsystems or part of other subsystems of string 1600.

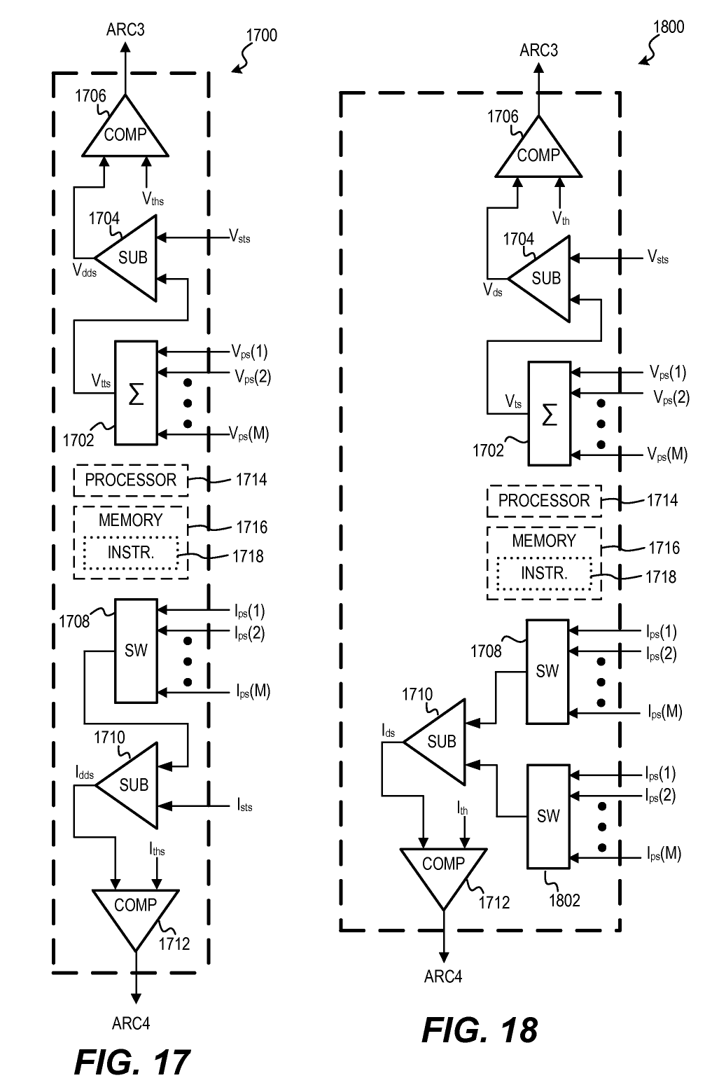

FIG. 17 illustrates a string arc detection subsystem 1700, which is one possible implementation of string arc detection subsystem 1608 (FIG. 16). String arc detection subsystem 1700, which is similar to string panel arc detection subsystem 700 of FIG. 7, includes a summation module 1702, a subtraction module 1704, and a comparison module 1706, which collectively detect a series electrical arc within photovoltaic string 1600 by evaluating EQN. 6. In particular, summation module 1702 generates a total voltage signal Vₜₜₛ representing a sum of all panel voltage signals Vₚₛ. Subtraction module 1704 generates a voltage difference signal V_{dds} representing a difference between total voltage signal Vₜₜₛ and string voltage signal Vₛₜₛ. Thus, voltage difference signal V_{dds} represents a discrepancy between string voltage Vₛₜ and the sum of all panel voltages Vₚ. String voltage Vₛₜ should be substantially equal to the sum of all panel voltages Vₚ at a given time. Thus, voltage difference signal V_{dds} will be very small unless there is a series electrical arc in photovoltaic string 1600.

Comparison module 1706 determines whether voltage difference signal V_{dds} exceeds threshold value Vₜₕₛ, and if so, comparison module 1706 asserts a signal ARC3 representing a series electrical arc in photovoltaic string 1600. Otherwise, arc detection subsystem 1700 continues to monitor photovoltaic string 1600 for a series electrical arc.

String arc detection subsystem 1700 further includes a switching module 1708, a subtraction module 1710, and a comparison module 1712 which collectively detect a parallel electrical arc in photovoltaic string 1600 by evaluating EQN. 7. Switching module 1708 selects one of the M panel current signals Iₚₛ for communicative coupling to subtraction module 1710, thereby selecting one photovoltaic panel 400 for monitoring. Thus, switching module 1708 effectively selects the value of x in EQN. 7. From time to time, switching module 1708 varies which panel current signal Iₚₛ is coupled to subtraction module 1710, thereby effectively changing the value of x in EQN. 7.

Subtraction module 1710 generates a current difference signal I_{dds} representing a difference between a panel current signal Iₚₛ selected by switching module 1708 and string current signal Iₛₜₛ. Current through all portions of photovoltaic string 1600 will be the same under normal operating conditions, and the magnitude of current difference signal I_{dds} will therefore be essentially zero under normal operating conditions. A parallel electrical arc affecting current flowing through a selected photovoltaic panel 400, however, will cause the selected panel current signal Iₚₛ to differ from string current signal Iₛₜₛ, thereby causing current difference signal I_{dds} to have a significant magnitude.

Comparison module 1712 determines whether current difference signal I_{dds} exceeds threshold value Iₜₕₛ, and if so, comparison module 1712 asserts a signal ARC4 indicating a parallel electrical arc in photovoltaic string 1600. Otherwise, string arc detection subsystem 1700 continues to monitor photovoltaic string 1600 for a parallel electrical arc.

Some alternate embodiments of string arc detection subsystem 1700 include additional instances of switching module 1708, subtraction module 1710, and comparison module 1712, such that string arc detection subsystem 1700 is capable of evaluating additional instances of EQN. 7 at a given time, thereby potentially speeding detection of a parallel electrical arc. Furthermore, a certain alternate embodiment includes M subtraction modules 1710 and M comparison modules 1712, thereby allowing simultaneous evaluation of M instances of EQN. 7 and eliminating the need for switching module 1708.

Modules 1702-1712 of string arc detection subsystem 1700 may be implemented by electronic circuitry, such as digital electronic circuitry in the case where signals Vₚₛ, Iₚₛ, Vₛₜₛ, and Iₛₜₛ are digital signals, or analog electronic circuitry, such as in the case where signals Vₚₛ, Iₚₛ, Vₛₜₛ, and Iₛₜₛ are analog signals. Additionally, in some embodiments, string arc detection subsystem 1700 further includes a processor 1714 and a memory 1716, where processor 1714 implements at least some of modules 1702-1712 by executing instructions 1718, in the form of software or firmware, stored in memory 1716. In some embodiments, signals ARC3 and ARC4 are combined into a single signal representing either a series or a parallel electrical arc in photovoltaic string 1600.

FIG. 18 illustrates a string arc detection subsystem 1800, which is another possible implementation of string arc detection subsystem 1608 (FIG. 16). String arc detection subsystem 1800 is similar to string arc detection subsystem 1700 of FIG. 17, but string arc detection subsystem 1800 is adapted to evaluate EQN. 8, instead of EQN. 7, to detect a parallel electrical arc in photovoltaic string 1600. String arc detection subsystem 1800 includes an additional switching module 1802 which communicatively couples a panel current signal Iₚₛ to subtraction module 1710. Switching modules 1708, 1802 collectively select two different panel current signals for comparison by subtraction module 1710, thereby selecting two different photovoltaic panels 400 for monitoring at a given time. Thus, switching modules 1708, 1802 effectively select the value of x and the value of y, respectively, for EQN. 8. From time to time, switching modules 1708, 1802 vary which panel current signals I_{P}, are coupled to subtraction module 1710, thereby effectively changing the values of x and y in EQN. 8.

In some alternate embodiments, string arc detection subsystem 1608 is capable of detecting only a series electrical arc or a parallel electrical arc, instead of both series and parallel electrical arcs. For example, modules 1708-1712 are omitted in some alternate embodiments of arc detection subsystem 1700 (FIG. 17) not having parallel electrical arc detection capability. As another example, modules 1702-1706 are omitted in some alternate embodiments of arc detection subsystem 1700 not having series electrical arc detection capability.

In some embodiments, photovoltaic string 1600 additionally includes a string isolation switch 1614 and/or a string shorting switch 1616. Although switches 1614, 1616 are shown as being part of string manager 1602, one or more of these switches could be separate from string manager 1602 without departing from the scope hereof. String isolation switch 1614 is electrically coupled in series with photovoltaic panels 400 and is closed during normal operating conditions. In response to string arc detection subsystem 1608 detecting an electrical arc in photovoltaic string 1600, string isolation switch 1614 opens to extinguish the arc. Opening of string isolation switch 1614, however, will only extinguish a series electrical arc in photovoltaic string 1600. Accordingly, in some embodiments where string arc detection subsystem 1608 is implemented as shown in FIG. 17 or FIG. 18, string isolation switch 1614 opens in response to assertion of signal ARC3 indicating a series electrical arc in photovoltaic string 1600. String isolation switch 1614 must be able to withstand the maximum possible voltage across photovoltaic string 1600. Additionally, string isolation switch 1614 should have a low on-resistance to prevent excessive power dissipation in the isolation switch during normal operating conditions.

String shorting switch 1616 is electrically coupled across power rails 1603, 1605 and is open during normal operating conditions. In response to string arc detection subsystem 1608 detecting an electrical arc in photovoltaic string 1600, string shorting switch 1616 closes to extinguish the arc. String shorting switch 1616 is advantageously capable of extinguishing both parallel and series electrical arcs in photovoltaic string 1600. Accordingly, in some embodiments where string arc detection subsystem 1608 is implemented as shown in FIG. 17 or FIG. 18, string shorting switch 1616 closes in response to assertion of either signal ARC3 indicating a series electrical arc in photovoltaic string 1600 or signal ARC4 indicating a parallel arc in photovoltaic string 1600. String shorting switch 1616 must be able to withstand the maximum voltage across photovoltaic string 1600, and string shorting switch 1616 must also be able to withstand the highest short current of photovoltaic panels 400.

In some embodiments where string manager 1602 includes telemetry subsystem 1610, the telemetry subsystem is adapted to signal an external system in response to detection of an electrical arc by string arc detection subsystem 1608. For example, in some embodiments where string arc detection subsystem 1608 is implemented as shown in FIG. 17 or FIG. 18, telemetry subsystem 1610 signals an external subsystem that a series or parallel electrical has occurred in response to assertion of signal ARC3 and ARC4, respectively.

In some alternate embodiments, one or more of photovoltaic panels 400 of photovoltaic string 1600 are replaced with a different type of photovoltaic panel, which may or may not have panel-level electrical arc detection capability. In any event, each photovoltaic panel of photovoltaic string 1600 must be capable of generating a respective signal representing voltage across the panel's output port, for string arc detection subsystem 1608 to detect a series electrical arc in photovoltaic string 1600. Additionally, each photovoltaic panel of photovoltaic string 1600 must be capable of generating a respective signal representing current flowing through the panel's output port, for string arc detection subsystem 1608 to be capable of fully monitoring photovoltaic string 1600 for a parallel electrical arc.

String 1600 could be modified to include a string-level MPPT converter (not shown), such as analogous to MPPT converter 1102 (FIG. 11), electrically coupling the plurality of photovoltaic panels 400 to string output port 1607, without departing from the scope hereof. In such case, string voltage Vₛₜ would not necessarily be the same as string output voltage Vₛₜₒ, and string current Iₛₜ would not necessarily be the same as string output current Iₛₜₒ, due to inclusion of the MPPT converter. Additionally, string 1600 could be modified to include a string-level inverter (not shown), such as analogous to inverter 1202 (FIG. 12), electrically coupling the plurality of photovoltaic panels 400 to string output port 1607, without departing from the scope hereof. In such case, string voltage Vₛₜ would differ from string output voltage Vₛₜₒ, and string current Iₛₜ would differ from string output current Iₛₜₒ, due to inclusion of the inverter.

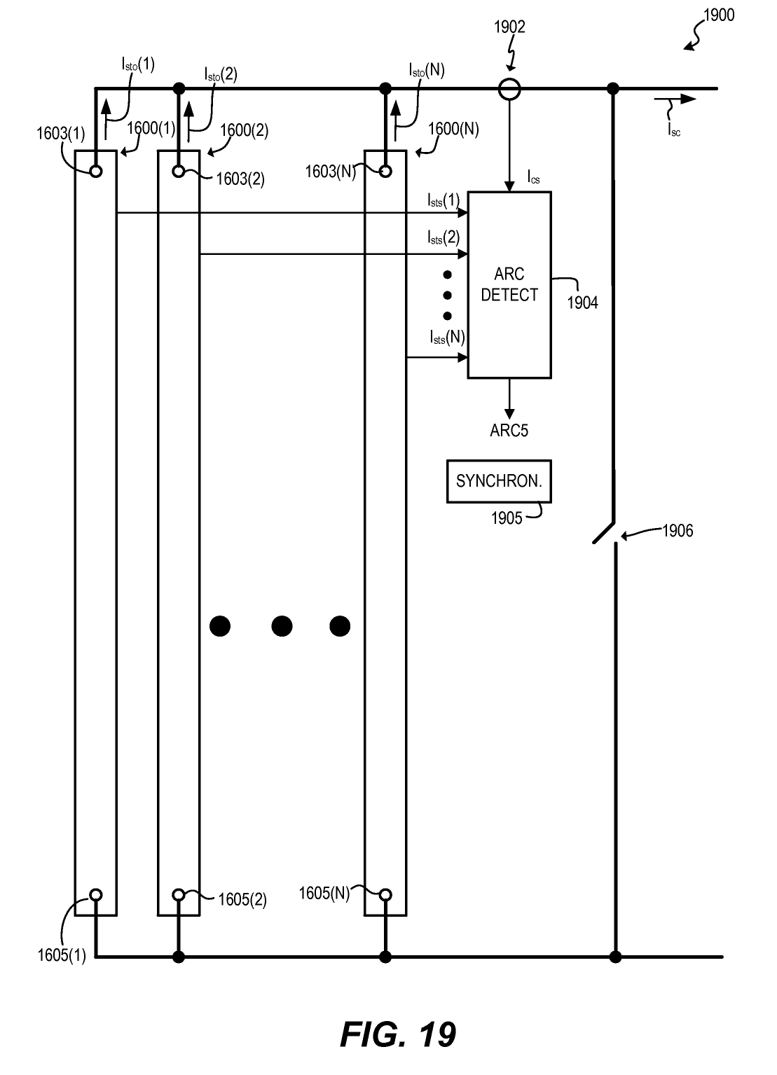

The parallel arc detection techniques disclosed above may also be applied to photovoltaic systems including multiple strings electrically coupled in parallel. For example, FIG. 19 illustrates a photovoltaic system 1900 having system-level parallel arc detection capability and including N strings 1600 (FIG. 16) electrically coupled in parallel, where N is an integer greater than one. Photovoltaic system 1900 further includes a combined current sensing subsystem 1902, a system-level arc detection subsystem 1904, and an optional synchronization subsystem 1905. Combined current sensing subsystem 1902 generates a combined current signal I_{cs} representing combined current I_{c} flowing between all of the parallel coupled strings 1600 and other circuitry (not shown). Synchronization subsystem 1905 synchronizes generation of combined current signal I_{cs} with string current signals Iₛₜₛ.

Under normal operating conditions, the sum of all string output currents Iₛₜₒ should be the same as combined current I_{c}. In the event of a parallel electrical arc in system 1900, combined current I_{c} will differ from the sum of all string output currents Iₛₜₒ. Accordingly, system-level arc detection subsystem 1904 detects a parallel electrical arc within photovoltaic system 1900 from a discrepancy between the sum of all string output currents Iₛₜₒ and combined current I_{c}. For example, in some embodiments, system-level arc detection subsystem 1904 detects a parallel electrical arc when EQN. 9 holds true, where I_{thy} is a positive threshold value chosen to achieve a desired tradeoff between electrical arc detection sensitivity and immunity to false electrical arc detection:

|I_{cs}−Σₙ₌₁^{N}Iₛₜₛ(n)|>I_{thy} (EQN. 9)

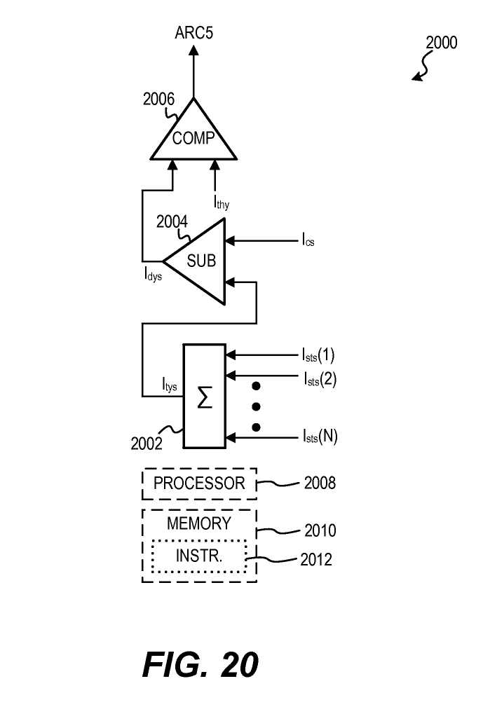

FIG. 20 illustrates a system-level arc detection subsystem 2000, which is one possible implementation of system-level arc detection subsystem 1904 (FIG. 19). System-level arc detection subsystem 2000 includes a summation module 2002, a subtraction module 2004, and a comparison module 2006, which collectively detect a parallel electrical arc within photovoltaic system 1900 by evaluating EQN. 9. In particular, summation module 2002 generates a total current signal I_{tys} representing a sum of all string current signals Iₛₜₛ. Subtraction module 2004 generates a current difference signal I_{dys} representing a difference between total current signal I_{tys} and combined current signal I_{cs}. Thus, current difference signal I_{ys} represents a discrepancy between combined current I_{cs} and the sum of all string currents Iₛₜ. Current difference signal I_{dys} will be very small unless there is a parallel electrical arc in photovoltaic system 1900.

Comparison module 2006 determines whether current difference signal I_{dys} exceeds threshold value I_{thy}, and if so, comparison module 2006 asserts a signal ARC5 representing a parallel electrical arc in photovoltaic system 1900. Otherwise, system-level arc detection subsystem 2000 continues to monitor photovoltaic system 1900 for a parallel electrical arc.

Modules 2002-2006 of system-level arc detection subsystem 2000 may be implemented by electronic circuitry, such as digital electronic circuitry in the case where signals Iₛₜₛ and I_{cs} are digital signals, or analog electronic circuitry, such as in the case where signals Iₛₜₛ and I_{cs} are analog signals. Additionally, in some embodiments, system-level arc detection subsystem 2000 further includes a processor 2008 and a memory 2010, where processor 2008 implements at least some of modules 2002-2006 by executing instructions 2012, in the form of software or firmware, stored in memory 2010.

Photovoltaic system 1900 optionally further includes a system shorting switch 1906 electrically coupled in parallel with strings 1600. System shorting switch 1906 is normally open. System shorting switch 1906 closes, however, in response to system-level arc detection subsystem 1904 detecting a parallel electrical arc in photovoltaic system 1900. For example, in embodiments where system-level arc detection subsystem 1904 is implemented as illustrated in FIG. 20, system shorting switch 1906 closes in response to assertion of signal ARC5 representing a parallel electrical arc within photovoltaic system 1900. System shorting switch 1906 must be able to withstand the maximum voltage across photovoltaic strings 1600, as well as the maximum short circuit current generated by photovoltaic strings 1600. Although signals Iₛₜₛ and I_{cs} are shown being communicatively coupled to system-level arc detection subsystem 1904 via dedicated communication links, one or more these signals may be communicatively coupled to system-level arc detection subsystem 1904 in other manners. For example, in some embodiments, these signals are communicatively coupled via wireless networks or wired networks based on the RS485 standard. Some examples of possible wireless networks include, but are not limited to, wireless networks based on the IEEE802.15.4 standard and cellular telephone networks.

Photovoltaic system 1900 has multiple levels of electrical arc detection. First, system-level arc detection subsystem 1904 detects a parallel electrical arc in photovoltaic system 1900. Second, photovoltaic strings 1600 have string-level electrical arc detection capability, as discussed above with respect to FIG. 16. Third, each photovoltaic panel 400 of each photovoltaic string 1600 has panel-level electrical arc detection capability, as discussed above with respect to FIG. 4. However, in some alternate embodiments, photovoltaic strings 1600 are replaced with different photovoltaic strings which may or may not have electrical arc detection capability. In any event, each photovoltaic string of photovoltaic system 1900 must be capable of generating a respective signal representing current flowing through the string's output port for system-level arc detection subsystem 1904 to be able to detect a parallel electrical arc in photovoltaic system 1900. Photovoltaic panels 400 of photovoltaic strings 1600 are also replaced with alternative photovoltaic panels, which may or may not have electrical arc detection capability, in some alternate embodiments of photovoltaic system 1900.

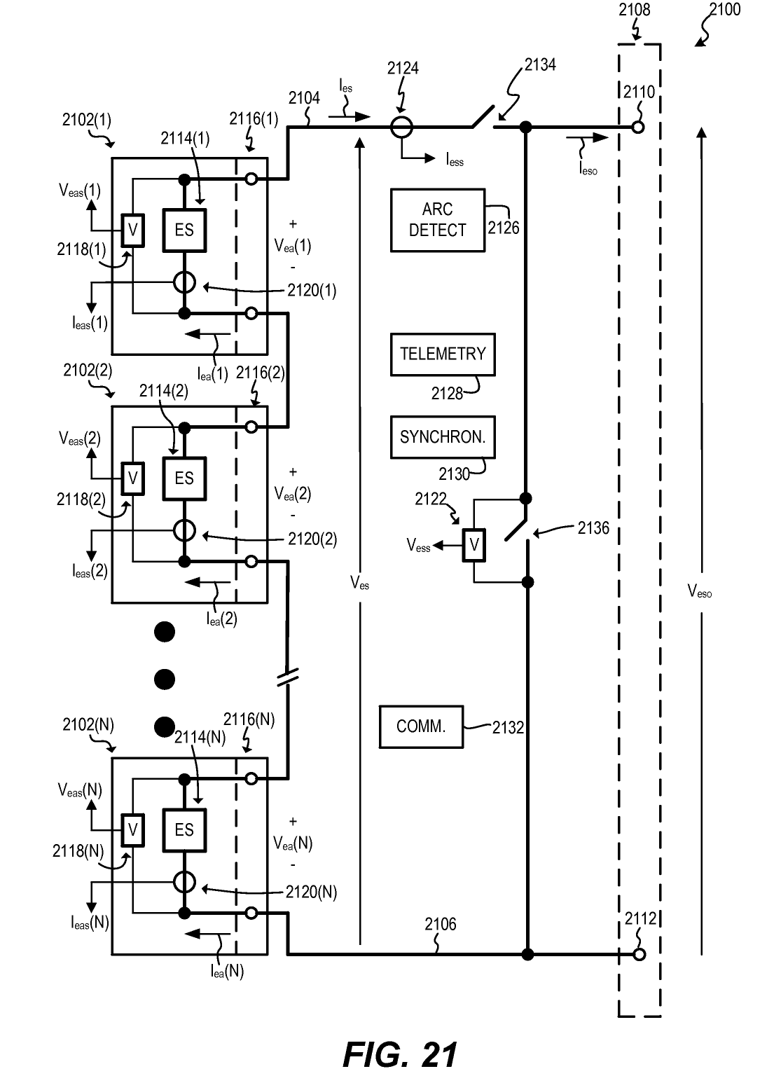

The electrical arc detection techniques disclosed above are not limited to photovoltaic applications but instead may be applied to other systems including a plurality of energy generation devices or energy storage devices electrically coupled in series. For example, FIG. 21 illustrates an energy storage system 2100 including N energy storage assemblies 2102 electrically coupled in series between a positive power rail 2104 and a negative power rail 2106, where N is an integer greater than one. An output port 2108 including a positive output terminal 2110 and a negative output terminal 2112 is electrically coupled across power rails 2104, 2106, where positive output terminal 2110 is electrically coupled to positive power rail 2104, and negative output terminal 2112 is electrically coupled to negative power rail 2106.

Each energy storage assembly 2102 includes an energy storage device 2114 electrically coupled to an output port 2116. Energy storage devices 2114 are, for example, one more battery cells, electrical capacitors, and/or fuel cells electrically coupled in series and/or parallel. Each energy storage assembly 2102 further includes an assembly voltage sensing subsystem 2118 and an assembly current sensing subsystem 2120. Each assembly voltage sensing subsystem 2118 generates a signal Vₑₐₛ representing a voltage Vₑₐ across the output port 2116 of its respective energy storage assembly 2102. For example, assembly voltage sensing subsystem 2118(1) generates a signal Vₑₐₛ(1) representing voltage Vₑₐ(1) across storage assembly 2102(1). Each assembly current sensing subsystem 2120 generates a signal Iₑₐₛ representing current flowing through its respective storage assembly 2102. For example, assembly current Iₑₐ sensing subsystem 2120 generates a signal Iₑₐₛ(1) representing current Iₑₐ(1) flowing through energy storage assembly 2102(1).

Energy storage system 2100 further includes a system-level voltage sensing subsystem 2122, a system-level current sensing subsystem 2124, and an arc detection subsystem 2126. System-level voltage sensing subsystem 2122 generates a system voltage signal Vₑₛₛ representing a system voltage Vₑₛ across power rails 2014, 2106. In this embodiment, system voltage Vₑₛ is the same as system output voltage Vₑₛₒ across output port 2108, and signal Vₑₛₛ therefore represents system output voltage Vₑₛₒ as well as system voltage Vₑₛ. System-level current sensing subsystem 2124 generates a system current signal Iₑₛₛ representing current Iₑₛ flowing between energy storage system 2100 and additional circuitry (not shown). In this embodiment, system current Iₑₛ is the same as system output current Iₑₛₒ flowing through output port 2108, and signal Iₑₛₛ therefore represents system output current Iₑₛₒ as well as system current Iₑₛ.

Arc detection subsystem 2126 detects a series electrical arc within storage system 2100 from a discrepancy between system voltage Vₑₛ and the sum of all storage assembly voltages Vₑₐ at a given time. Specifically, arc detection subsystem 2126 detects a series electrical arc within energy storage system 2100 when EQN. 10 holds true:

|[Σₙ₌₁^{N}Vₑₐ(n)−Vₑₛ]|>Vₜₕₛₛ (EQN. 10)

Vₜₕₛₛ is a positive threshold value chosen to achieve a desired tradeoff between electrical arc detection sensitivity and immunity to false electrical arc detection. If Vₜₕₛₛ was omitted from EQN. 10, parasitic voltage drop across conductors electrically coupling energy storage assemblies 2102 in series, or minor voltage measure errors, would cause false detection of an electrical arc.

Arc detection subsystem 2126 detects a parallel electrical arc within energy storage system 2100 from a discrepancy between current flowing in different serially-connected portions of the storage system at a given time, such as a discrepancy between assembly currents Iₑₐ of two different energy storage assemblies 2102, or a discrepancy between system current Iₑₛ and assembly current Iₑₐ of a selected energy storage assembly 2102. For example, in some embodiments, arc detection subsystem 2126 detects a parallel electrical arc within energy storage system 2100 when EQN. 11 holds true, where x is an integer ranging from 1 to N:

|Iₑₛ−Iₑₐ(x)|>Iₜₕₛₛ (EQN. 11)

In other embodiments, arc detection subsystem 2126 detects a parallel electrical arc within energy storage system 2100 when EQN. 12 holds true, where x and y are each integers ranging from 1 to N, and x does not equal y:

|Iₑₐ(x)−Iₑₐ(y)|>Iₜₕₛₛ (EQN. 12)

In both EQNS. 11 and 12, Iₜₕₛₛ is a positive threshold value chosen to achieve a desired tradeoff between electrical arc detection sensitivity and immunity to false electrical arc detection. If Iₜₕₛₛ were omitted from the equations, minor current measurement errors would cause false detection of a parallel electrical arc. System-level current sensing subsystem 2124 is optionally omitted in embodiments evaluating EQN. 12, since system current signal Iₑₛ is not a parameter of EQN. 12.

Arc detection subsystem 2126 is implemented, for example, in a manner similar to that discussed above with respect to FIG. 4. For example, in certain embodiments, arc detection subsystem 2126 is implemented as shown in either FIG. 7 or 8, but with signals Vₑₐₛ, Iₑₐₛ, Vₑₛₛ, Iₑₛₛ substituted for signals Vₐₛ, Iₐₛ, Vₚₛ, and Iₚₛ, respectively. Energy storage system 2100 optionally further includes one or more of telemetry subsystem 2128, synchronization subsystem 2130, communication network 2132, isolation switch 2134, and shorting switch 2136, which are similar to telemetry subsystem 430, synchronization subsystem 434, communication network 432, isolation switch 436, and shorting switch 438, respectively.

Energy storage assemblies 2102 could include MPPT capability, such as in a manner similar to that discussed above with respect to FIGS. 13-15. For example, in an alternate embodiment, energy storage assemblies 2102 are substituted by energy storage assemblies having a topology like MPPT photovoltaic assemblies 1302 of FIG. 13, but with the photovoltaic devices replaced with energy storage devices. In this alternate embodiment, the energy storage device optionally has a maximum open circuit voltage rating that is sufficiently low, such as less than 80 volts, so that electrical arc detection is not required under applicable safety standards. Furthermore, in some embodiments, the energy storage device has an open circuit voltage rating, such as 18 volts or less, that is lower than a minimum voltage required to sustain an electrical arc on the input side of the MPPT converter, for reasons similar to those discussed above with respect to FIG. 13.

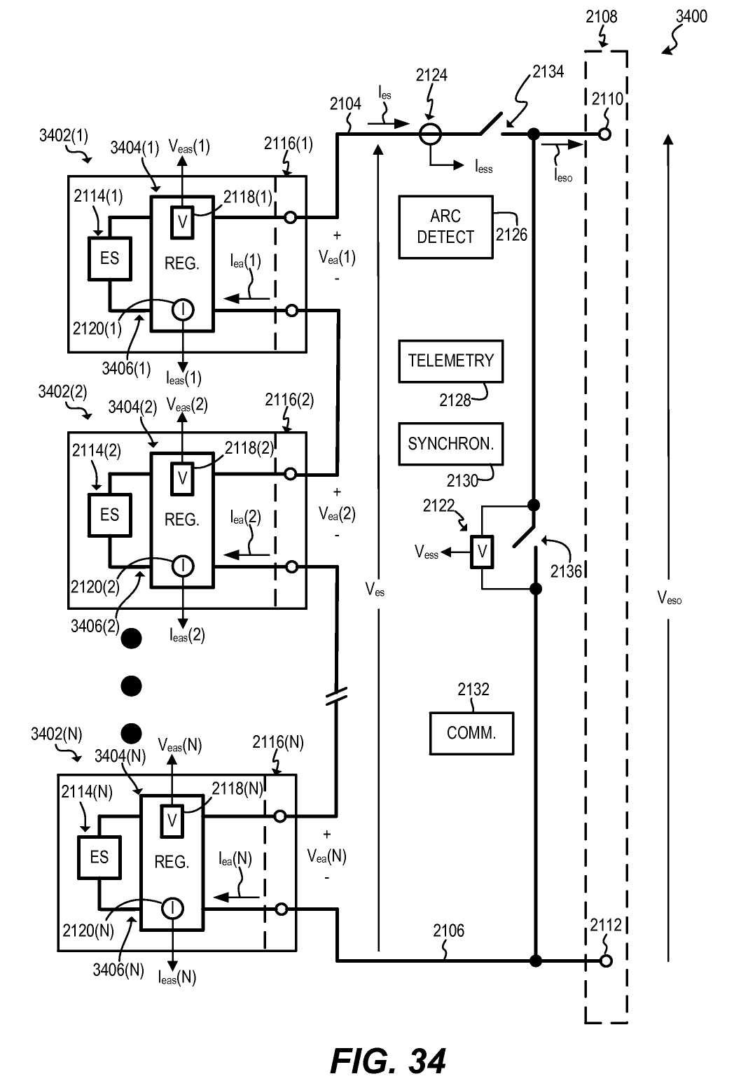

Energy storage assemblies 2102 optionally further include voltage regulation capability. For example, FIG. 34 illustrates an energy storage system 3400, which is similar to energy storage system 2100 (FIG. 21), but with energy storage assemblies 2102 replaced with energy storage assemblies 3402. Energy storage assemblies 3402 are like energy storage assemblies 2102 of FIG. 21, but further include a voltage regulator 3404, such as a boost converter, electrically coupled between the energy storage device 2114 and the output port 2116 of the energy storage assembly. In some embodiments, assembly voltage sensing subsystems 2118 and assembly current sensing subsystems 2120 are integrated within voltage regulators 3404, as shown. Arc detection subsystem 2126 is unable to detect an electrical arc on input sides 3406 of voltage regulators 3404. Accordingly, in some embodiments, energy storage devices 2114 have a maximum open circuit voltage rating that is sufficiently low, such as less than 80 volts, so that electrical arc detection is not required under applicable safety standards. Furthermore, in some embodiments, energy storage devices 2114 have a maximum open circuit voltage rating, such as 18 volts or less, that is lower than a minimum voltage required to sustain an electrical arc on input sides 3406 of voltage regulators 3404.

Energy storage system 2100 could be modified to include a system-level MPPT converter (not shown), such as analogous to MPPT converter 1102 (FIG. 11), electrically coupling the plurality of energy storage assemblies 2102 to output port 2108, without departing from the scope hereof. In such case, system voltage Vₑₛ would not necessarily be the same as system output voltage Vₑₛₒ, and system current Iₑₛ would not necessarily be the same as system output current Iₑₛₒ, due to inclusion of the MPPT converter. Additionally, energy storage system could be modified to include a system-level inverter (not shown), such as analogous to inverter 1202 (FIG. 12), electrically coupling the plurality of energy storage assemblies 2102 to output port 2108, without departing from the scope hereof. In such case, system voltage Vₑₛ would differ from system output voltage Vₑₛₒ, and system current Iₑₛ would differ from system output current Iₑₛₒ, due to inclusion of the inverter.

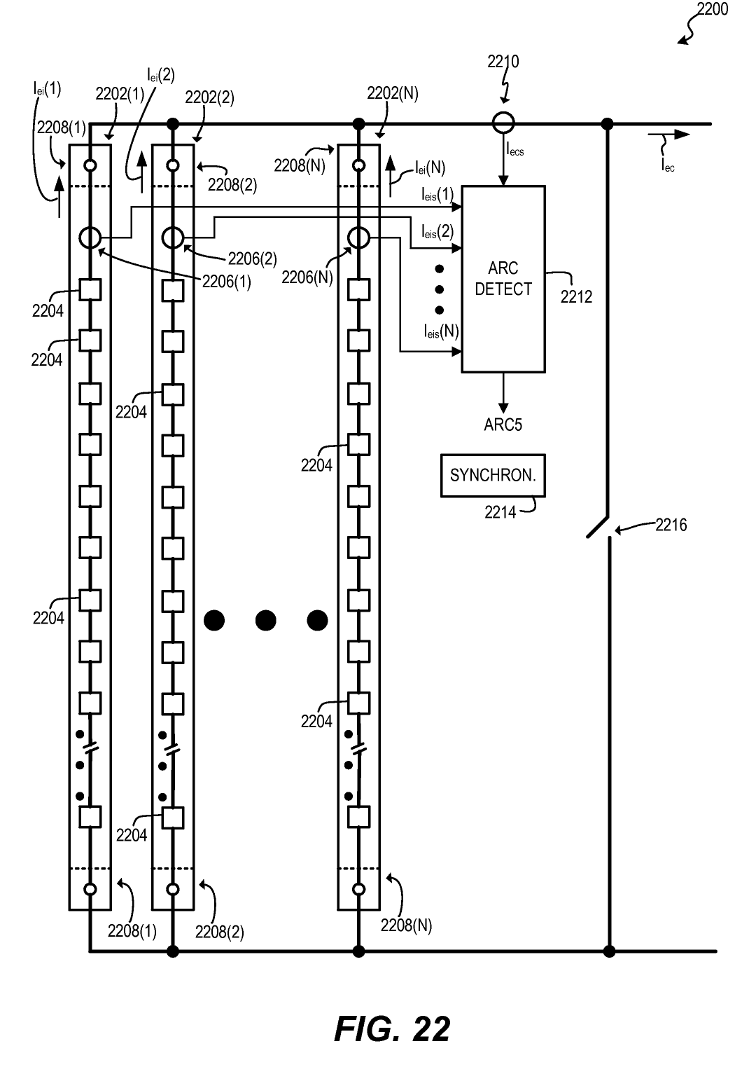

FIG. 22 illustrates an energy storage system 2200 having parallel electrical arc detection capability and including N energy storage strings 2202 electrically coupled in parallel, where N is an integer greater than one. Each energy storage string 2202 includes a plurality of energy storage assemblies 2204 electrically coupled in series. Only some energy storage assemblies 2204 are labeled to promote illustrative clarity. Each energy storage assembly 2204 includes one or more energy storage devices (not shown), such as battery cells or capacitors, electrically coupled in series and/or parallel. In some embodiments, energy storage assemblies 2204 are energy storage assemblies 2102 of FIG. 21. Each energy storage string 2202 additionally includes a string current sensing subsystem 2206 operable to generate a signal I_{ecs} representing current I_{ec} flowing through an output port 2208 of the energy storage string. One or more energy storage strings 2202 also optionally further includes one or more MPPT converters (not shown), such as a string-level MPPT converter, and/or an MPPT converter for each energy storage assembly 2204.

Energy storage system 2200 further includes a combined current sensing subsystem 2210, an arc detection subsystem 2212, and an optional synchronization subsystem 2214. Combined current sensing subsystem 2210 generates a combined current signal I_{ecs} representing combined current Iₑ flowing between all of the parallel coupled energy storage strings 2202 and other circuitry (not shown). Synchronization subsystem 2214 synchronizes generation of combined current signal I_{ecs} with string current signals Iₑᵢₛ.

Under normal operating conditions, the sum of all string currents Iₑᵢ should be the same as combined current I_{ec}. In the event of a parallel electrical arc in energy storage system 2200, combined current I_{ec} will differ from the sum of all string currents Iₑᵢ. Accordingly, arc detection subsystem 2212 detects a parallel electrical arc within energy storage system 2200 from a discrepancy between the sum of all string currents Iₑᵢ and combined current I_{ec}. For example, in some embodiments, arc detection subsystem 2212 detects a parallel electrical arc when EQN. 13 holds true, where I_{thc} is a positive threshold value chosen to achieve a desired tradeoff between electrical arc detection sensitivity and immunity to false electrical arc detection:

|I_{ecs}−Σₙ₌₁^{N}Iₑᵢₛ(n)|>I_{thc} (EQN. 13)

Arc detection subsystem 2212 is implemented, for example, in a manner similar to that discussed above with respect to FIG. 19. For example, in certain embodiments, arc detection subsystem 2212 is implemented as shown in FIG. 20, but with signals Iₑᵢₛ and I_{ecs}, substituted for signals Iₛₜₛ and I_{cs}, respectively.

Energy storage system 2200 optionally further includes a shorting switch 2216 electrically coupled in parallel with energy storage strings 2202. Shorting switch 2216 is normally open. System shorting switch 2216 closes, however, in response to arc detection subsystem 2212 detecting a parallel electrical arc in energy storage system 2200. Shorting switch 2216 must be able to withstand the maximum voltage across energy storage strings 2202, as well as the maximum short circuit current generated by energy storage strings 2202. Although signals Iₑᵢₛ and I_{ecs} are shown being communicatively coupled to arc detection subsystem 2212 via dedicated communication links, one or more these signals may be communicatively coupled to arc detection subsystem 2212 in other manners. For example, in some embodiments, these signals are communicatively coupled via wireless networks or wired networks based on the RS485 standard. Some examples of possible wireless networks include, but are not limited to, wireless networks based on the IEEE802.15.4 standard and cellular telephone networks.

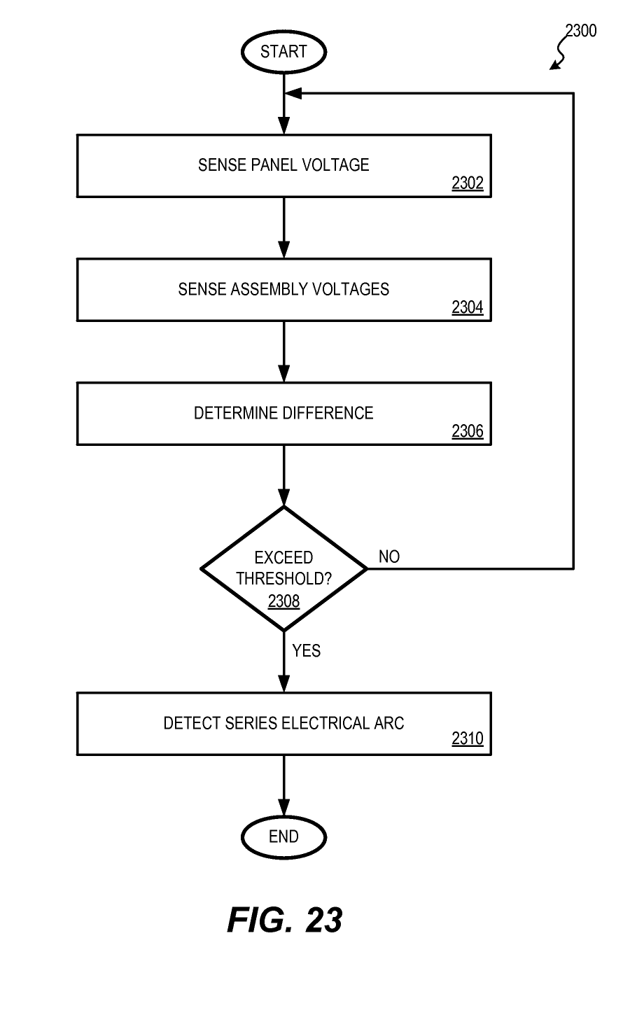

FIG. 23 illustrates a method 2300 for detecting a series electrical arc in a photovoltaic panel including a plurality of photovoltaic assemblies electrically coupled in series. A panel voltage is sensed across positive and negative power rails in step 2302. In one example of step 2302, panel voltage Vₚ is sensed across panel power rails 408, 410 of photovoltaic panel 400 (see FIG. 4) using panel voltage sensing subsystem 424. In step 2304, a respective assembly voltage is sensed across each of the plurality of photovoltaic assemblies. In one example of step 2304, an assembly voltage Vₐ is sensed across each photovoltaic assembly 402 using assembly voltage sensing subsystems 418. In step 2306, a difference between a sum of all of the assembly voltages and the panel voltage is determined. In one example of step 2306, panel arc detection subsystem 428 determines a difference between the sum of all assembly voltages V, and panel voltage Vₚ. Decision step 2308 determines whether the difference exceeds a threshold value, and if so, the electrical arc is detected in step 2310. In one example of steps 2308 and 2310, panel arc detection subsystem 428 determines whether the difference exceeds threshold value Vₜₕ, and if so, panel arc detection subsystem 428 asserts an arc detection signal.

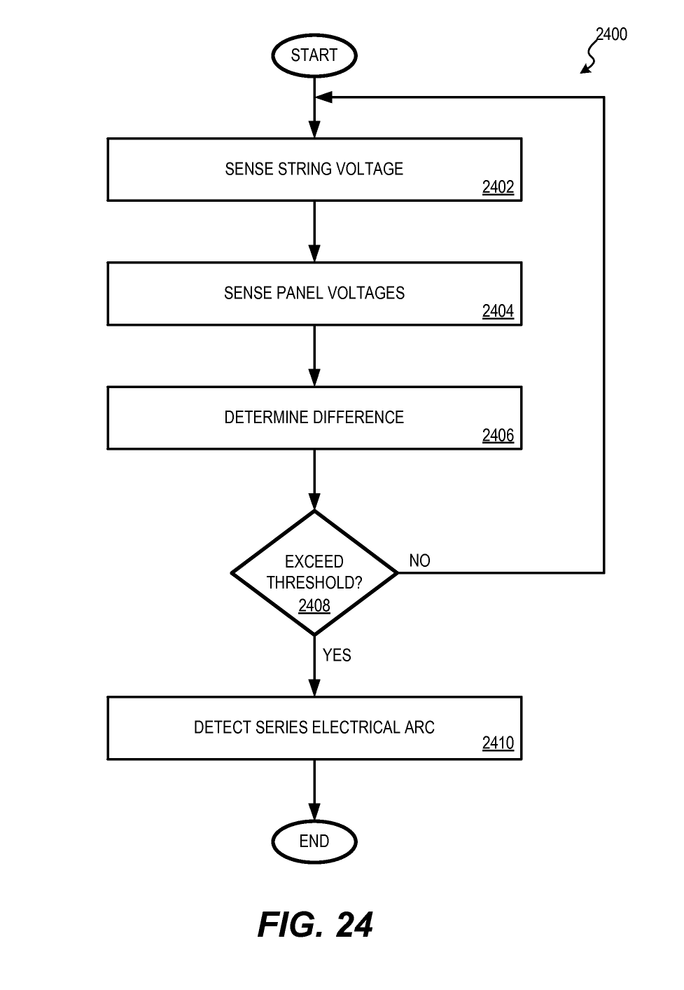

FIG. 24 illustrates a method 2400 for detecting a series electrical arc in a photovoltaic string including a plurality of photovoltaic panels electrically coupled in series. A string voltage is sensed across positive and negative string power rails in step 2402. In one example of step 2402, string voltage Vₛₜ is sensed across power rails 1603, 1605 of photovoltaic string 1600 (see FIG. 16) using string voltage sensing subsystem 1604. In step 2404, a respective panel voltage is sensed across each of the plurality of photovoltaic panels. In one example of step 2404, a panel voltage Vₚ is sensed across each photovoltaic panel 400 using panel voltage sensing subsystems 424. In step 2406, a difference between a sum of all of the panel voltages and the string voltage is determined. In one example of step 2406, string arc detection subsystem 1608 determines a difference between the sum of all panel voltages Vₚ and string voltage Vₛₜ. Decision step 2408 determines whether the difference exceeds a threshold value, and if so, the electrical arc is detected in step 2410. In one example of steps 2408 and 2410, string arc detection subsystem 1608 determines whether the difference exceeds threshold value Vₜₕₛₜ, and if so, string arc detection subsystem 1608 asserts an arc detection signal.

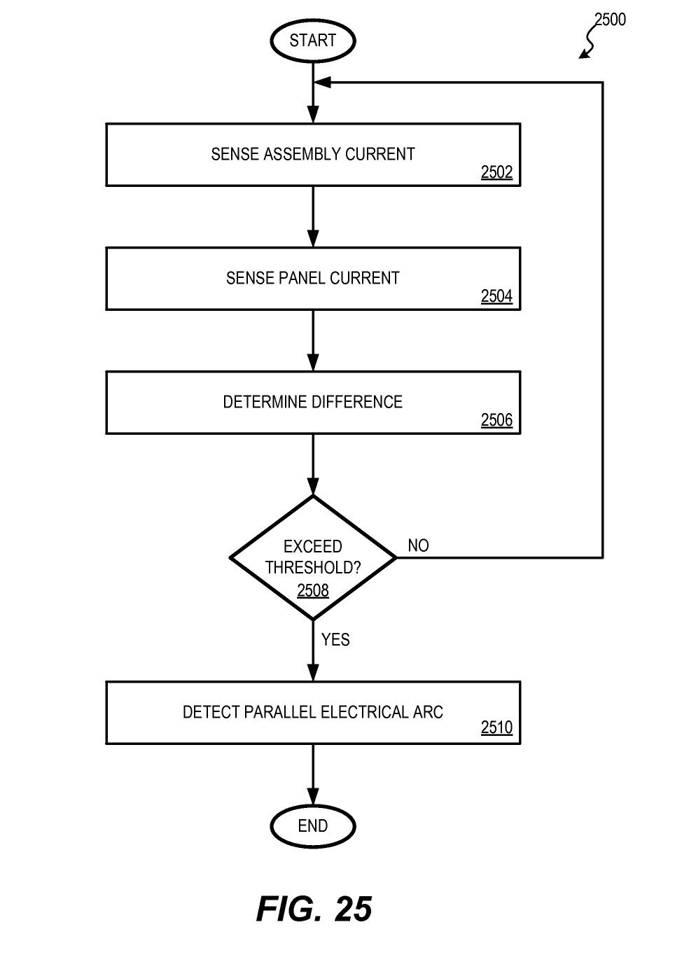

FIG. 25 illustrates a method 2500 for detecting a parallel electrical arc in a photovoltaic panel including a plurality of photovoltaic assemblies electrically coupled in series. In step 2502, an assembly current flowing through one of the plurality of photovoltaic assemblies is sensed. In one example of step 2502, assembly current Iₐ(1) flowing through photovoltaic assembly 402(1) is sensed using assembly current sensing subsystem 420(1) (see FIG. 4). A panel current flowing between the plurality of photovoltaic assemblies and other circuitry is sensed in step 2504. In one example of step 2504, panel current Iₚ is sensed using panel current sensing subsystem 426. In step 2506, a difference between the assembly current and the panel current is determined. In one example of step 2506, panel arc detection subsystem 428 determines a difference between assembly current Iₐ(1) and panel current Iₚ. Decision step 2508 determines whether a magnitude of the difference exceeds a threshold value, and if so, the electrical arc is detected in step 2510. In one example of steps 2508 and 2510, panel arc detection subsystem 428 determines whether a magnitude of the difference exceeds threshold value Iₜₕ, and if so, panel arc detection subsystem 428 asserts an arc detection signal.

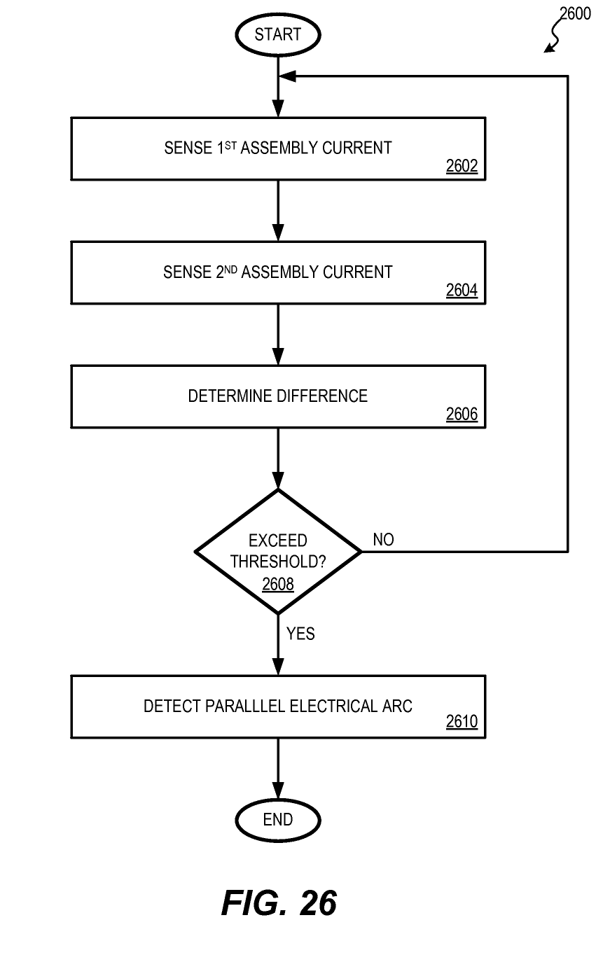

FIG. 26 illustrates another method 2600 for detecting a parallel electrical arc in a photovoltaic panel including a plurality of photovoltaic assemblies electrically coupled in series. In step 2602, a first assembly current flowing through a first one of the plurality of photovoltaic assemblies is sensed. In one example of step 2602, assembly current Iₐ(1) flowing through photovoltaic assembly 402(1) is sensed using assembly current sensing subsystem 420(1) (see FIG. 4). In step 2604, an assembly current flowing through another one of the plurality of photovoltaic assemblies is sensed. In one example of step 2604, assembly current Iₐ(2) flowing through photovoltaic assembly 402(2) is sensed using assembly current sensing subsystem 420(2). In step 2606, a difference between the first and second assembly currents is determined. In one example of step 2606, panel arc detection subsystem 428 determines a difference between assembly currents Iₐ(1) and Iₐ(2). Decision step 2608 determines whether a magnitude of the difference exceeds a threshold value, and if so, the electrical arc is detected in step 2610. In one example of steps 2608 and 2610, panel arc detection subsystem 428 determines whether a magnitude of the difference exceeds threshold value Iₜₕ, and if so, panel arc detection subsystem 428 asserts an arc detection signal.

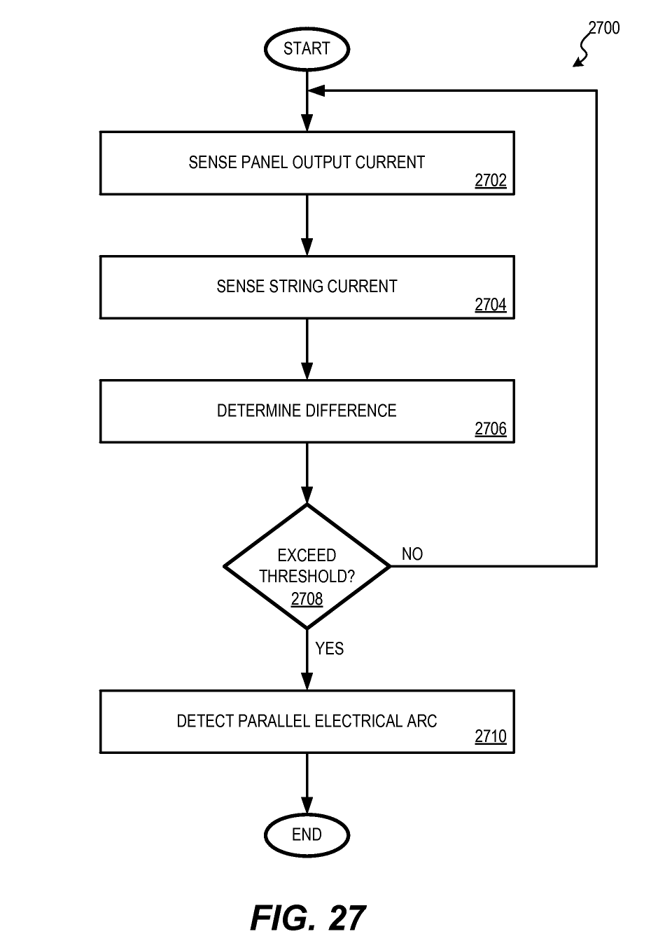

FIG. 27 illustrates a method 2700 for detecting a parallel electrical arc in a photovoltaic string including a plurality of photovoltaic panels electrically coupled in series. In step 2702, a panel output current flowing through an output port one of the plurality of photovoltaic panels is sensed. In one example of step 2702, panel output current Iₚₒ(1) flowing through photovoltaic panel 400(1) is sensed using the panel current sensing subsystem 426 of the photovoltaic panel (see FIG. 4). A string current flowing between the plurality of photovoltaic panels and other circuitry is sensed in step 2704. In one example of step 2704, string current Iₛₜ is sensed using string current sensing subsystem 1606. In step 2706, a difference between the panel output current and the string current is determined. In one example of step 2706, string arc detection subsystem 1608 determines a difference between string current Iₛₜ and panel output current Iₚₒ(1). Decision step 2708 determines whether a magnitude of the difference exceeds a threshold value, and if so, the electrical arc is detected in step 2710. In one example of steps 2708 and 2710, string arc detection subsystem 1608 determines whether a magnitude of the difference exceeds threshold value Iₜₕₛₜ, and if so, string arc detection subsystem 1608 asserts an arc detection signal.

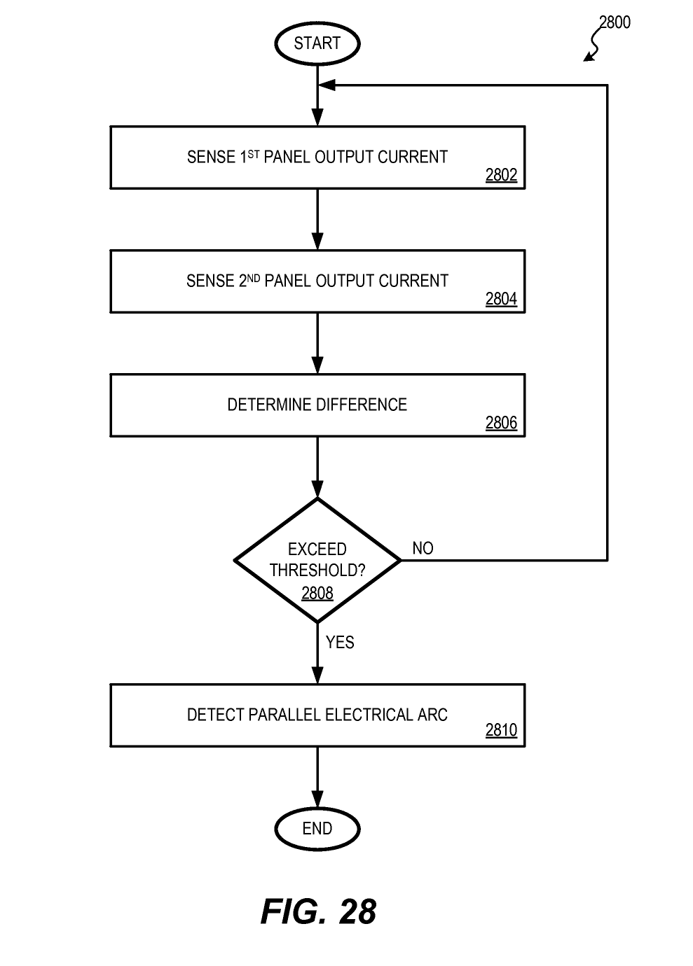

FIG. 28 illustrates another method 2800 for detecting a parallel electrical arc in a photovoltaic string including a plurality of photovoltaic panels electrically coupled in series. In step 2802, a first panel output current flowing through an output port of one of the plurality of photovoltaic panels is sensed. In one example of step 2802, panel output current Iₚₒ(1) flowing through photovoltaic panel 400(1) is sensed using the panel current sensing subsystem 426 of the photovoltaic panel (see FIG. 4). In step 2804, a second panel output current flowing through an output port of another one of the plurality of photovoltaic panels is sensed. In one example of step 2804, panel output current Iₚₒ(2) flowing through photovoltaic panel 400(2) is sensed using the panel current sensing subsystem 426 of the photovoltaic panel. In step 2806, a difference between the first and second panel output currents is determined. In one example of step 2806, string arc detection subsystem 1608 determines a difference between panel output current Iₚₒ(1) and panel output current Iₚₒ(2). Decision step 2808 determines whether a magnitude of the difference exceeds a threshold value, and if so, the electrical arc is detected in step 2810. In one example of steps 2808 and 2810, string arc detection subsystem 1608 determines whether a magnitude of the difference exceeds threshold value Iₜₕₛₜ, and if so, string arc detection subsystem 1608 asserts an arc detection signal.

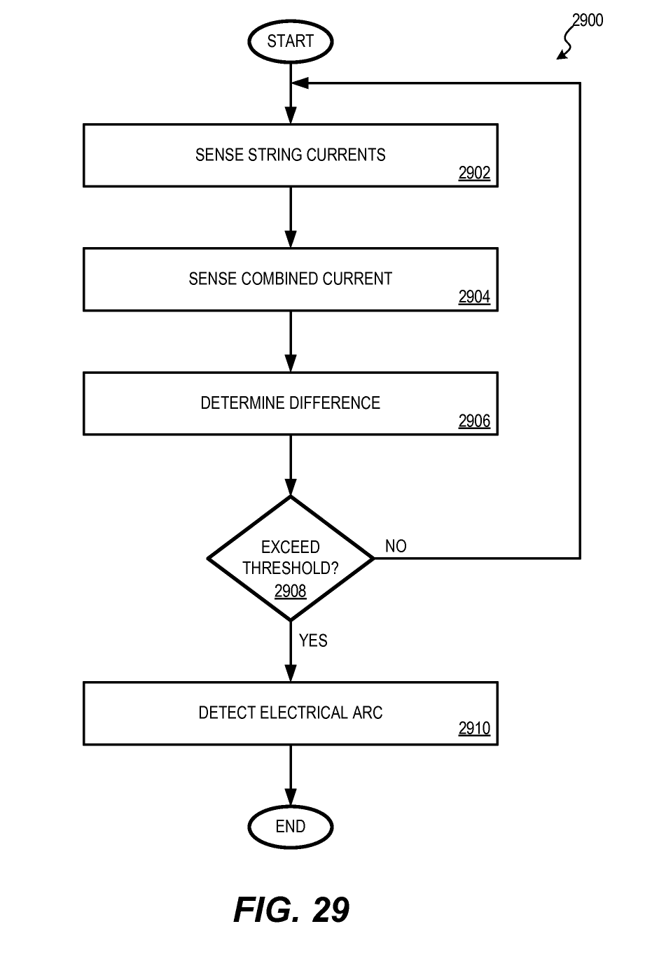

FIG. 29 illustrates a method for detecting an electrical arc in a photovoltaic system including a plurality of strings electrically coupled in parallel, where each of the strings includes a plurality of photovoltaic panels electrically coupled in series. In step 2902, a respective string output current flowing through each of the plurality of strings is sensed. In one example of step 2902, the string output current Iₛₜₒ flowing through each string 1600 of photovoltaic system 1900 is sensed using the string current sensing subsystem 1606 of the photovoltaic string (FIGS. 16 and 19). In step 2904, a combined current flowing between the plurality of strings and other circuitry is sensed. In one example of step 2904, combined current sensing subsystem 1902 senses combined current Iₛₜₒ flowing between strings 1600 and other circuitry. In step 2906, a difference between the combined current and a sum of all of the string output currents is determined. In one example of step 2906, system-level arc detection subsystem 1904 determines a difference between combined current I_{c} and a sum of all string output currents Iₛₜₒ. Decision step 2908 determines whether the difference exceeds a threshold value, and if so, the electrical arc is detected in step 2910. In one example of steps 2908, 2910, system-level arc detection subsystem 1904 determines whether a magnitude of the difference exceeds threshold value I_{thy}, and if so, system-level arc detection subsystem 1904 asserts an arc detection signal.

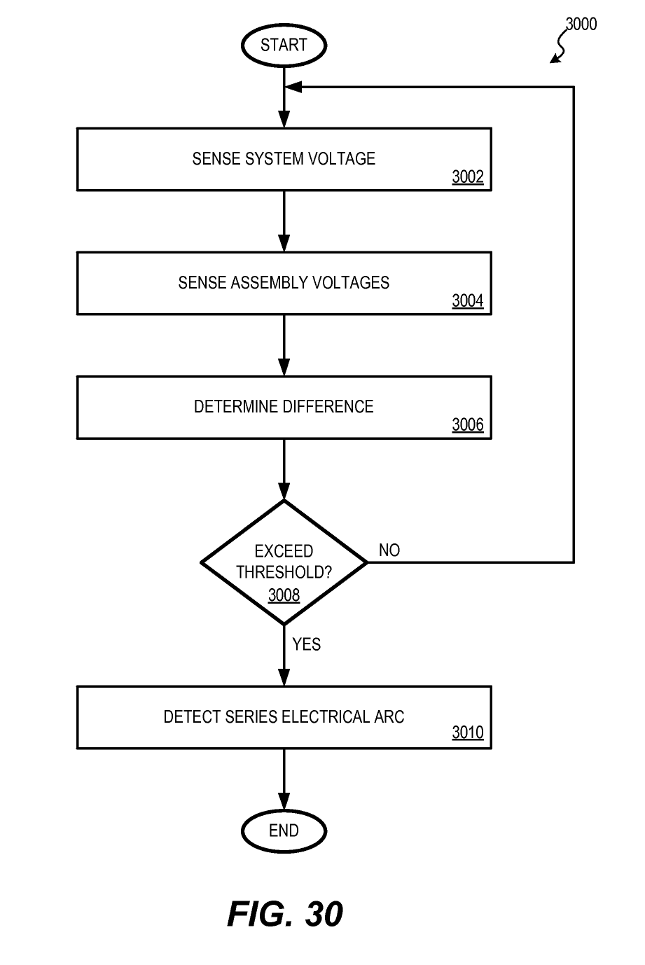

FIG. 30 illustrates a method 3000 for detecting a series electrical arc in an energy storage system including a plurality of energy storage assemblies electrically coupled in series. A system voltage is sensed across positive and negative power rails in step 3002. In one example of step 3002, system voltage Vₑₛ is sensed across power rails 2104, 2106 of energy storage system 2100 (see FIG. 21) using system-level voltage sensing subsystem 2122. In step 3004, a respective assembly voltage is sensed across each of the plurality of energy storage assemblies. In one example of step 3004, an assembly voltage Vₑₐ is sensed across each energy storage assembly 2102 using assembly voltage sensing subsystems 2118. In step 3006, a difference between a sum of all of the assembly voltages and the system voltage is determined. In one example of step 3006, arc detection subsystem 2126 determines a difference between the sum of all assembly voltages Vₑₐ and system voltage Vₑₛ. Decision step 3008 determines whether the difference exceeds a threshold value, and if so, the electrical arc is detected in step 3010. In one example of steps 3008 and 3010, arc detection subsystem 2126 determines whether the difference exceeds threshold value Vₜₕₛₛ, and if so, arc detection subsystem 2126 asserts an arc detection signal.

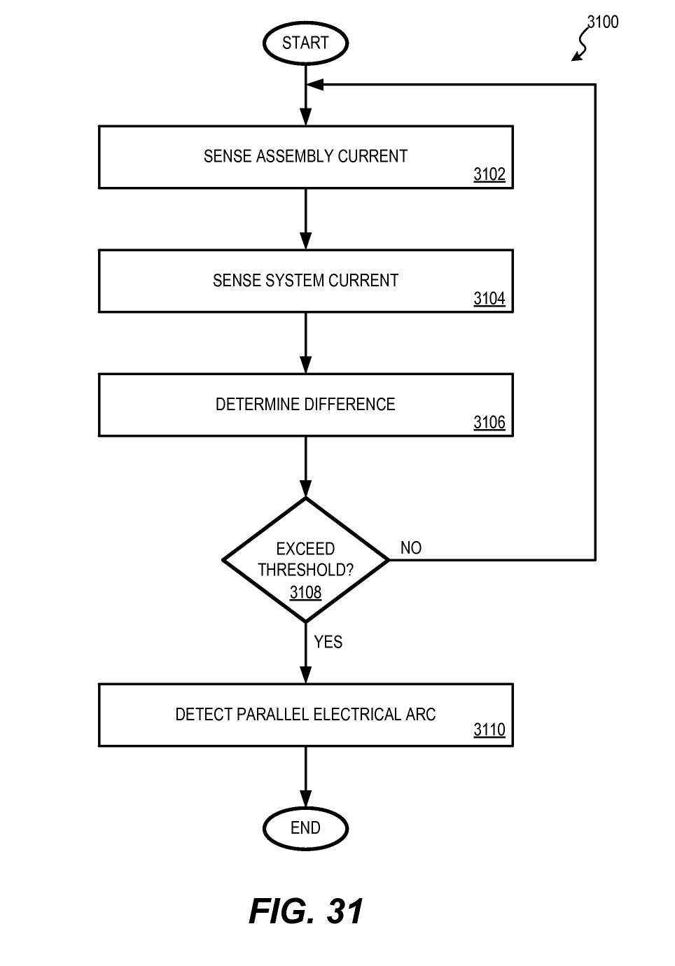

FIG. 31 illustrates a method 3100 for detecting a parallel electrical arc in an energy storage system including a plurality of energy storage system assemblies electrically coupled in series. In step 3102, an assembly current flowing through one of the plurality of energy storage system assemblies is sensed. In one example of step 3102, assembly current Iₑₐ(1) flowing through energy storage system assembly 2102(1) is sensed using assembly current sensing subsystem 2120(1) (see FIG. 21). A system current flowing between the plurality of energy storage system assemblies and other circuitry is sensed in step 3104. In one example of step 3104, system current Iₑₛ is sensed using system-level current sensing subsystem 2124. In step 3106, a difference between the assembly current and the system current is determined. In one example of step 3106, arc detection subsystem 2126 determines a difference between assembly current Iₑₐ(1) and system current Iₑₛ. Decision step 3108 determines whether a magnitude of the difference exceeds a threshold value, and if so, the electrical arc is detected in step 3110. In one example of steps 3108 and 3110, arc detection subsystem 2126 determines whether a magnitude of the difference exceeds threshold value Iₜₕₛₛ, and if so, arc detection subsystem 2126 asserts an arc detection signal.

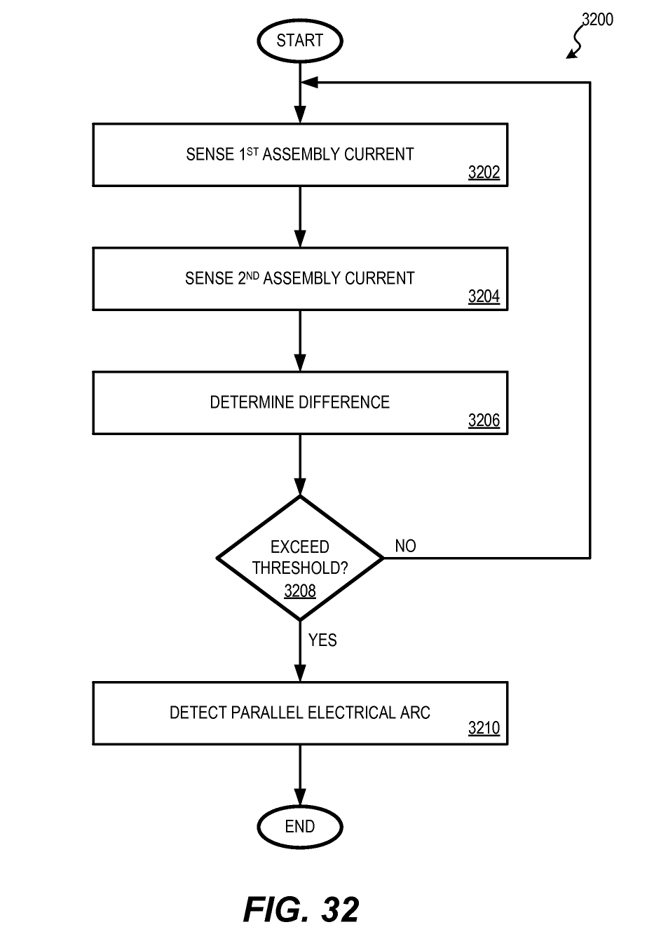

FIG. 32 illustrates another method 3200 for detecting a parallel electrical arc in an energy storage system including a plurality of energy storage assemblies electrically coupled in series. In step 3202, a first assembly current flowing through a first one of the plurality of energy storage assemblies is sensed. In one example of step 3202, assembly current Iₑₐ(1) flowing through energy storage assembly 2102(1) is sensed using assembly current sensing subsystem 2120(1) (see FIG. 21). In step 3204, an assembly current flowing through another one of the plurality of energy storage assemblies is sensed. In one example of step 3204, assembly current Iₑₐ(2) flowing through energy storage assembly 2102(2) is sensed using assembly current sensing subsystem 2120(2). In step 3206, a difference between the first and second assembly currents is determined. In one example of step 3206, arc detection subsystem 2126 determines a difference between assembly currents Iₑₐ(1) and Iₑₐ(2). Decision step 3208 determines whether a magnitude of the difference exceeds a threshold value, and if so, the electrical arc is detected in step 3210. In one example of steps 3208 and 3210, arc detection subsystem 2126 determines whether a magnitude of the difference exceeds threshold value Iₜₕₛₛ, and if so, arc detection subsystem 2126 asserts an arc detection signal.

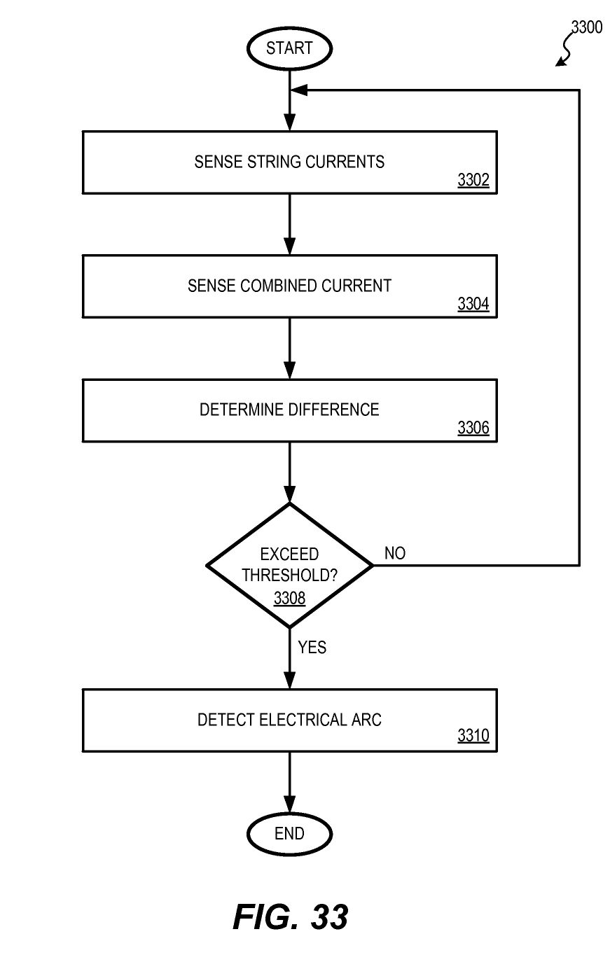

FIG. 33 illustrates a method for detecting an electrical arc in an energy storage system including a plurality of energy storage strings electrically coupled in parallel, where each of the energy storage strings includes a plurality of energy storage assemblies electrically coupled in series. In step 3302, a respective string output current flowing through an output port each of the plurality of energy storage strings is sensed. In one example of step 3202, the string output current Iₑᵢ flowing through each string 2202 of energy storage system 2200 is sensed using the string current sensing subsystem 2206 of the energy storage string (FIG. 22). In step 3304, a combined current flowing between the plurality of energy storage strings and other circuitry is sensed. In one example of step 3304, combined current sensing subsystem 2210 senses combined current I_{ec} flowing between energy storage strings 2202 and other circuitry. In step 3306, a difference between the combined current and a sum of all of the string currents is determined. In one example of step 3306, arc detection subsystem 2212 determines a difference between combined current I_{ec} and a sum of all string currents Iₑᵢ. Decision step 3308 determines whether a magnitude of the difference exceeds a threshold value, and if so, the electrical arc is detected in step 3310. In one example of steps 3308, 3310, arc detection subsystem 2212 determines whether the difference exceeds threshold value I_{thc}, and if so, arc detection subsystem 2122 asserts an arc detection signal.

Combinations of Features

Features described above as well as those claimed below may be combined in various ways without departing from the scope hereof. The following examples illustrate some possible combinations:

(A1) A method for detecting an electrical arc in a photovoltaic panel including a plurality of photovoltaic assemblies electrically coupled in series between positive and negative panel power rails may include the following steps: (1) sensing a panel voltage across the positive and negative panel power rails, (2) sensing a respective assembly voltage across each of the plurality of photovoltaic assemblies, (3) determining a difference between a sum of all of the assembly voltages and the panel voltage, (4) determining whether the difference exceeds a threshold value, and (5) detecting the electrical arc if the difference exceeds the threshold value.

(B1) A method for detecting an electrical arc in a photovoltaic string including a plurality of photovoltaic panels electrically coupled in series between positive and negative string power rails may include the following steps: (1) sensing a string voltage across the positive and negative string power rails, (2) sensing a respective panel output voltage across each of the plurality of photovoltaic panels, (3) determining a difference between a sum of all of the panel output voltages and the string voltage, (4) determining whether the difference exceeds a threshold value, and (5) detecting the electrical arc if the difference exceeds the threshold value.

(C1) A method for detecting an electrical arc in a photovoltaic panel including a plurality of photovoltaic assemblies electrically coupled in series may include the following steps: (1) sensing a first assembly current flowing through one of the plurality of photovoltaic assemblies, (2) sensing a panel current flowing between the plurality of photovoltaic assemblies and other circuitry, (3) determining a difference between the panel current and the first assembly current, (4) determining whether a magnitude of the difference exceeds a threshold value, and (5) detecting the electrical arc if the magnitude of the difference exceeds the threshold value.

(C2) The method denoted as (C1) may further include the following steps: (1) sensing a second assembly current flowing through another one of the plurality of photovoltaic assemblies, (2) determining a second difference between the panel current and the second assembly current, (3) determining whether a magnitude of the second difference exceeds the threshold value, and (4) detecting the electrical arc if the magnitude of the second difference exceeds the threshold value.

(D1) A method for detecting an electrical arc in a photovoltaic panel including a plurality of photovoltaic assemblies electrically coupled in series may include the following steps: (1) sensing a first assembly current flowing through one of the plurality of photovoltaic assemblies, (2) sensing a second assembly current flowing through another one of the plurality of photovoltaic assemblies, (3) determining a difference between the first and second assembly currents, (4) determining whether a magnitude of the difference exceeds a threshold value, and (5) detecting the electrical arc if the magnitude of the difference exceeds the threshold value.

(E1) A method for detecting an electrical arc in a string including a plurality of photovoltaic panels electrically coupled in series may include the following steps: (1) sensing a first panel output current flowing through an output port one of the plurality of photovoltaic panels, (2) sensing a string current flowing between the plurality of photovoltaic panels and other circuitry, (3) determining a difference between the first panel output current and the string current, (4) determining whether a magnitude of the difference exceeds a threshold value, and (5) detecting the electrical arc if the magnitude of the difference exceeds the threshold value.

(E2) The method denoted as (E1) may further include the following steps: (1) sensing a second panel output current flowing through an output port of another one of the plurality of photovoltaic panels, (2) determining a second difference between the second panel output current and the string current, (3) determining whether a magnitude of the second difference exceeds the threshold value, and (4) detecting the electrical arc if the magnitude of the second difference exceeds the threshold value.

(F1) A method for detecting an electrical arc in a string including a plurality of photovoltaic panels electrically coupled in series may include the following steps: (1) sensing a first panel output current flowing through an output port one of the plurality of photovoltaic panels, (2) sensing a second panel output current flowing through an output port of another one of the plurality of photovoltaic panels, (3) determining a difference between the first and second panel output currents, (4) determining whether a magnitude of the difference exceeds a threshold value, and (5) detecting the electrical arc if the magnitude of the difference exceeds the threshold value.

(G1) A method for detecting an electrical arc in a photovoltaic system including a plurality of strings electrically coupled in parallel, each of the plurality of strings including a plurality of photovoltaic panels electrically coupled in series, may include the following steps: (1) sensing a respective string output current flowing through an output port of each of the plurality of strings, (2) sensing a combined current flowing between the plurality of strings and other circuitry, (3) determining a difference between the combined current and a sum of all of the string output currents, (4) determining whether a magnitude of the difference exceeds a threshold value, and (5) detecting the electrical arc if the magnitude of the difference exceeds the threshold value.

(H1) A photovoltaic panel having electrical arc detection capability may include a panel arc detection subsystem and a plurality of photovoltaic assemblies electrically coupled in series between a positive panel power rail and a negative panel power rail. The panel arc detection subsystem may be adapted to detect a series electrical arc within the photovoltaic panel from a discrepancy between a panel voltage across the positive and negative panel power rails and a sum of all voltages across the plurality of photovoltaic assemblies.

(H2) In the photovoltaic panel denoted as (H1), each of the plurality of photovoltaic assemblies may include an assembly voltage sensing subsystem adapted to generate a respective assembly voltage signal representing a voltage across an output port of the photovoltaic assembly; the photovoltaic panel may further include a panel voltage sensing subsystem adapted to generate a panel voltage signal representing the panel voltage; and the panel arc detection subsystem may be further adapted to: (1) determine a difference between a sum of all of the assembly voltage signals and the panel voltage signal, (2) determine whether the difference exceeds a threshold value, and (3) detect the series electrical arc if the difference exceeds the threshold value.

(H3) In either of the photovoltaic panels denoted as (H1) or (H2), each of the plurality of photovoltaic assemblies may further include a photovoltaic device and a maximum power point tracking converter electrically coupled between the photovoltaic device and an output port of the photovoltaic assembly, where the maximum power point tracking converter is adapted to cause the photovoltaic device to operate substantially at its maximum power point.

(H4) In the photovoltaic panel denoted as (H3), each photovoltaic device may have a maximum open circuit voltage rating of less than a minimum voltage required to sustain an electrical arc.

(H5) In either of the photovoltaic panels denoted as (H3) or (H4), each photovoltaic device may have a maximum open circuit voltage rating of 18 volts or less.

(H6) In any of the photovoltaic panels denoted as (H3) through (H5), each photovoltaic device may include at least one, but no more than 24, photovoltaic cells electrically coupled in series.

(H7) Any of the photovoltaic panels denoted as (H1) through (H6) may further include a panel isolation switch electrically coupled in series with the plurality of photovoltaic assemblies, where the panel isolation switch is adapted to open in response to detection of the series electrical arc by the panel arc detection subsystem.

(H8) Any of the photovoltaic panels denoted as (H1) through (H7) may further include a panel shorting switch electrically coupled across the positive and negative panel power rails, where the panel shorting switch is adapted to close in response to detection of the series electrical arc by the panel arc detection subsystem.

(H9) In any of the photovoltaic panels denoted as (H1) through (H8), the panel arc detection subsystem may be further adapted to detect a parallel electrical arc within the photovoltaic panel from a discrepancy between current flowing through a selected one of the plurality of photovoltaic assemblies and current flowing between the plurality of photovoltaic assemblies and other circuitry.

(H10) In any of the photovoltaic panels denoted as (H1) through (H8), the panel arc detection subsystem may be further adapted to detect a parallel electrical arc within the photovoltaic panel from a discrepancy between current flowing through two different ones of the plurality of photovoltaic assemblies.

(I1) A photovoltaic panel having electrical arc detection capability may include a panel arc detection subsystem and a plurality of photovoltaic assemblies electrically coupled in series. The panel arc detection subsystem may be adapted to detect a parallel electrical arc within the photovoltaic panel from a discrepancy between current flowing through a selected one of the plurality of photovoltaic assemblies and current flowing between the plurality of photovoltaic assemblies and other circuitry.

(I2) In the photovoltaic panel denoted as (I1), each of the plurality of photovoltaic assemblies may include an assembly current sensing subsystem adapted to generate a respective assembly current signal representing current flowing through the photovoltaic assembly; the photovoltaic panel may further include a panel current sensing subsystem adapted to generate a panel current signal representing current flowing between the plurality of photovoltaic assemblies and other circuitry; and the panel arc detection subsystem may be further adapted to: (1) determine a difference between the panel current signal and an assembly current signal of a selected one of the plurality of photovoltaic assemblies, (2) determine whether a magnitude of the difference exceeds a threshold value, and (3) detect the parallel electrical arc if the magnitude of the difference exceeds the threshold value.

(I3) In either of the photovoltaic panels denoted as (I1) or (I2), each of the plurality of photovoltaic assemblies may further include a maximum power point tracking converter and a photovoltaic device. The maximum power point tracking converter may be electrically coupled between the photovoltaic device and an output port of the photovoltaic assembly, where the maximum power point tracking converter is adapted to cause the photovoltaic device to operate substantially at its maximum power point.

(I4) In the photovoltaic panel denoted as (I3), each photovoltaic device may have a maximum open circuit voltage rating of less than a minimum voltage required to sustain an electrical arc.

(I5) In either of the photovoltaic panels denoted as (I3) or (I4), each photovoltaic device may have a maximum open circuit voltage rating of 18 volts or less.

(I6) Any of the photovoltaic panels denoted as (I1) through (I5) may further include a panel shorting switch electrically coupled across positive and negative power rails of the photovoltaic panel, where the panel shorting switch is adapted to close in response to detection of the parallel electrical arc by the panel arc detection subsystem.

(J1) A photovoltaic panel having electrical arc detection capability may include a panel arc detection subsystem and a plurality of photovoltaic assemblies electrically coupled in series. The panel arc detection subsystem may be adapted to detect a parallel electrical arc within the photovoltaic panel from a discrepancy between current flowing through two different ones of the plurality of photovoltaic assemblies.

(J2) In the photovoltaic panel denoted as (J1), each of the plurality of photovoltaic assemblies may include an assembly current sensing subsystem adapted to generate a respective assembly current signal representing current flowing through the photovoltaic assembly; and the panel arc detection subsystem may be further adapted to: (1) determine a difference between assembly current signals of two different ones of the plurality of photovoltaic assemblies, (2) determine whether a magnitude of the difference exceeds a threshold value, and (3) detect the parallel electrical arc if the magnitude of the difference exceeds the threshold value.

(J3) In either of the photovoltaic panels denoted as (J1) or (J2), each of the plurality of photovoltaic assemblies may further include a photovoltaic device and a maximum power point tracking converter electrically coupled between the photovoltaic device and an output port of the photovoltaic assembly, where the maximum power point tracking converter is adapted to cause the photovoltaic device to operate substantially at its maximum power point.

(J4) In the photovoltaic panel denoted as (J3), each photovoltaic device may have a maximum open circuit voltage rating of less than a minimum voltage required to sustain an electrical arc.

(J5) In either of the photovoltaic panels denoted as (J3) or (J4), each photovoltaic device may have a maximum open circuit voltage rating of 18 volts or less.

(J6) Any of the photovoltaic panels denoted as (J1) through (J5) may further include a panel shorting switch electrically coupled across positive and negative power rails of the photovoltaic panel, where the panel shorting switch is adapted to close in response to detection of the parallel electrical arc by the panel arc detection subsystem.

(K1) A photovoltaic string having electrical arc detection capability may include a string arc detection subsystem and a plurality of photovoltaic panels electrically coupled in series between a positive string power rail and a negative string power rail. The string arc detection subsystem may be adapted to detect a series electrical arc within the photovoltaic string from a discrepancy between a string voltage across the positive and negative string power rails and a sum of all voltages across the plurality of photovoltaic panels.

(K2) In the photovoltaic string denoted as (K1), each of the plurality of photovoltaic panels may further include a panel arc detection subsystem adapted to detect an electrical arc within the photovoltaic panel.

(K3) In the photovoltaic string denoted as (K2), each of the plurality of photovoltaic panels may further include a panel shorting switch electrically coupled across positive and negative power rails of the photovoltaic panel, where the panel shorting switching is adapted to close in response to the panel arc detection subsystem of the photovoltaic panel detecting an electrical arc within the photovoltaic panel.

(K4) In either of the photovoltaic strings denoted as (K2) or (K3), each of the plurality of photovoltaic panels may include a plurality of photovoltaic assemblies electrically coupled in series, and the panel arc detection subsystem of each of the plurality of photovoltaic panels may be further adapted to detect a series electrical arc within the photovoltaic panel from a discrepancy between a voltage across power rails of the photovoltaic panel and a sum of all voltages across the photovoltaic assemblies of the photovoltaic panel.

(K5) In either of the photovoltaic strings denoted as (K2) or (K3), each of the plurality of photovoltaic panels may include a plurality of photovoltaic assemblies electrically coupled in series, and the panel arc detection subsystem of each of the plurality of photovoltaic panels may be further adapted to detect a parallel electrical arc within the photovoltaic panel from a discrepancy between current flowing through a selected one of the photovoltaic assemblies of the photovoltaic panel and current flowing between the photovoltaic assemblies of the photovoltaic panel and other circuitry.

(K6) In either of the photovoltaic strings denoted as (K2) or (K3), each of the plurality of photovoltaic panels may include a plurality of photovoltaic assemblies electrically coupled in series, and the panel arc detection subsystem of each of the plurality of photovoltaic panels may be adapted to detect a parallel electrical arc within the photovoltaic panel from a discrepancy between current flowing through two different ones of the plurality of photovoltaic assemblies of the photovoltaic panel.

(K7) In any of the photovoltaic strings denoted as (K1) through (K6), each of the plurality of photovoltaic panels may include a panel voltage sensing subsystem adapted to generate a respective panel output voltage signal representing a voltage across an output port of the photovoltaic panel; the photovoltaic string may further include a string voltage sensing subsystem adapted to generate a string voltage signal representing a voltage across the positive and negative string power rails; and the string arc detection subsystem may be further adapted to: (1) determine a difference between a sum of all of the panel output voltage signals and the string voltage signal, (2) determine whether the difference exceeds a threshold value, and (3) detect the series electrical arc if the magnitude of the difference exceeds the threshold value.

(K8) Any of the photovoltaic strings denoted as (K1) through (K7) may further include a string isolation switch electrically coupled in series with the plurality of photovoltaic panels, where the string isolation switch is adapted to open in response to the string arc detection subsystem detecting a series electrical arc within the photovoltaic string.

(K9) Any of the photovoltaic strings denoted as (K1) through (K8) may further include a string shorting switch electrically coupled across the positive and negative string power rails, where the string shorting switch is adapted to close to response to the string arc detection subsystem detecting a series electrical arc within the photovoltaic string.

(K10) In any of the photovoltaic strings denoted as (K1) through (K9), the string arc detection subsystem may be further adapted to detect a parallel electrical arc within the photovoltaic string from a discrepancy between current flowing through a selected one of the plurality of photovoltaic panels and current flowing between the plurality of photovoltaic panels and other circuitry.

(K11) In any of the photovoltaic strings denoted as (K1) through (K9), the string arc detection subsystem may be further adapted to detect a parallel electrical arc within the photovoltaic string from a discrepancy between current flowing through two different ones of the plurality of photovoltaic panels.

(L1) A photovoltaic string having electrical arc detection capability may include a string arc detection subsystem and a plurality of photovoltaic panels electrically coupled in series. The string arc detection subsystem may be adapted to detect a parallel electrical arc within the photovoltaic string from a discrepancy between a current flowing through a selected one of the plurality of photovoltaic panels and current flowing between the plurality of photovoltaic panels and other circuitry.

(L2) In the photovoltaic string denoted as (L1), each of the plurality of photovoltaic panels may include a panel current sensing subsystem adapted to generate a respective panel current signal representing current flowing through an output port of the photovoltaic panel; the photovoltaic string may further include a string current sensing subsystem adapted to generate a string current signal representing current flowing between the plurality of photovoltaic panels and other circuitry; and the string arc detection subsystem may be further adapted to: (1) determine a difference between the string current signal and a panel current signal of a selected one of the plurality of photovoltaic panels, (2) determine whether a magnitude of the difference exceeds a threshold value, and (3) detect the parallel electrical arc if the magnitude of the difference exceeds the threshold value.

(L3) In either of the photovoltaic strings denoted as (L1) or (L2), the plurality of photovoltaic panels may be electrically coupled in series between a positive string power rail and a negative string power rail, and the photovoltaic string may further include a string shorting switch electrically coupled across the positive and negative string power rails, where the string shorting switch is adapted to close in response to detection of the parallel electrical arc by the string arc detection subsystem.

(M1) A photovoltaic string having electrical arc detection capability may include a string arc detection subsystem and a plurality of photovoltaic panels electrically coupled in series. The string arc detection subsystem may be adapted to detect a parallel electrical arc within the photovoltaic string from a discrepancy between current flowing through two different ones of the plurality of photovoltaic panels.

(M2) In the photovoltaic string denoted as (M1), each of the plurality of photovoltaic panels may include a panel current sensing subsystem adapted to generate a respective panel current signal representing current flowing through an output port the photovoltaic panel; and the string arc detection subsystem may be further adapted to: (1) determine a difference between panel current signals of two different ones of the plurality of photovoltaic panels, (2) determine whether a magnitude of the difference exceeds a threshold value, and (3) detect the parallel electrical arc if the magnitude of the difference exceeds the threshold value.

(M3) In either of the photovoltaic strings denoted as (M1) or (M2), the plurality of photovoltaic panels may be electrically coupled in series between a positive string power rail and a negative string power rail, and the photovoltaic string may further include a string shorting switch electrically coupled across the positive and negative string power rails, where the string shorting switch is adapted to close in response to detection of the parallel electrical arc by the string arc detection subsystem.

(N1) A photovoltaic system having electrical arc detection capability may include a system-level arc detection subsystem and a plurality of photovoltaic strings electrically coupled in parallel. The system-level arc detection subsystem may be adapted to detect a parallel electrical arc within the photovoltaic system from a discrepancy between (a) a sum of current flowing through all of the plurality of strings and (b) current flowing between the plurality of strings and other circuitry.

(N2) In the photovoltaic system denoted as (N1), each of the plurality of strings may include a plurality of photovoltaic panels electrically coupled in series and a string current sensing subsystem adapted to generate a respective string current signal representing current flowing through an output port of the photovoltaic string; the photovoltaic system may further include a combined current sensing subsystem adapted to generate a combined current signal representing current flowing between the plurality of strings and other circuitry; and the system-level arc detection subsystem may be further adapted to: (1) determine a difference between the combined current signal and a sum of all of the string current signals, (2) determine whether a magnitude of the difference exceeds a threshold value, and (3) detect the series electrical arc if the magnitude of the difference exceeds the threshold value.

(N3) Either of the photovoltaic systems denoted as (N1) or (N2) may further include a system shorting switch electrically coupled across the plurality of photovoltaic strings, where the system shorting switch is adapted to close in response to detection of the parallel electrical arc by the system-level arc detection subsystem.

(O1) A method for detecting an electrical arc in an energy storage system including a plurality of energy storage assemblies electrically coupled in series between positive and negative power rails may include the following steps: (1) sensing a system voltage across the positive and negative power rails, (2) sensing a respective assembly voltage across each of the plurality of energy storage assemblies, (3) determining a difference between a sum of all of the assembly voltages and the system voltage, (4) determining whether the difference exceeds a threshold value, and (5) detecting the electrical arc if the difference exceeds the threshold value.

(P1) A method for detecting an electrical arc in an energy storage system including a plurality of energy storage assemblies electrically coupled in series may include the following steps: (1) sensing a first assembly current flowing through one of the plurality of energy storage assemblies, (2) sensing a system current flowing between the plurality of energy storage assemblies and other circuitry, (3) determining a difference between the system current and the first assembly current, (4) determining whether a magnitude of the difference exceeds a threshold value, and (5) detecting the electrical arc if the magnitude of the difference exceeds the threshold value.

(P2) The method denoted as (P1) may further include the following steps: (1) sensing a second assembly current flowing through another one of the plurality of energy storage assemblies, (2) determining a second difference between the system current and the second assembly current, (3) determining whether a magnitude of the second difference exceeds the threshold value, and (4) detecting the electrical arc if the magnitude of the second difference exceeds the threshold value.

(Q1) A method for detecting an electrical arc in an energy storage system including a plurality of energy storage assemblies electrically coupled in series may include the following steps: (1) sensing a first assembly current flowing through one of the plurality of energy storage assemblies, (2) sensing a second assembly current flowing through another one of the plurality of energy storage assemblies, (3) determining a difference between the first and second assembly currents, (4) determining whether a magnitude of the difference exceeds a threshold value, and (5) detecting the electrical arc if the magnitude of the difference exceeds the threshold value.

(R1) A method for detecting an electrical arc in an energy storage system including a plurality of energy storage strings electrically coupled in parallel, each of the plurality of energy storage strings including a plurality of energy storage assemblies electrically coupled in series, may include the following steps: (1) sensing a respective string output current flowing through an output port of each of the plurality of energy storage strings, (2) sensing a combined current flowing between the plurality of energy storage strings and other circuitry, (3) determining a difference between the combined current and a sum of all of the string output currents, (4) determining whether a magnitude of the difference exceeds a threshold value, and (5) detecting the electrical arc if the magnitude of the difference exceeds the threshold value.

(S1) An energy storage system having electrical arc detection capability may include an arc detection subsystem and a plurality of energy storage assemblies electrically coupled in series between a positive power rail and a negative power rail. The arc detection subsystem may be adapted to detect a series electrical arc within the energy storage system from a discrepancy between a system voltage across the positive and negative power rails and a sum of all voltages across the plurality of energy storage assemblies.

(S2) In the energy storage system denoted as (S1), each of the plurality of energy storage system assemblies may include an assembly voltage sensing subsystem adapted to generate a respective assembly voltage signal representing a voltage across an output port of the energy storage assembly; the energy storage system may further include a system voltage sensing subsystem adapted to generate a system voltage signal representing the system voltage; and the arc detection subsystem may be further adapted to: (1) determine a difference between a sum of all of the assembly voltage signals and the system voltage signal, (2) determine whether the difference exceeds a threshold value, and (3) detect the series electrical arc if the difference exceeds the threshold value.

(S3) In either of the energy storage systems denoted as (S1) or (S2), each of the plurality of energy storage assemblies may further include an energy storage device and a maximum power point tracking converter electrically coupled between the energy storage device and an output port of the energy storage assembly, where the maximum power point tracking converter is adapted to cause the energy storage device to operate substantially at its maximum power point.

(S4) In the energy storage system denoted as (S3), each energy storage device may have a maximum open circuit voltage rating of less than a minimum voltage required to sustain an electrical arc.

(S5) In either of the energy storage systems denoted as (S3) or (S4), each energy storage device may have a maximum open circuit voltage rating of 18 volts or less.

(S6) Any of the energy storage systems denoted as (S1) through (S5) may further include an isolation switch electrically coupled in series with the plurality of energy storage assemblies, where the isolation switch is adapted to open in response to detection of the series electrical arc by the arc detection subsystem.

(S7) Any of the energy storage systems denoted as (S1) through (S6) may further include a shorting switch electrically coupled across the positive and negative power rails, where the shorting switch is adapted to close in response to detection of the series electrical arc by the arc detection subsystem.

(S8) In any of the energy storage systems denoted as (S1) through (S7), the arc detection subsystem may be further adapted to detect a parallel electrical arc within the energy storage system from a discrepancy between current flowing through a selected one of the plurality of energy storage assemblies and current flowing between the plurality of energy storage assemblies and other circuitry.

(S9) In any of the energy storage systems denoted as (S1) through (S7), the arc detection subsystem may be further adapted to detect a parallel electrical arc within the energy storage system from a discrepancy between current flowing through two different ones of the plurality of energy storage assemblies.

(T1) An energy storage system having electrical arc detection capability may include an arc detection subsystem and a plurality of energy storage assemblies electrically coupled in series. The arc detection subsystem may be adapted to detect a parallel electrical arc within the energy storage system from a discrepancy between current flowing through a selected one of the plurality of energy storage assemblies and current flowing between the plurality of energy storage assemblies and other circuitry.

(T2) In the energy storage system denoted as (T1), each of the plurality of energy storage assemblies may include an assembly current sensing subsystem adapted to generate a respective assembly current signal representing current flowing through the energy storage assembly; the energy storage system may further include a system current sensing subsystem adapted to generate a system current signal representing current flowing between the plurality of energy storage assemblies and other circuitry; and the arc detection subsystem may be further adapted to: (1) determine a difference between the system current signal and an assembly current signal of a selected one of the plurality of energy storage assemblies, (2) determine whether a magnitude of the difference exceeds a threshold value, and (3) detect the parallel electrical arc if the magnitude of the difference exceeds the threshold value.

(T3) In either of the energy storage systems denoted as (T1) or (T2), each of the plurality of energy storage assemblies may further include an energy storage device and a maximum power point tracking converter electrically coupled between the energy storage device and an output port of the energy storage assembly, where the maximum power point tracking converter is adapted to cause the energy storage device to operate substantially at its maximum power point.

(T4) In the energy storage system denoted as (T3), each energy storage device may have a maximum open circuit voltage rating of less than a minimum voltage required to sustain an electrical arc.

(T5) In either of the energy storage systems denoted as (T3) or (T4), each energy storage device may have a maximum open circuit voltage rating of 18 volts or less.

(T6) Any of the energy storage systems denoted as (T1) through (T5) may further include a shorting switch electrically coupled across positive and negative power rails of the energy storage system, where the shorting switch is adapted to close in response to detection of the parallel electrical arc by the arc detection subsystem.

(U1) An energy storage system having electrical arc detection capability may include an arc detection subsystem and a plurality of energy storage assemblies electrically coupled in series. The arc detection subsystem may be adapted to detect a parallel electrical arc within the energy storage system from a discrepancy between current flowing through two different ones of the plurality of energy storage assemblies.

(U2) In the energy storage system denoted as (U1), each of the plurality of energy storage assemblies may include an assembly current sensing subsystem adapted to generate a respective assembly current signal representing current flowing through the energy storage assembly; and the arc detection subsystem may be further adapted to: (1) determine a difference between assembly current signals of two different ones of the plurality of energy storage assemblies, (2) determine whether a magnitude of the difference exceeds a threshold value, and (3) detect the parallel electrical arc if the magnitude of the difference exceeds the threshold value.

(U3) In either of the energy storage systems denoted as (U1) or (U2), each of the plurality of energy storage assemblies may further include an energy storage device and a maximum power point tracking converter electrically coupled between the energy storage device and an output port of the energy storage assembly, where the maximum power point tracking converter is adapted to cause the energy storage device to operate substantially at its maximum power point.

(U4) In the energy storage system denoted as (U3), each energy storage device may have a maximum open circuit voltage rating of less than a minimum voltage required to sustain an electrical arc.

(U5) In either of the energy storage systems denoted as (U3) or (U4), each energy storage device may have a maximum open circuit voltage rating of 18 volts or less.

(U6) Any of the energy storage systems denoted as (U1) through (U5) may further include a shorting switch electrically coupled across positive and negative power rails of the energy storage system, where the shorting switch is adapted to close in response to detection of the parallel electrical arc by the arc detection subsystem.

(V1) An energy storage system having electrical arc detection capability may include an arc detection subsystem and a plurality of energy storage strings electrically coupled in parallel. The arc detection subsystem may be adapted to detect a parallel electrical arc within the energy storage system from a discrepancy between (a) a sum of current flowing through all of the plurality of energy storage strings and (b) current flowing between the plurality of energy storage strings and other circuitry.

(V2) In the energy storage system denoted as (V1), each of the plurality of energy storage strings may include: a (1) plurality of energy storage assemblies electrically coupled in series and (2) a string current sensing subsystem adapted to generate a respective string current signal representing current flowing through an output port of the energy storage string. The energy storage system may further include a combined current sensing subsystem adapted to generate a combined current signal representing current flowing between the plurality of energy storage strings and other circuitry. The arc detection subsystem may be further adapted to: (1) determine a difference between the combined current signal and a sum of all of the string current signals, (2) determine whether a magnitude of the difference exceeds a threshold value, and (3) detect the parallel electrical arc if the magnitude of the difference exceeds the threshold value.

Changes may be made in the above methods and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. A photovoltaic panel having electrical arc detection capability, comprising:
a plurality of photovoltaic assemblies electrically coupled in series between a positive panel power rail and a negative panel power rail; and
a panel arc detection subsystem adapted to detect a series electrical arc within the photovoltaic panel from a discrepancy between a panel voltage across the positive and negative panel power rails and a sum of all voltages across the plurality of photovoltaic assemblies.

2. The photovoltaic panel of claim 1, wherein:
each of the plurality of photovoltaic assemblies includes an assembly voltage sensing subsystem adapted to generate a respective assembly voltage signal representing a voltage across an output port of the photovoltaic assembly;
the photovoltaic panel further comprises a panel voltage sensing subsystem adapted to generate a panel voltage signal representing the panel voltage; and
the panel arc detection subsystem is further adapted to:
determine a difference between a sum of all of the assembly voltage signals and the panel voltage signal,
determine whether the difference exceeds a threshold value, and
detect the series electrical arc if the difference exceeds the threshold value.

3. The photovoltaic panel of claim 1, each of the plurality of photovoltaic assemblies further including:
a photovoltaic device; and
a maximum power point tracking converter electrically coupled between the photovoltaic device and an output port of the photovoltaic assembly, the maximum power point tracking converter adapted to cause the photovoltaic device to operate substantially at its maximum power point.

4. The photovoltaic panel of claim 3, each photovoltaic device having a maximum open circuit voltage rating of less than a minimum voltage required to sustain an electrical arc.

5. The photovoltaic panel of claim 4, each photovoltaic device having a maximum open circuit voltage rating of 18 volts or less.

6. The photovoltaic panel of claim 5, each photovoltaic device including at least one, but no more than 24, photovoltaic cells electrically coupled in series.

7. The photovoltaic panel of claim 1, further comprising a panel isolation switch electrically coupled in series with the plurality of photovoltaic assemblies, the panel isolation switch adapted to open in response to detection of the series electrical arc by the panel arc detection subsystem.

8. The photovoltaic panel of claim 1, further comprising a panel shorting switch electrically coupled across the positive and negative panel power rails, the panel shorting switch adapted to close in response to detection of the series electrical arc by the panel arc detection subsystem.

9. The photovoltaic panel of claim 1, the panel arc detection subsystem further adapted to detect a parallel electrical arc within the photovoltaic panel from a discrepancy between current flowing through a selected one of the plurality of photovoltaic assemblies and current flowing between the plurality of photovoltaic assemblies and other circuitry.

10. The photovoltaic panel of claim 1, the panel arc detection subsystem further adapted to detect a parallel electrical arc within the photovoltaic panel from a discrepancy between current flowing through two different ones of the plurality of photovoltaic assemblies.

11. A photovoltaic panel having electrical arc detection capability, comprising:
a plurality of photovoltaic assemblies electrically coupled in series; and
a panel arc detection subsystem adapted to detect a parallel electrical arc within the photovoltaic panel from a discrepancy between current flowing through a selected one of the plurality of photovoltaic assemblies and current flowing between the plurality of photovoltaic assemblies and other circuitry.

12. The photovoltaic panel of claim 11, wherein:
each of the plurality of photovoltaic assemblies includes an assembly current sensing subsystem adapted to generate a respective assembly current signal representing current flowing through the photovoltaic assembly;
the photovoltaic panel further comprises a panel current sensing subsystem adapted to generate a panel current signal representing current flowing between the plurality of photovoltaic assemblies and other circuitry; and
the panel arc detection subsystem is further adapted to:
determine a difference between the panel current signal and an assembly current signal of a selected one of the plurality of photovoltaic assemblies,
determine whether a magnitude of the difference exceeds a threshold value, and
detect the parallel electrical arc if the magnitude of the difference exceeds the threshold value.

13. The photovoltaic panel of claim 11, each of the plurality of photovoltaic assemblies further including:
a photovoltaic device; and
a maximum power point tracking converter electrically coupled between the photovoltaic device and an output port of the photovoltaic assembly, the maximum power point tracking converter adapted to cause the photovoltaic device to operate substantially at its maximum power point.

14. The photovoltaic panel of claim 13, each photovoltaic device having a maximum open circuit voltage rating of less than a minimum voltage required to sustain an electrical arc.

15. The photovoltaic panel of claim 14, each photovoltaic device having a maximum open circuit voltage rating of 18 volts or less.

16. The photovoltaic panel of claim 11, further comprising a panel shorting switch electrically coupled across positive and negative power rails of the photovoltaic panel, the panel shorting switch adapted to close in response to detection of the parallel electrical arc by the panel arc detection subsystem.

17. A photovoltaic panel having electrical arc detection capability, comprising:
a plurality of photovoltaic assemblies electrically coupled in series; and
a panel arc detection subsystem adapted to detect a parallel electrical arc within the photovoltaic panel from a discrepancy between current flowing through two different ones of the plurality of photovoltaic assemblies.

18. The photovoltaic panel of claim 17, wherein:
each of the plurality of photovoltaic assemblies includes an assembly current sensing subsystem adapted to generate a respective assembly current signal representing current flowing through the photovoltaic assembly; and
the panel arc detection subsystem is further adapted to:
determine a difference between assembly current signals of two different ones of the plurality of photovoltaic assemblies,
determine whether a magnitude of the difference exceeds a threshold value, and
detect the parallel electrical arc if the magnitude of the difference exceeds the threshold value.

19. The photovoltaic panel of claim 17, each of the plurality of photovoltaic assemblies further including:
a photovoltaic device; and
a maximum power point tracking converter electrically coupled between the photovoltaic device and an output port of the photovoltaic assembly, the maximum power point tracking converter adapted to cause the photovoltaic device to operate substantially at its maximum power point.

20. The photovoltaic panel of claim 19, each photovoltaic device having a maximum open circuit voltage rating of less than a minimum voltage required to sustain an electrical arc.

21. The photovoltaic panel of claim 20, each photovoltaic device having a maximum open circuit voltage rating of 18 volts or less.

22. The photovoltaic panel of claim 17, further comprising a panel shorting switch electrically coupled across positive and negative power rails of the photovoltaic panel, the panel shorting switch adapted to close in response to detection of the parallel electrical arc by the panel arc detection subsystem.

23. A photovoltaic string having electrical arc detection capability, comprising:
a plurality of photovoltaic panels electrically coupled in series between a positive string power rail and a negative string power rail; and
a string arc detection subsystem adapted to detect a series electrical arc within the photovoltaic string from a discrepancy between a string voltage across the positive and negative string power rails and a sum of all voltages across the plurality of photovoltaic panels.

24. The photovoltaic string of claim 23, each of the plurality of photovoltaic panels further including a panel arc detection subsystem adapted to detect an electrical arc within the photovoltaic panel.

25. The photovoltaic string of claim 24, each of the plurality of photovoltaic panels further including a panel shorting switch electrically coupled across positive and negative power rails of the photovoltaic panel, the panel shorting switching adapted to close in response to the panel arc detection subsystem of the photovoltaic panel detecting an electrical arc within the photovoltaic panel.

26. The photovoltaic string of claim 24, wherein:
each of the plurality of photovoltaic panels comprises a plurality of photovoltaic assemblies electrically coupled in series; and
the panel arc detection subsystem of each of the plurality of photovoltaic panels is further adapted to detect a series electrical arc within the photovoltaic panel from a discrepancy between a voltage across power rails of the photovoltaic panel and a sum of all voltages across the photovoltaic assemblies of the photovoltaic panel.

27. The photovoltaic string of claim 24, wherein:
each of the plurality of photovoltaic panels comprises a plurality of photovoltaic assemblies electrically coupled in series; and
the panel arc detection subsystem of each of the plurality of photovoltaic panels is further adapted to detect a parallel electrical arc within the photovoltaic panel from a discrepancy between current flowing through a selected one of the photovoltaic assemblies of the photovoltaic panel and current flowing between the photovoltaic assemblies of the photovoltaic panel and other circuitry.

28. The photovoltaic string of claim 24, wherein:
each of the plurality of photovoltaic panels comprises a plurality of photovoltaic assemblies electrically coupled in series; and
the panel arc detection subsystem of each of the plurality of photovoltaic panels is adapted to detect a parallel electrical arc within the photovoltaic panel from a discrepancy between current flowing through two different ones of the plurality of photovoltaic assemblies of the photovoltaic panel.

29. The photovoltaic string of claim 23, wherein:
each of the plurality of photovoltaic panels comprises a panel voltage sensing subsystem adapted to generate a respective panel output voltage signal representing a voltage across an output port of the photovoltaic panel;
the photovoltaic string further comprises a string voltage sensing subsystem adapted to generate a string voltage signal representing a voltage across the positive and negative string power rails; and
the string arc detection subsystem is further adapted to:
determine a difference between a sum of all of the panel output voltage signals and the string voltage signal,
determine whether the difference exceeds a threshold value, and
detect the series electrical arc if the magnitude of the difference exceeds the threshold value.

30. The photovoltaic string of claim 23, further comprising a string isolation switch electrically coupled in series with the plurality of photovoltaic panels, the string isolation switch adapted to open in response to the string arc detection subsystem detecting a series electrical arc within the photovoltaic string.

31. The photovoltaic string of claim 23, further comprising a string shorting switch electrically coupled across the positive and negative string power rails, the string shorting switch adapted to close to response to the string arc detection subsystem detecting a series electrical arc within the photovoltaic string.

32. The photovoltaic string of claim 23, the string arc detection subsystem further adapted to detect a parallel electrical arc within the photovoltaic string from a discrepancy between current flowing through a selected one of the plurality of photovoltaic panels and current flowing between the plurality of photovoltaic panels and other circuitry.

33. The photovoltaic string of claim 23, the string arc detection subsystem further adapted to detect a parallel electrical arc within the photovoltaic string from a discrepancy between current flowing through two different ones of the plurality of photovoltaic panels.

34. A photovoltaic string having electrical arc detection capability, comprising:
a plurality of photovoltaic panels electrically coupled in series; and
a string arc detection subsystem adapted to detect a parallel electrical arc within the photovoltaic string from a discrepancy between a current flowing through a selected one of the plurality of photovoltaic panels and current flowing between the plurality of photovoltaic panels and other circuitry.

35. The photovoltaic string of claim 34, wherein:
each of the plurality of photovoltaic panels includes a panel current sensing subsystem adapted to generate a respective panel current signal representing current flowing through an output port of the photovoltaic panel;
the photovoltaic string further comprises a string current sensing subsystem adapted to generate a string current signal representing current flowing between the plurality of photovoltaic panels and other circuitry; and
the string arc detection subsystem is further adapted to:
determine a difference between the string current signal and a panel current signal of a selected one of the plurality of photovoltaic panels,
determine whether a magnitude of the difference exceeds a threshold value, and
detect the parallel electrical arc if the magnitude of the difference exceeds the threshold value.

36. The photovoltaic string of claim 34, the plurality of photovoltaic panels being electrically coupled in series between a positive string power rail and a negative string power rail, the photovoltaic string further comprising a string shorting switch electrically coupled across the positive and negative string power rails, the string shorting switch adapted to close in response to detection of the parallel electrical arc by the string arc detection subsystem.

37. A photovoltaic string having electrical arc detection capability, comprising:
a plurality of photovoltaic panels electrically coupled in series; and
a string arc detection subsystem adapted to detect a parallel electrical arc within the photovoltaic string from a discrepancy between current flowing through two different ones of the plurality of photovoltaic panels.

38. The photovoltaic string of claim 37, wherein:
each of the plurality of photovoltaic panels includes a panel current sensing subsystem adapted to generate a respective panel current signal representing current flowing through an output port the photovoltaic panel; and
the string arc detection subsystem is further adapted to:
determine a difference between panel current signals of two different ones of the plurality of photovoltaic panels,
determine whether a magnitude of the difference exceeds a threshold value, and
detect the parallel electrical arc if the magnitude of the difference exceeds the threshold value.

39. The photovoltaic string of claim 37, the plurality of photovoltaic panels being electrically coupled in series between a positive string power rail and a negative string power rail, the photovoltaic string further comprising a string shorting switch electrically coupled across the positive and negative string power rails, the string shorting switch adapted to close in response to detection of the parallel electrical arc by the string arc detection subsystem.

40. A photovoltaic system having electrical arc detection capability, comprising:
a plurality of photovoltaic strings electrically coupled in parallel; and
a system-level arc detection subsystem adapted to detect a parallel electrical arc within the photovoltaic system from a discrepancy between (a) a sum of current flowing through all of the plurality of strings and (b) current flowing between the plurality of strings and other circuitry.

41. The photovoltaic system of claim 40, wherein:
each of the plurality of strings includes:
a plurality of photovoltaic panels electrically coupled in series, and
a string current sensing subsystem adapted to generate a respective string current signal representing current flowing through an output port of the photovoltaic string;
the photovoltaic system further includes a combined current sensing subsystem adapted to generate a combined current signal representing current flowing between the plurality of strings and other circuitry; and
the system-level arc detection subsystem is further adapted to:
determine a difference between the combined current signal and a sum of all of the string current signals,
determine whether a magnitude of the difference exceeds a threshold value, and
detect the series electrical arc if the magnitude of the difference exceeds the threshold value.

42. The photovoltaic system of claim 41, further comprising a system shorting switch electrically coupled across the plurality of photovoltaic strings, the system shorting switch adapted to close in response to detection of the parallel electrical arc by the system-level arc detection subsystem.

43. An energy storage system having electrical arc detection capability, comprising:
a plurality of energy storage assemblies electrically coupled in series between a positive power rail and a negative power rail; and
an arc detection subsystem adapted to detect a series electrical arc within the energy storage system from a discrepancy between a system voltage across the positive and negative power rails and a sum of all voltages across the plurality of energy storage assemblies.

44. The energy storage system of claim 43, wherein:
each of the plurality of energy storage system assemblies includes an assembly voltage sensing subsystem adapted to generate a respective assembly voltage signal representing a voltage across an output port of the energy storage assembly;
the energy storage system further comprises a system voltage sensing subsystem adapted to generate a system voltage signal representing the system voltage; and
the arc detection subsystem is further adapted to:
determine a difference between a sum of all of the assembly voltage signals and the system voltage signal,
determine whether the difference exceeds a threshold value, and
detect the series electrical arc if the difference exceeds the threshold value.

45. The energy storage system of claim 43, each of the plurality of energy storage assemblies further including:
an energy storage device; and
a maximum power point tracking converter electrically coupled between the energy storage device and an output port of the energy storage assembly, the maximum power point tracking converter adapted to cause the energy storage device to operate substantially at its maximum power point.

46. The energy storage system of claim 45, each energy storage device having a maximum open circuit voltage rating of less than a minimum voltage required to sustain an electrical arc.

47. The energy storage system of claim 46, each energy storage device having a maximum open circuit voltage rating of 18 volts or less.

48. The energy storage system of claim 43, further comprising an isolation switch electrically coupled in series with the plurality of energy storage assemblies, the isolation switch adapted to open in response to detection of the series electrical arc by the arc detection subsystem.

49. The energy storage system of claim 43, further comprising a shorting switch electrically coupled across the positive and negative power rails, the shorting switch adapted to close in response to detection of the series electrical arc by the arc detection subsystem.

50. The energy storage system of claim 43, the arc detection subsystem further adapted to detect a parallel electrical arc within the energy storage system from a discrepancy between current flowing through a selected one of the plurality of energy storage assemblies and current flowing between the plurality of energy storage assemblies and other circuitry.

51. The energy storage system of claim 43, the arc detection subsystem further adapted to detect a parallel electrical arc within the energy storage system from a discrepancy between current flowing through two different ones of the plurality of energy storage assemblies.

52. An energy storage system having electrical arc detection capability, comprising:
a plurality of energy storage assemblies electrically coupled in series; and
an arc detection subsystem adapted to detect a parallel electrical arc within the energy storage system from a discrepancy between current flowing through a selected one of the plurality of energy storage assemblies and current flowing between the plurality of energy storage assemblies and other circuitry.

53. The energy storage system of claim 52, wherein:
each of the plurality of energy storage assemblies includes an assembly current sensing subsystem adapted to generate a respective assembly current signal representing current flowing through the energy storage assembly;
the energy storage system further comprises a system current sensing subsystem adapted to generate a system current signal representing current flowing between the plurality of energy storage assemblies and other circuitry; and
the arc detection subsystem is further adapted to:
determine a difference between the system current signal and an assembly current signal of a selected one of the plurality of energy storage assemblies,
determine whether a magnitude of the difference exceeds a threshold value, and
detect the parallel electrical arc if the magnitude of the difference exceeds the threshold value.

54. The energy storage system of claim 52, each of the plurality of energy storage assemblies further including:
an energy storage device; and
a maximum power point tracking converter electrically coupled between the energy storage device and an output port of the energy storage assembly, the maximum power point tracking converter adapted to cause the energy storage device to operate substantially at its maximum power point.

55. The energy storage system of claim 54, each energy storage device having a maximum open circuit voltage rating of less than a minimum voltage required to sustain an electrical arc.

56. The energy storage system of claim 55, each energy storage device having a maximum open circuit voltage rating of 18 volts or less.

57. The energy storage system of claim 52, further comprising a shorting switch electrically coupled across positive and negative power rails of the energy storage system, the shorting switch adapted to close in response to detection of the parallel electrical arc by the arc detection subsystem.

58. An energy storage system having electrical arc detection capability, comprising:
a plurality of energy storage assemblies electrically coupled in series; and
an arc detection subsystem adapted to detect a parallel electrical arc within the energy storage system from a discrepancy between current flowing through two different ones of the plurality of energy storage assemblies.

59. The energy storage system of claim 58, wherein:
each of the plurality of energy storage assemblies includes an assembly current sensing subsystem adapted to generate a respective assembly current signal representing current flowing through the energy storage assembly; and
the arc detection subsystem is further adapted to:
determine a difference between assembly current signals of two different ones of the plurality of energy storage assemblies,
determine whether a magnitude of the difference exceeds a threshold value, and
detect the parallel electrical arc if the magnitude of the difference exceeds the threshold value.

60. The energy storage system of claim 58, each of the plurality of energy storage assemblies further including:
an energy storage device; and
a maximum power point tracking converter electrically coupled between the energy storage device and an output port of the energy storage assembly, the maximum power point tracking converter adapted to cause the energy storage device to operate substantially at its maximum power point.

61. The energy storage system of claim 60, each energy storage device having a maximum open circuit voltage rating of less than a minimum voltage required to sustain an electrical arc.

62. The energy storage system of claim 61, each energy storage device having a maximum open circuit voltage rating of 18 volts or less.

63. The energy storage system of claim 58, further comprising a shorting switch electrically coupled across positive and negative power rails of the energy storage system, the shorting switch adapted to close in response to detection of the parallel electrical arc by the arc detection subsystem.

64. An energy storage system having electrical arc detection capability, comprising:
a plurality of energy storage strings electrically coupled in parallel; and
an arc detection subsystem adapted to detect a parallel electrical arc within the energy storage system from a discrepancy between (a) a sum of current flowing through all of the plurality of energy storage strings and (b) current flowing between the plurality of energy storage strings and other circuitry.

65. The energy storage system of claim 64, wherein:
each of the plurality of energy storage strings includes:
a plurality of energy storage assemblies electrically coupled in series, and
a string current sensing subsystem adapted to generate a respective string current signal representing current flowing through an output port of the energy storage string;
the energy storage system further includes a combined current sensing subsystem adapted to generate a combined current signal representing current flowing between the plurality of energy storage strings and other circuitry; and
the arc detection subsystem is further adapted to:
determine a difference between the combined current signal and a sum of all of the string current signals,
determine whether a magnitude of the difference exceeds a threshold value, and
detect the parallel electrical arc if the magnitude of the difference exceeds the threshold value.
